(19) United States
(12) Patent Application Publication
(10) Pub. No.: US 2026/0133950 A1
(43) Pub. Date: May 14, 2026

(54) STORING A SEGMENT DIRECTORY GROUP VIA A DATABASE SYSTEM

(71) Applicant: Ocient Holdings LLC, Chicago, IL (US)

(72) Inventors: George Kondiles, Highland Park, IL (US); Finley Jordan Lau, Chicago, IL (US); Andrew Michael Bass, Carmel, IN (US); Tim Louison Girard, Chicago, IL (US); Greg R. Dhuse, Chicago, IL (US); Hassan Farahani, Evanston, IL (US); Ryan William Luu, Chicago, IL (US)

(73) Assignee: Ocient Holdings LLC, Chicago, IL (US)

(21) Appl. No.: 18/969,537

(22) Filed: Dec. 5, 2024

Related U.S. Application Data
(60) Provisional application No. 63/719,444, filed on Nov. 12, 2024.

(51) Int. Cl. G06F 16/22; G06F 16/2453

(52) U.S. Cl. CPC G06F 16/2246; G06F 16/24532

(57) ABSTRACT

A database system is operable to storing a set of segments containing a plurality of rows of at least one relational database table via a disk memory resources of a plurality of nodes of a database system. A tree topology is generated for a segment directory group that includes the set of segments, where a plurality of leaf tree nodes of the tree topology correspond to the set of segments. A set of files for the segment directory group are stored in the disk memory resources. Root tree node data for a root tree node of the of the tree topology is stored as state data maintained via a consensus protocol mediated via the plurality of nodes.

### CROSS-REFERENCE TO RELATED APPLICATIONS

The present U.S. Utility patent application claims priority pursuant to 35 U.S.C. § 119(e) to U.S. Provisional Application No. 63/719,444, entitled “STORING A SEGMENT DIRECTORY GROUP VIA A DATABASE SYSTEM”, filed Nov. 12, 2024, which is hereby incorporated herein by reference in its entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networking and more particularly to database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system in accordance with various embodiments;

FIG. 1A is a schematic block diagram of an embodiment of a database system in accordance with various embodiments;

FIG. 2 is a schematic block diagram of an embodiment of an administrative sub-system in accordance with various embodiments;

FIG. 3 is a schematic block diagram of an embodiment of a configuration sub-system in accordance with various embodiments;

FIG. 4 is a schematic block diagram of an embodiment of a parallelized data input sub-system in accordance with various embodiments;

FIG. 5 is a schematic block diagram of an embodiment of a parallelized query and response (Q&R) sub-system in accordance with various embodiments;

FIG. 6 is a schematic block diagram of an embodiment of a parallelized data store, retrieve, and/or process (IO& P) sub-system in accordance with various embodiments;

FIG. 7 is a schematic block diagram of an embodiment of a computing device in accordance with various embodiments;

FIG. 8 is a schematic block diagram of another embodiment of a computing device in accordance with various embodiments;

FIG. 9 is a schematic block diagram of another embodiment of a computing device in accordance with various embodiments;

FIG. 10 is a schematic block diagram of an embodiment of a node of a computing device in accordance with various embodiments;

FIG. 11 is a schematic block diagram of an embodiment of a node of a computing device in accordance with various embodiments;

FIG. 12 is a schematic block diagram of an embodiment of a node of a computing device in accordance with various embodiments;

FIG. 13 is a schematic block diagram of an embodiment of a node of a computing device in accordance with various embodiments;

FIG. 14 is a schematic block diagram of an embodiment of operating systems of a computing device in accordance with various embodiments;

FIGS. 15-23 are schematic block diagrams of an example of processing a table or data set for storage in the database system in accordance with various embodiments;

FIG. 24A is a schematic block diagram of a query execution plan implemented via a plurality of nodes in accordance with various embodiments;

FIGS. 24B-24D are schematic block diagrams of embodiments of a node that implements a query processing module in accordance with various embodiments;

FIG. 24E is an embodiment is schematic block diagrams illustrating a plurality of nodes that communicate via shuffle networks in accordance with various embodiments;

FIG. 24F is a schematic block diagram of a database system communicating with an external requesting entity in accordance with various embodiments;

FIG. 24G is a schematic block diagram of a query processing system in accordance with various embodiments;

FIG. 24H is a schematic block diagram of a query operator execution flow in accordance with various embodiments;

FIG. 24I is a schematic block diagram of a plurality of nodes that utilize query operator execution flows in accordance with various embodiments;

FIG. 24J is a schematic block diagram of a query execution module that executes a query operator execution flow via a plurality of corresponding operator execution modules in accordance with various embodiments;

FIG. 24K illustrates an example embodiment of a plurality of database tables stored in database storage in accordance with various embodiments;

FIG. 24L illustrates an example embodiment of a dataset stored in database storage that includes at least one array field in accordance with various embodiments;

FIG. 24M is a schematic block diagram of a query execution module that implements a plurality of column data streams in accordance with various embodiments;

FIG. 24N illustrates example data blocks of a column data stream in accordance with various embodiments;

FIG. 24O is a schematic block diagram of a query execution module illustrating writing and processing of data blocks by operator execution modules in accordance with various embodiments;

FIG. 24P is a schematic block diagram of a database system that implements a segment generator that generates segments from a plurality of records in accordance with various embodiments;

FIG. 24Q is a schematic block diagram of a segment generator that implements a cluster key-based grouping module, a columnar rotation module, and a metadata generator module in accordance with various embodiments;

FIG. 24R is a schematic block diagram of a query processing system that generates and executes a plurality of IO pipelines to generate filtered records sets from a plurality of segments in conjunction with executing a query in accordance with various embodiments;

FIG. 24S is a schematic block diagram of a query processing system that generates an IO pipeline for accessing a corresponding segment based on predicates of a query in accordance with various embodiments;

FIG. 24T is a schematic block diagram of a database system that includes a plurality of storage clusters that each mediate cluster state data via a plurality of nodes in accordance with a consensus protocol in accordance with various embodiments;

FIG. 24U is a schematic block diagram of a database system that implements a compressed column filter conversion module based on accessing a dictionary structure in accordance with various embodiments;

FIG. 24V is a schematic block diagram of a query execution module that implements a Global Dictionary Compression join via access to a dictionary structure in accordance with various embodiments;

FIG. 24W is a schematic block diagram illustrating communication between database system 10 and a plurality of user entities in accordance with various embodiments;

FIGS. 25A-25B are schematic block diagrams of embodiments of a database system that includes a record processing and storage system in accordance with various embodiments;

FIG. 25C is a is a schematic block diagrams of an embodiment of a page generator in accordance with various embodiments;

FIG. 25D is a schematic block diagrams of an embodiment of a page storage system of a record processing and storage system in accordance with various embodiments;

FIG. 25E is a schematic block diagrams of a node that implements a query processing module that reads records from segment storage and page storage in accordance with various embodiments;

FIG. 26A is a schematic block diagram of a record processing and storage system implementing a page bucket scheduling module in accordance with various embodiments;

FIG. 26B is a logic diagram illustrating a method for execution in accordance with various embodiments;

FIG. 27A is a schematic block diagram of a record processing and storage system implementing a director module, a producer module, and a plurality of delegate modules in accordance with various embodiments;

FIG. 27B is a logic diagram illustrating a method for execution in accordance with various embodiments;

FIG. 28A is a schematic block diagram of a segment directory group implemented via a plurality of tree nodes in accordance with various embodiments;

FIG. 28B is a schematic block diagram of a segment directory in accordance with various embodiments;

FIG. 28C is a schematic block diagram of a plurality of memory drives storing segments and segment directories in accordance with various embodiments;

FIG. 28D is a schematic block diagram of a plurality of memory drives storing segment directories in accordance with various embodiments;

FIG. 28E is a logic diagram illustrating a method for execution in accordance with various embodiments;

FIG. 29A is a schematic block diagram of a node that implements a storage location data generator module in accordance with various embodiments;

FIGS. 29B-29E illustrate example embodiments of a plurality of nodes storing segments of at least one segment group across a plurality of drives in accordance with various embodiments;

FIG. 29F is a logic diagram illustrating a method for execution in accordance with various embodiments;

FIGS. 30A-30C are schematic block diagrams of a group merging module operable in accordance with various embodiments;

FIG. 30D is a logic diagram illustrating a method for execution in accordance with various embodiments;

FIGS. 31A-31C are schematic block diagrams of tree topologies for segment directory groups implementing owner storage identifiers in accordance with various embodiments;

FIG. 31D is a schematic block diagram of a group access module implementing a recursive tree traversal process in accordance with various embodiments;

FIG. 31E illustrates a logical flow performed to implement a recursive tree traversal process in accordance with various embodiments; and

FIG. 31F is a logic diagram illustrating a method for execution in accordance with various embodiments.

### DETAILED DESCRIPTION OF THE INVENTION

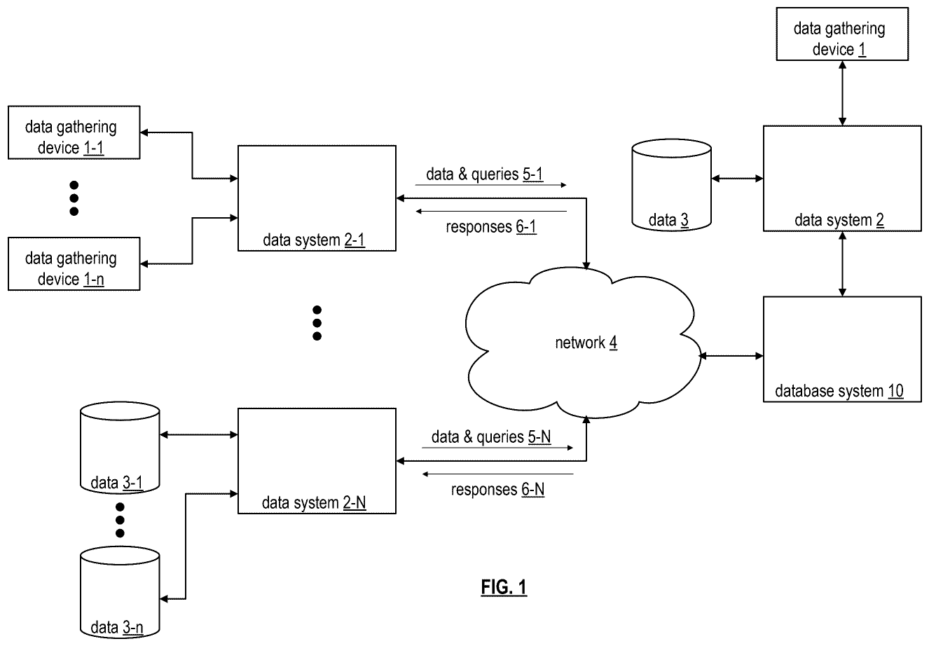

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of: wide area network (WAN) connections, local area network (LAN) connections, wireless connections, wireline connections, etc. to couple the sub-systems 11, 12, 13, 15, and 16 together.

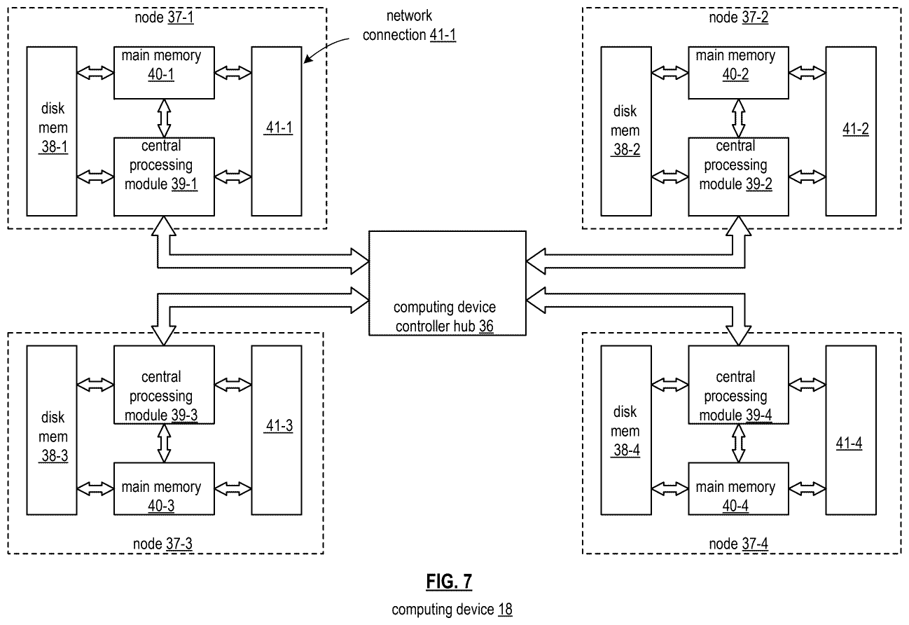

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

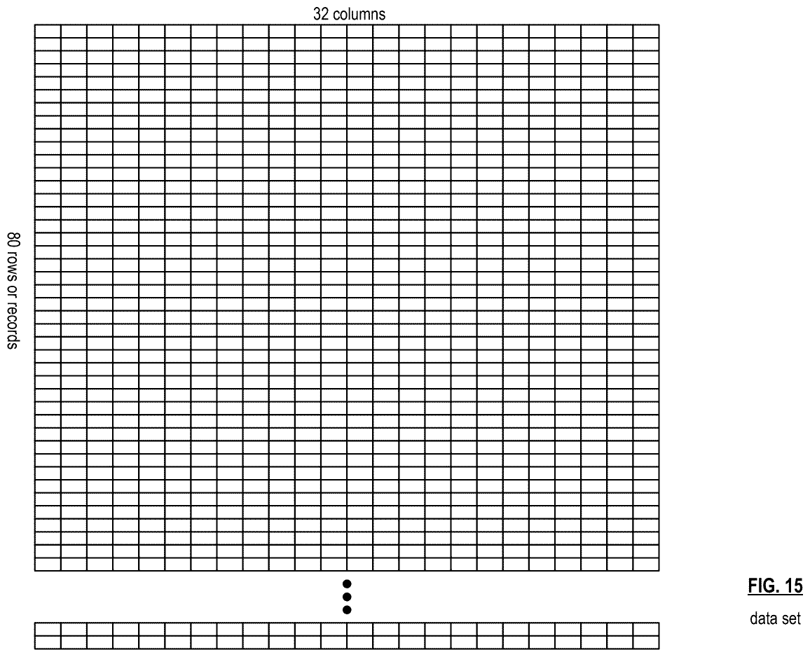

As is further discussed with reference to FIG. 15, the data source organizes its records of the data set into a table that includes rows and columns. The columns represent data fields of data for the rows. Each row corresponds to a record of data. For example, a table includes payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches of dividing a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

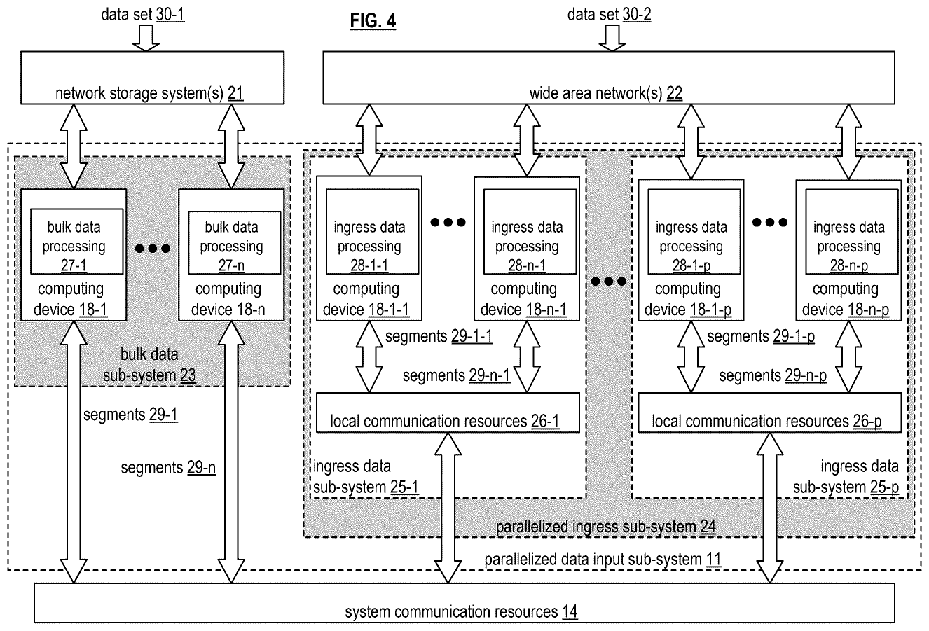

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

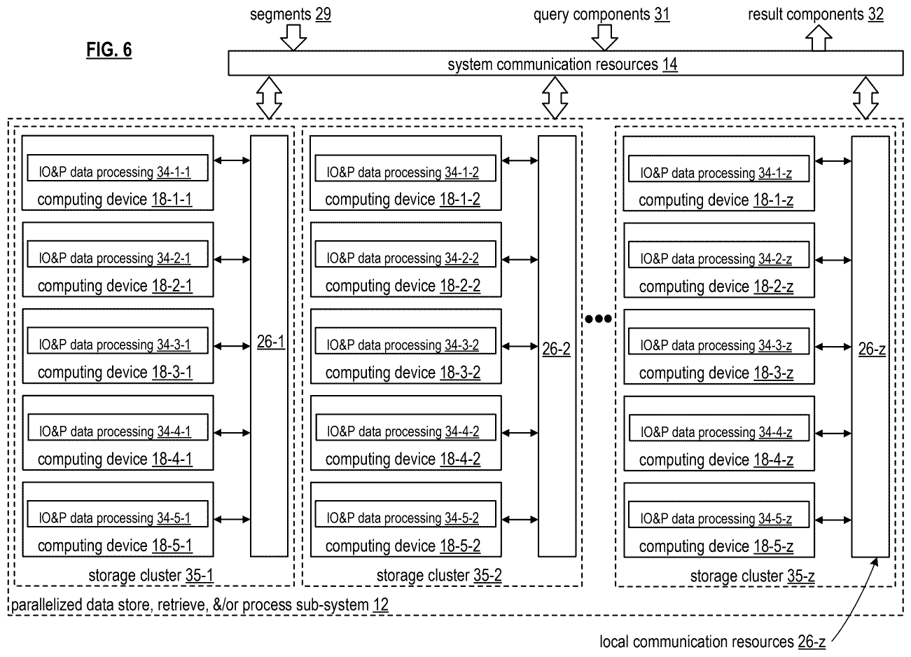

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates an SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

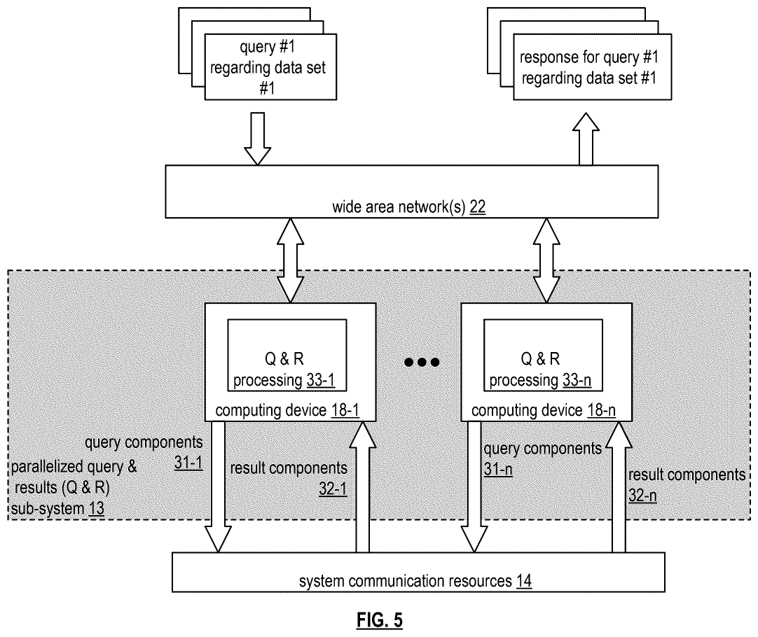

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

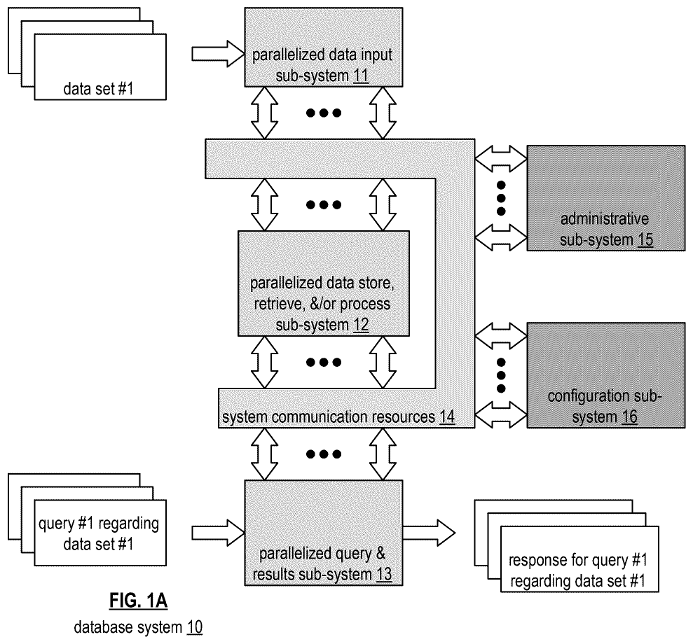

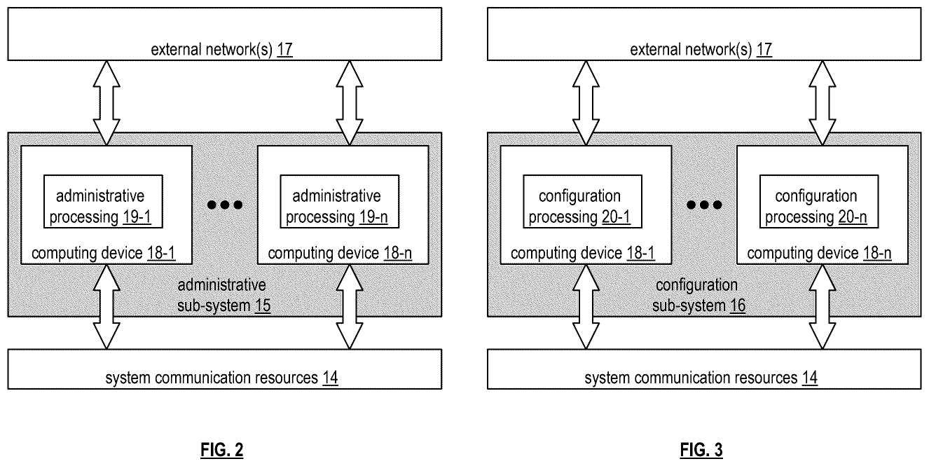

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

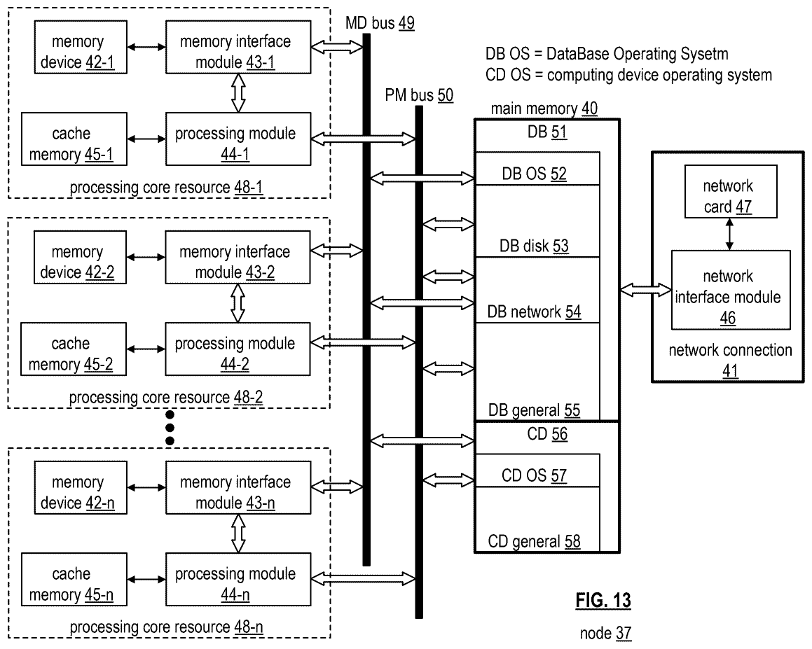

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

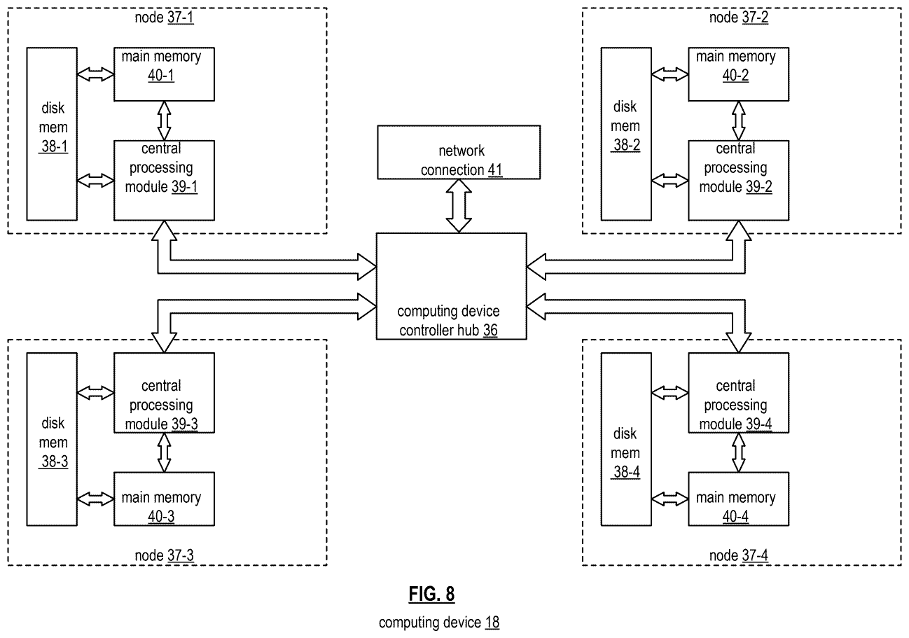

FIG. 8 is a schematic block diagram of another embodiment of a computing device similar to the computing device of FIG. 7 with an exception that it includes a single network connection 41, which is coupled to the computing device controller hub 36. As such, each node coordinates with the computing device controller hub to transmit or receive data via the network connection.

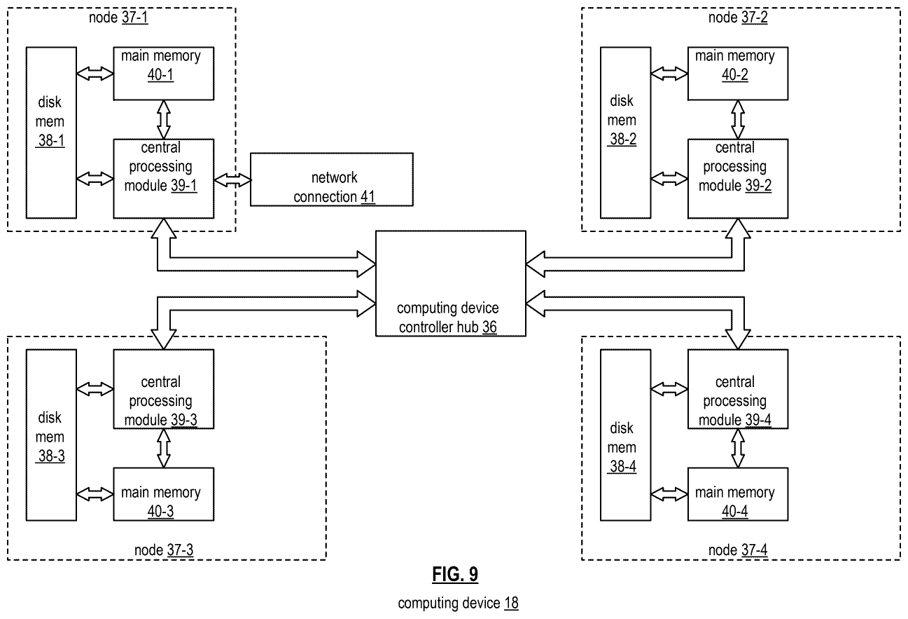

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

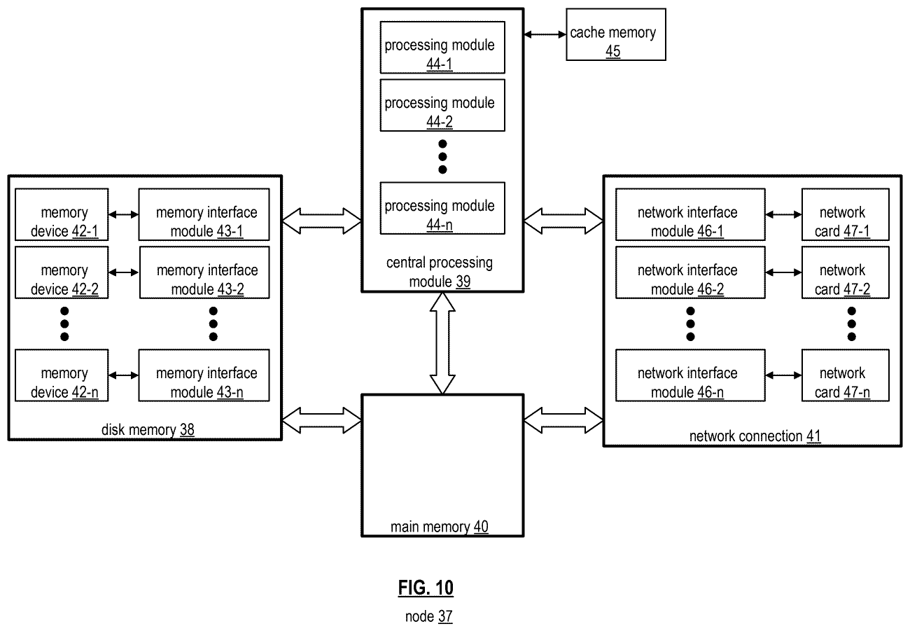

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

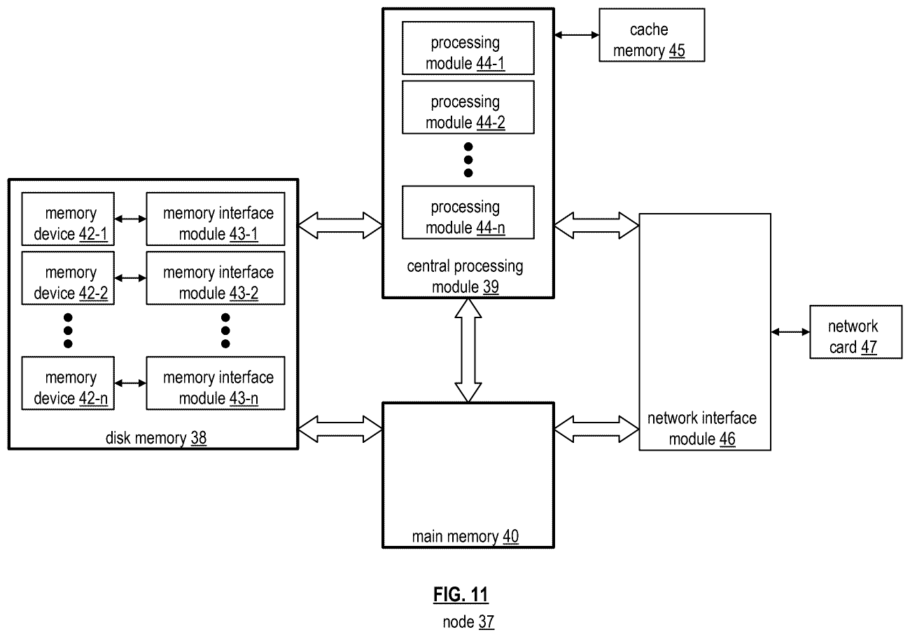

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

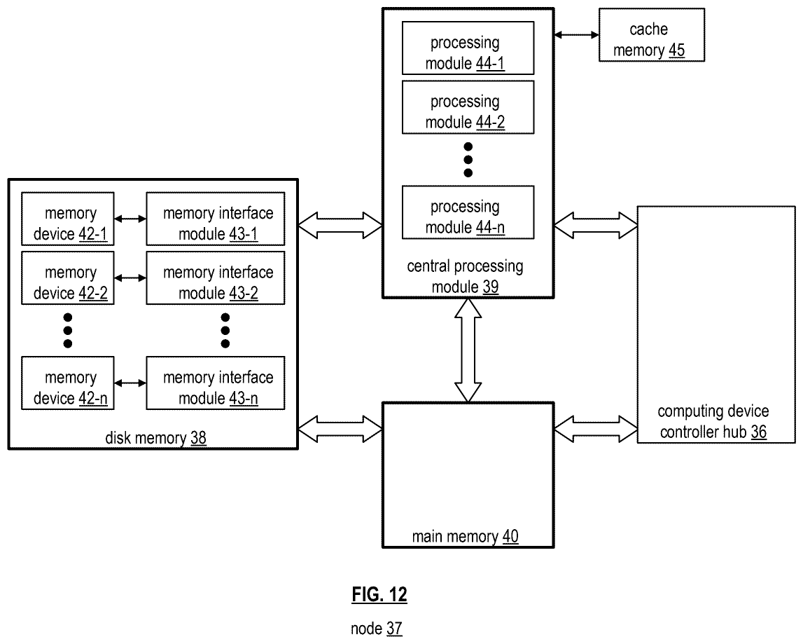

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

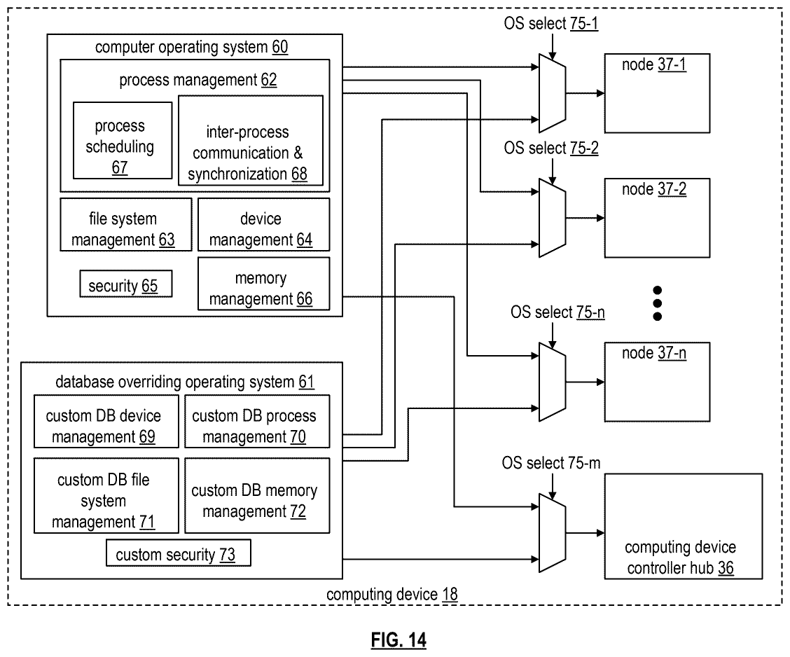

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

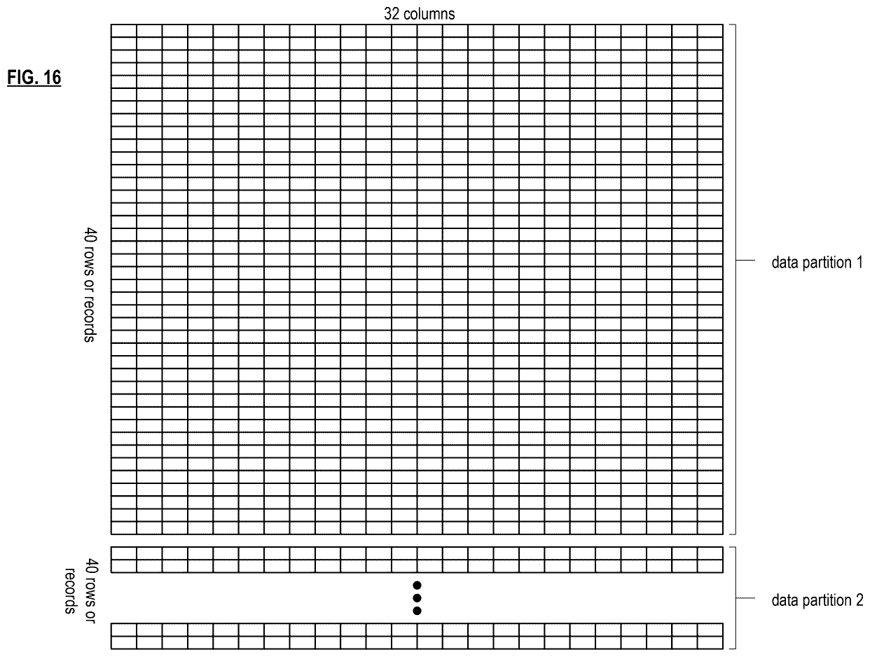

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

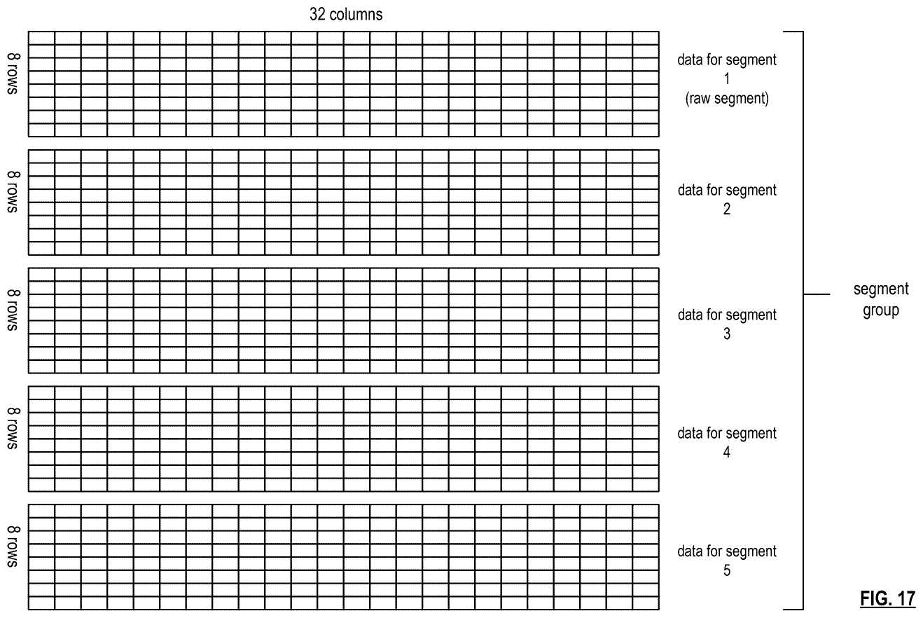

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

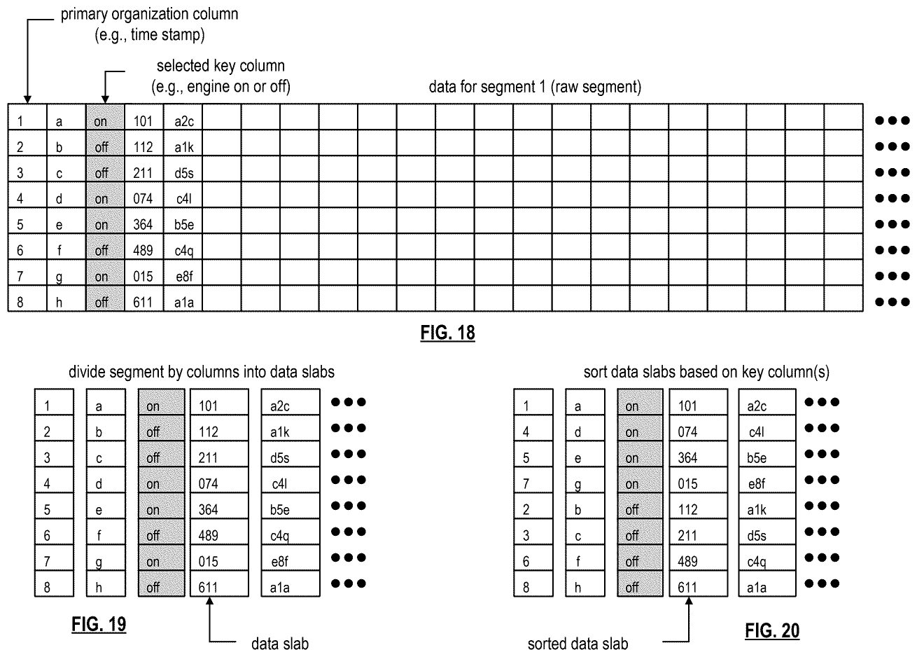

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

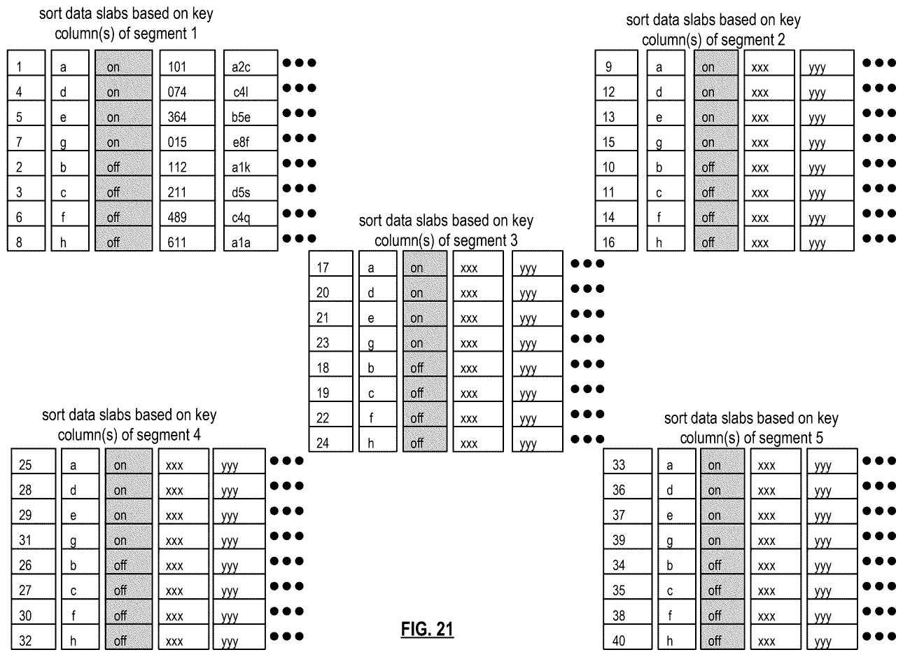

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

FIG. 21 illustrates an example of each segment of the segment group sorted into sorted data slabs. The similarity of data from segment to segment is for the convenience of illustration. Note that each segment has its own data, which may or may not be similar to the data in the other sections.

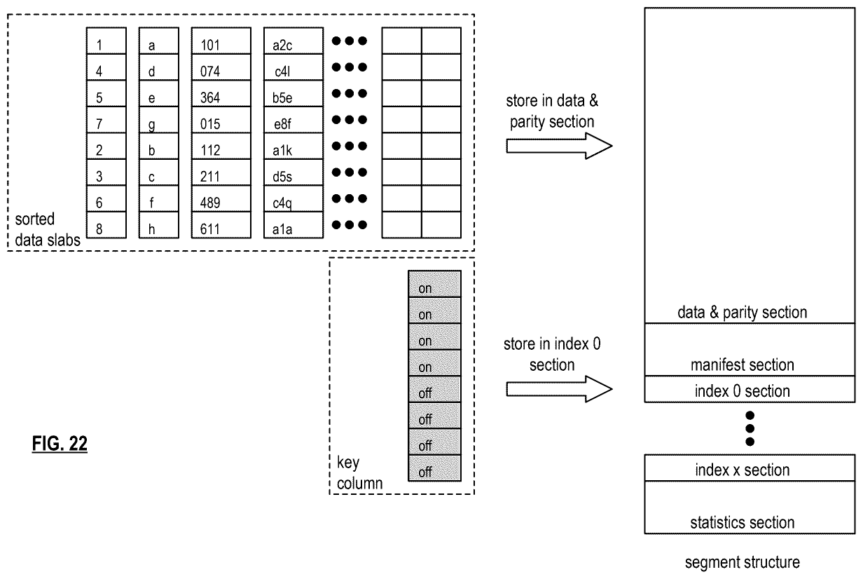

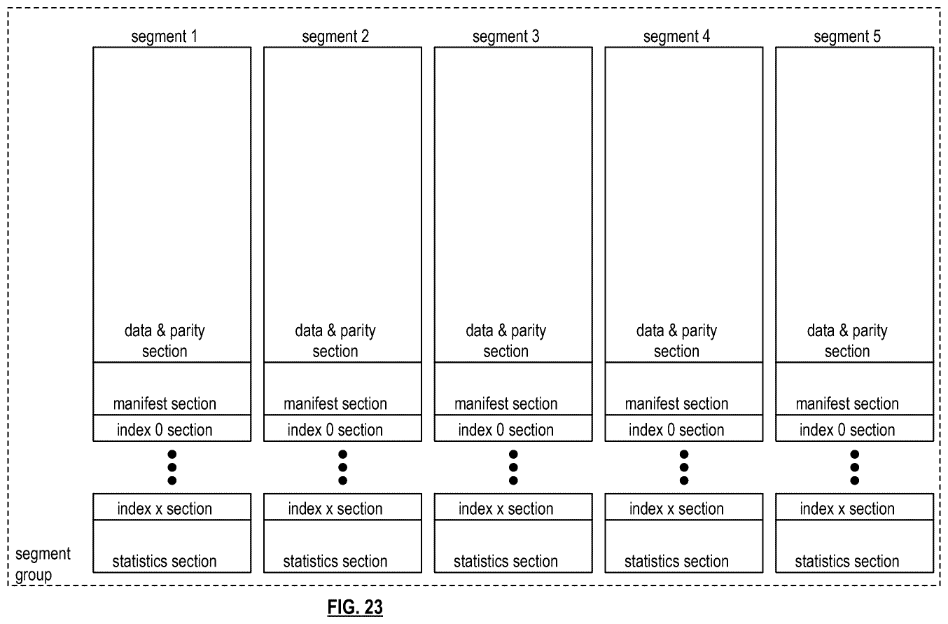

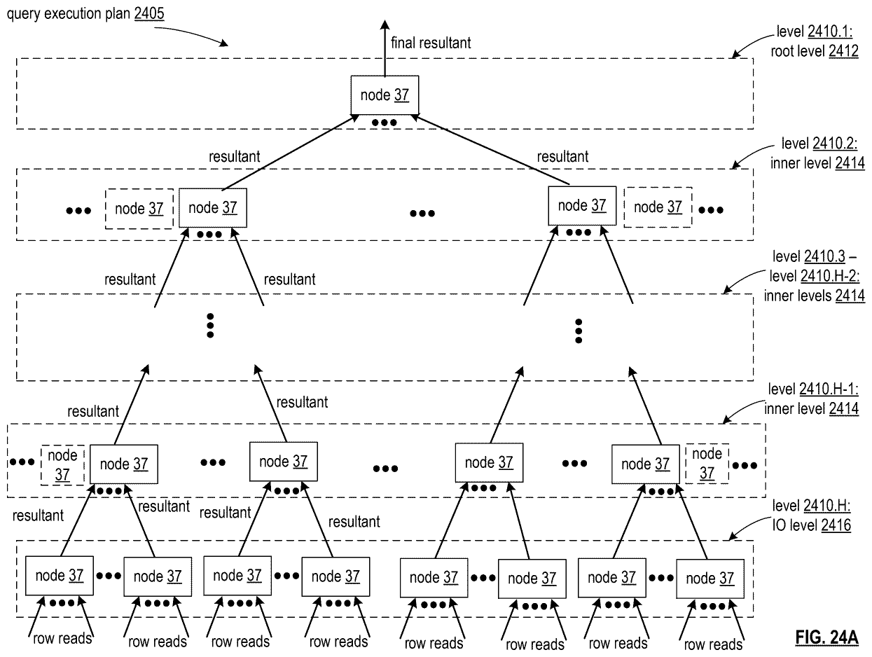

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

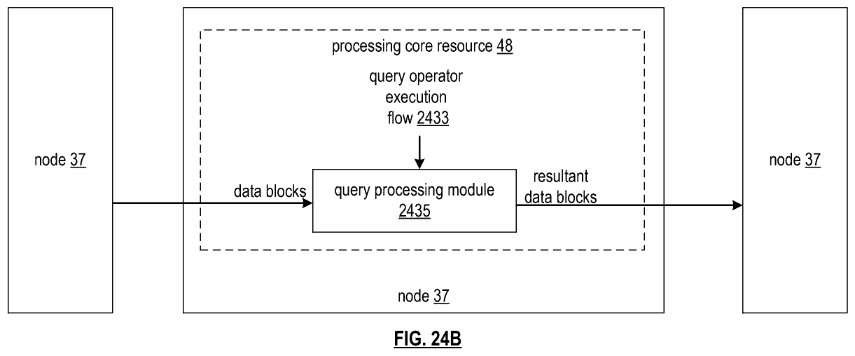

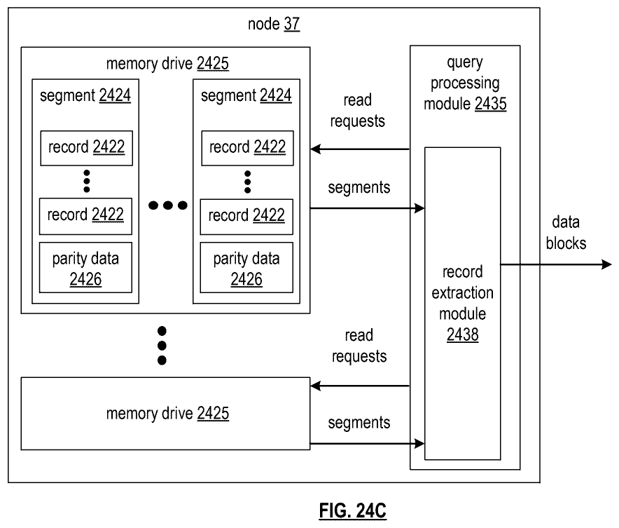

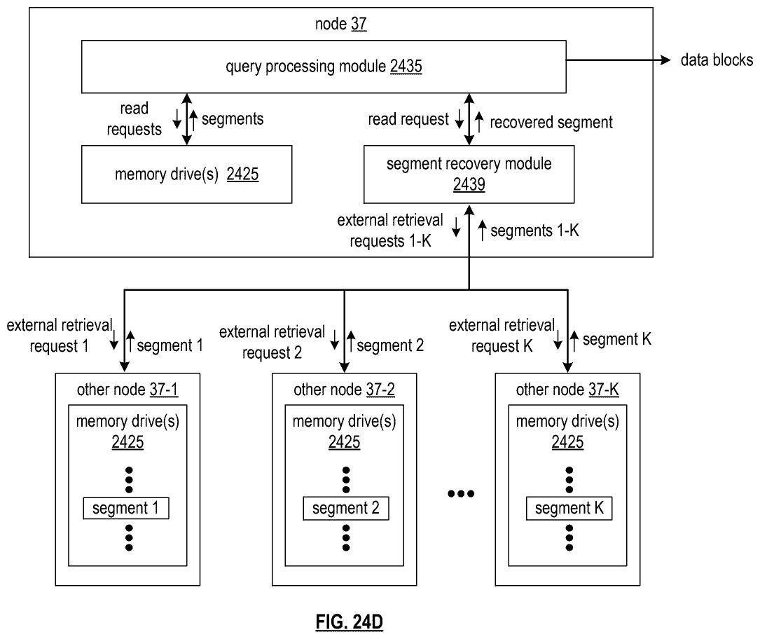

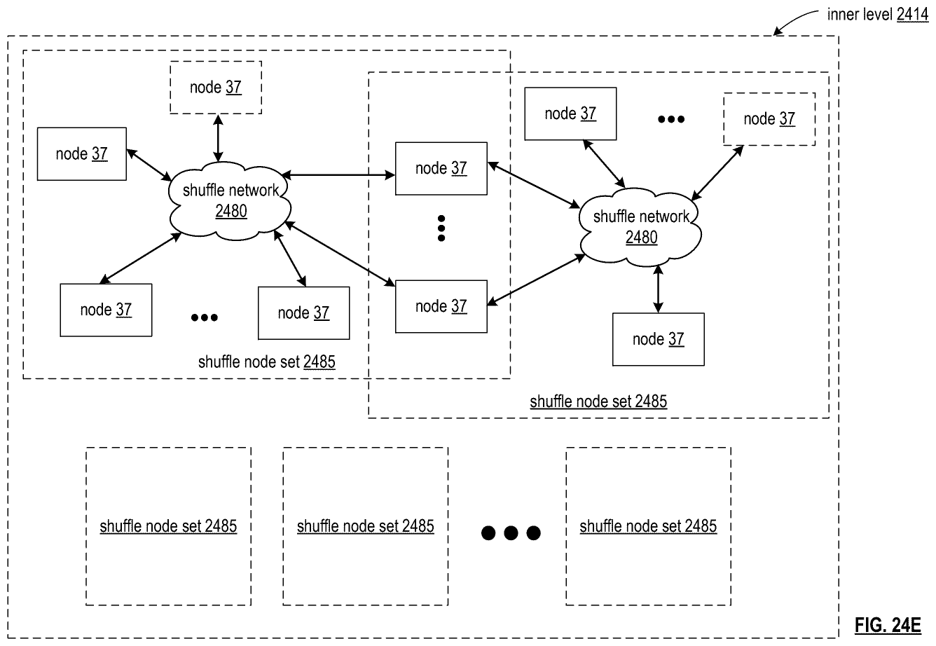

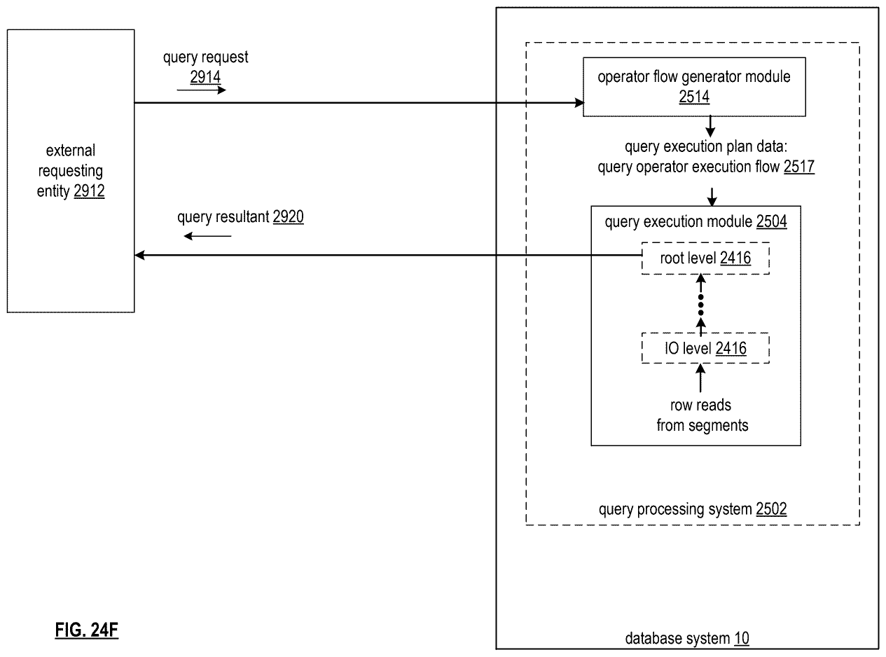

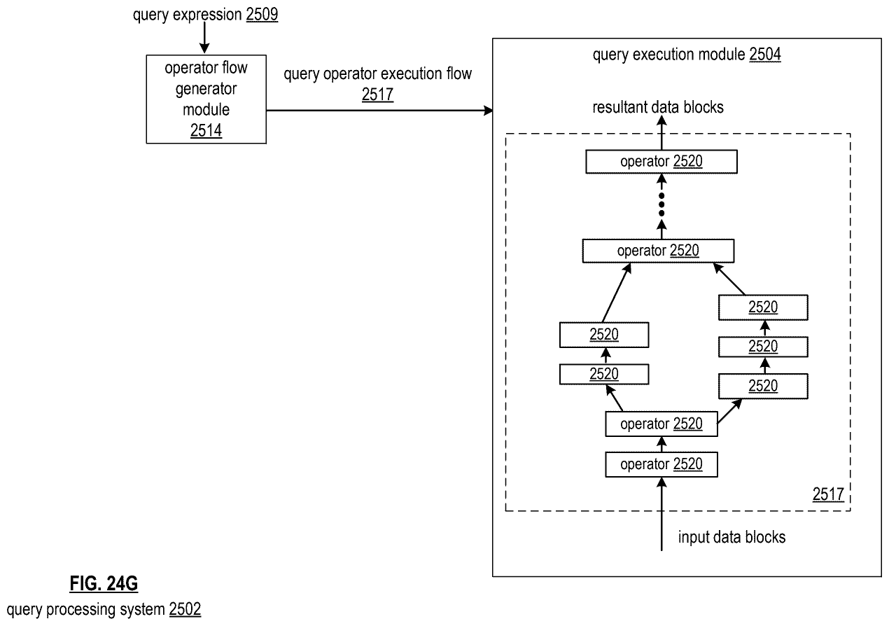

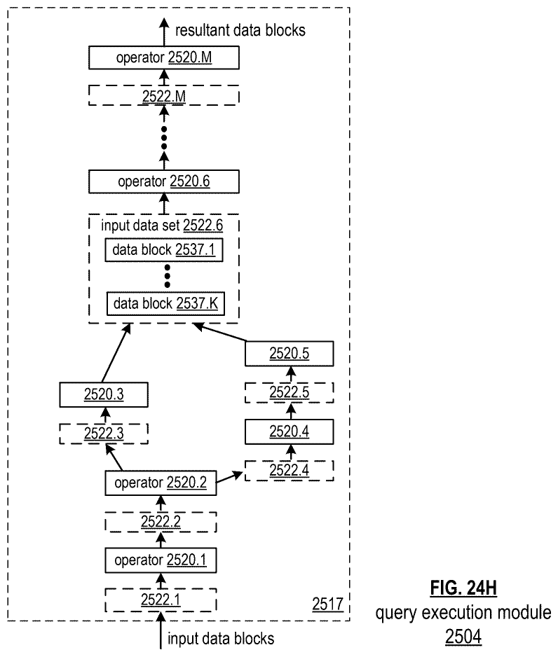

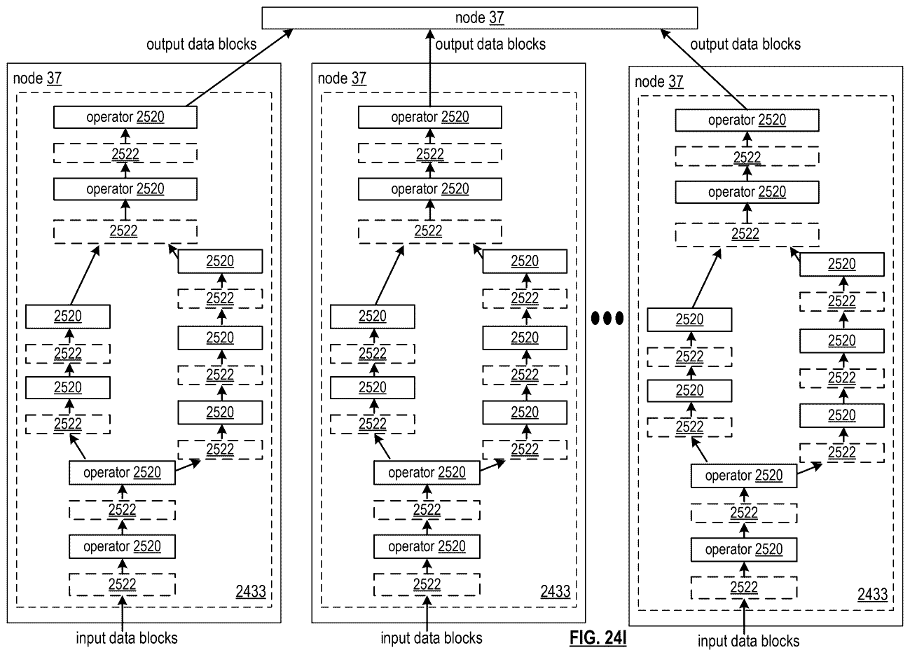

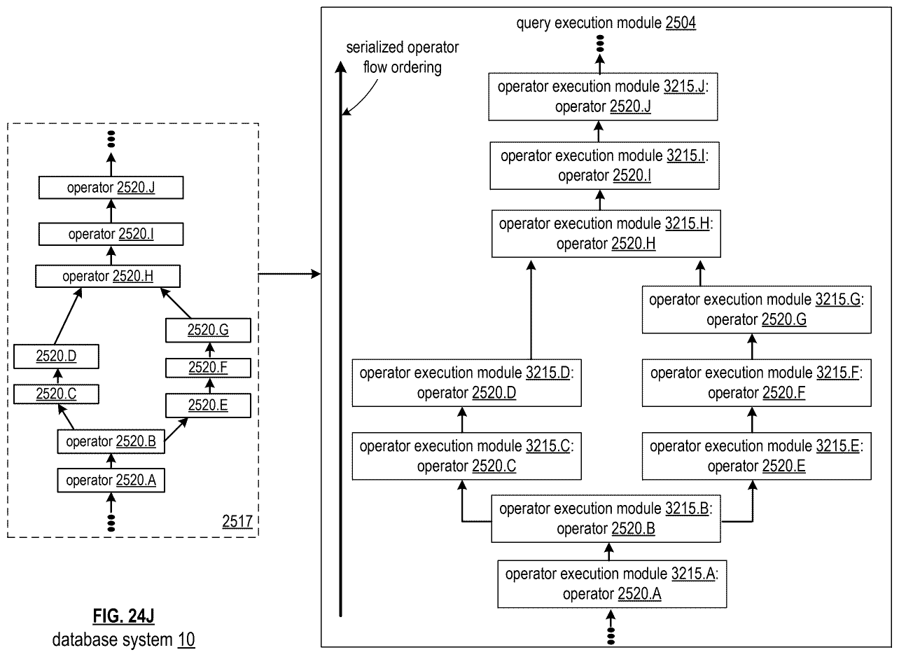

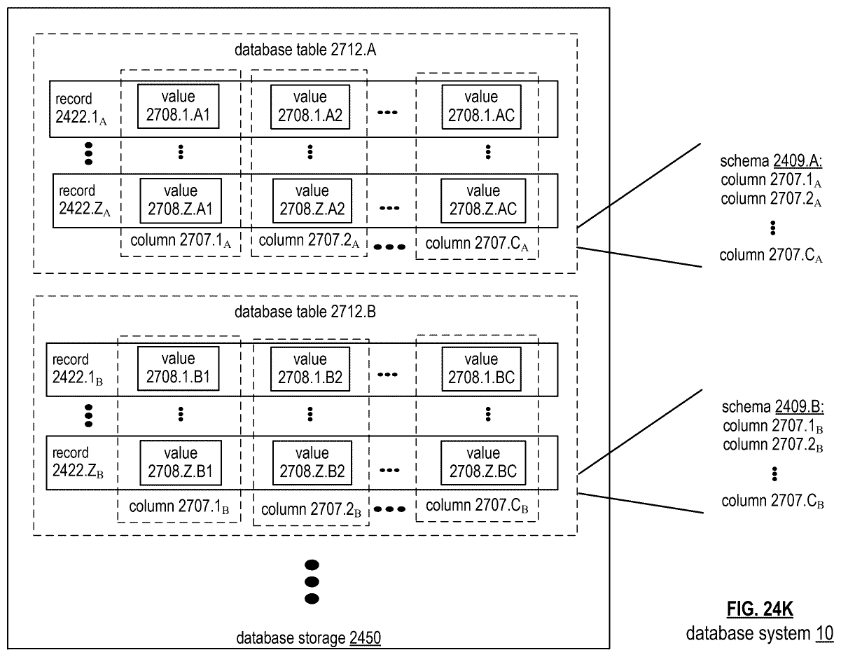

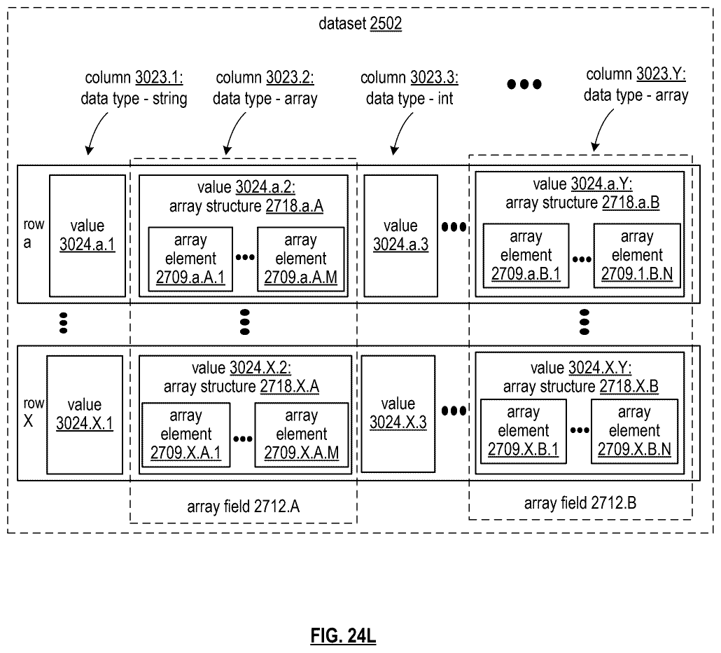

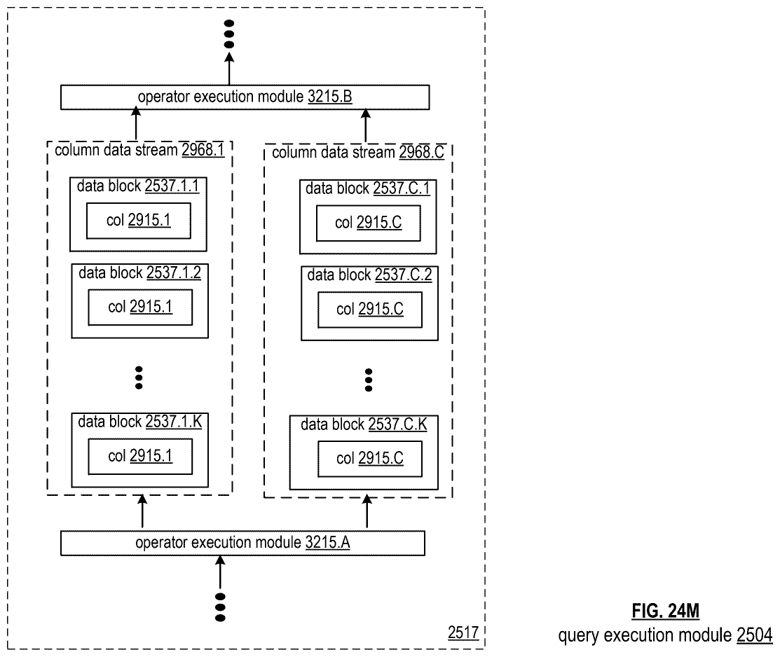

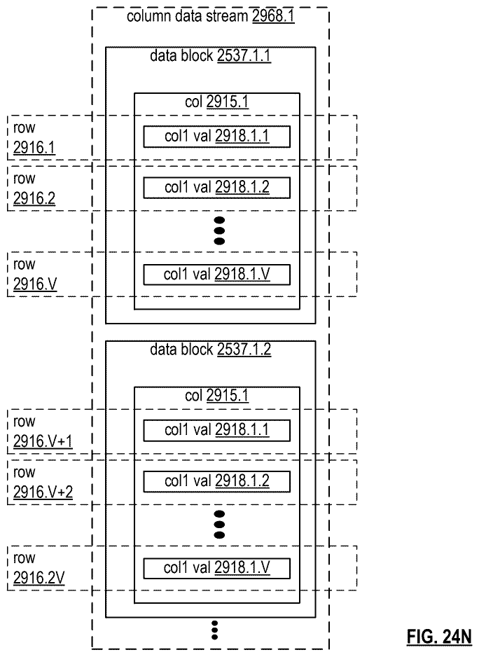

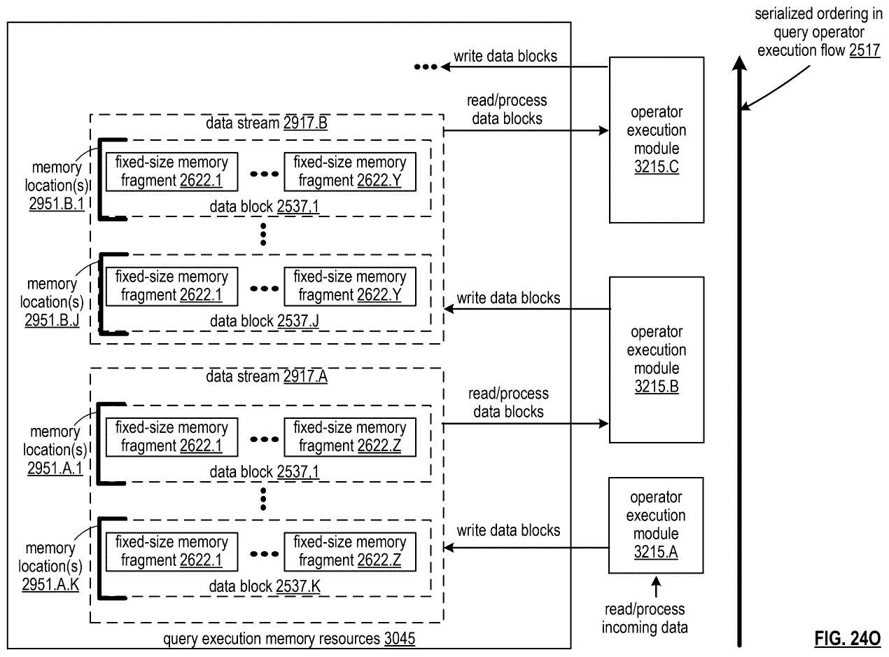

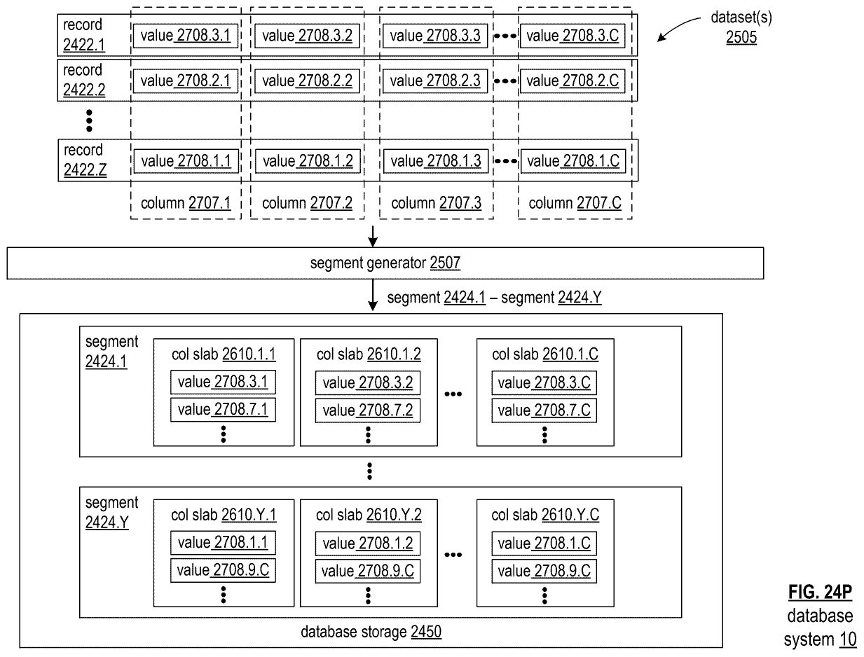

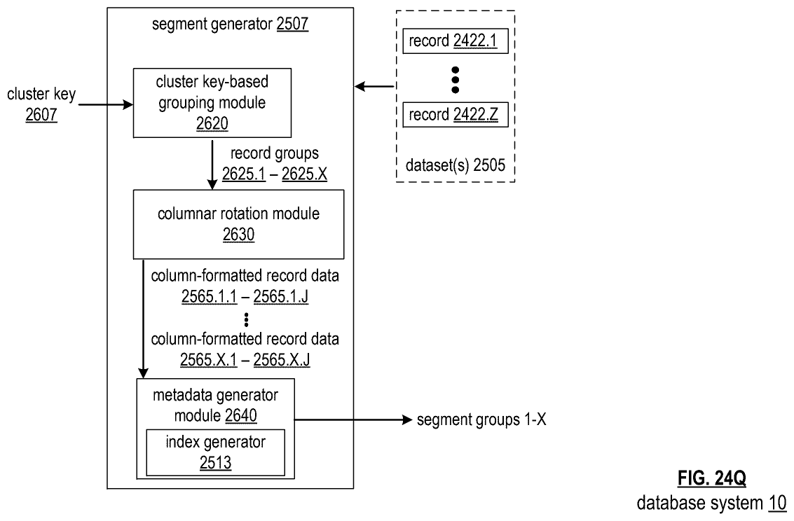

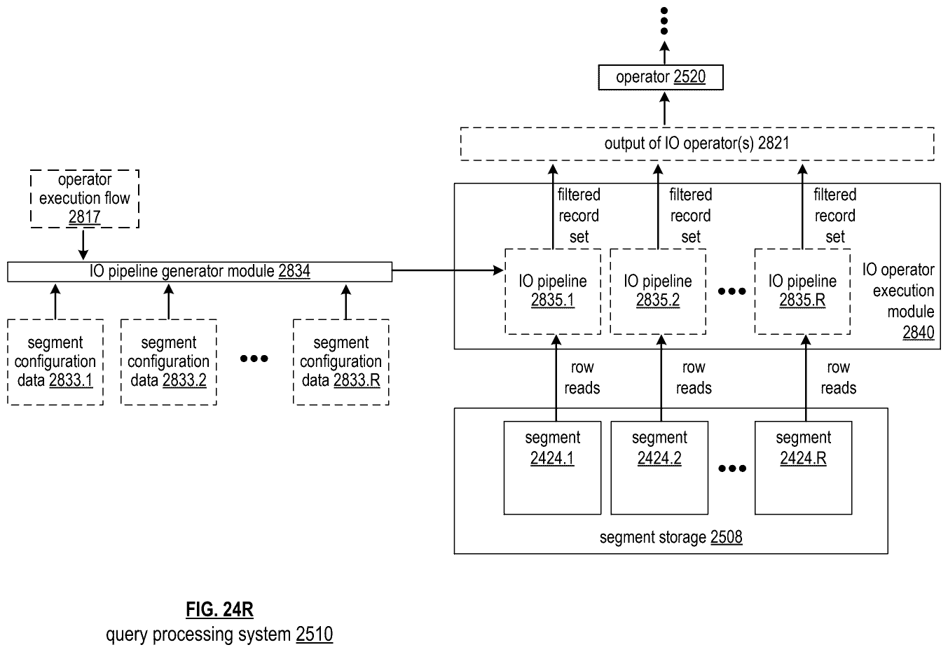

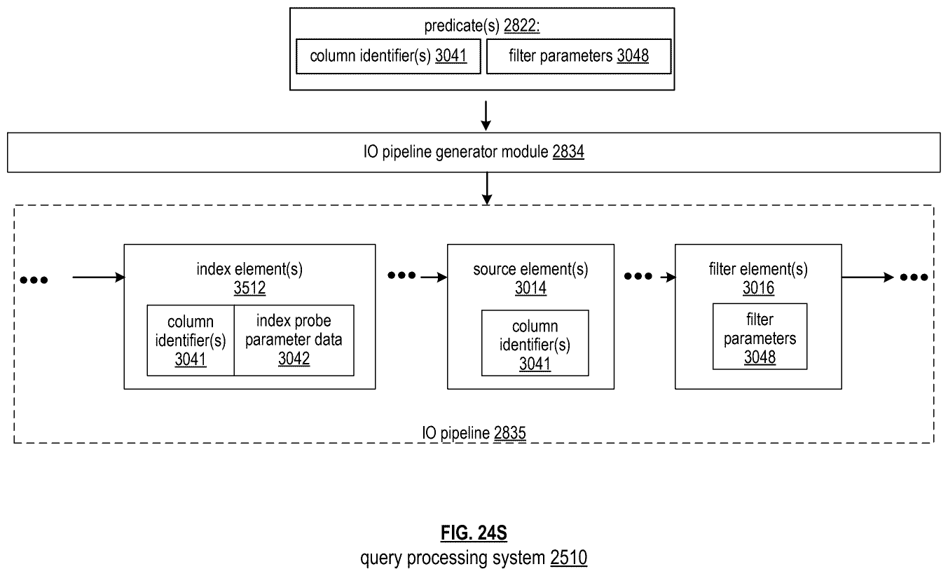

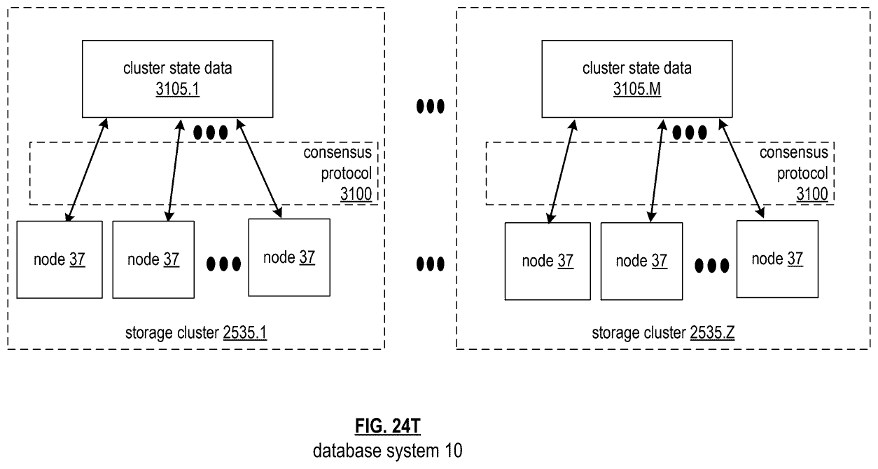

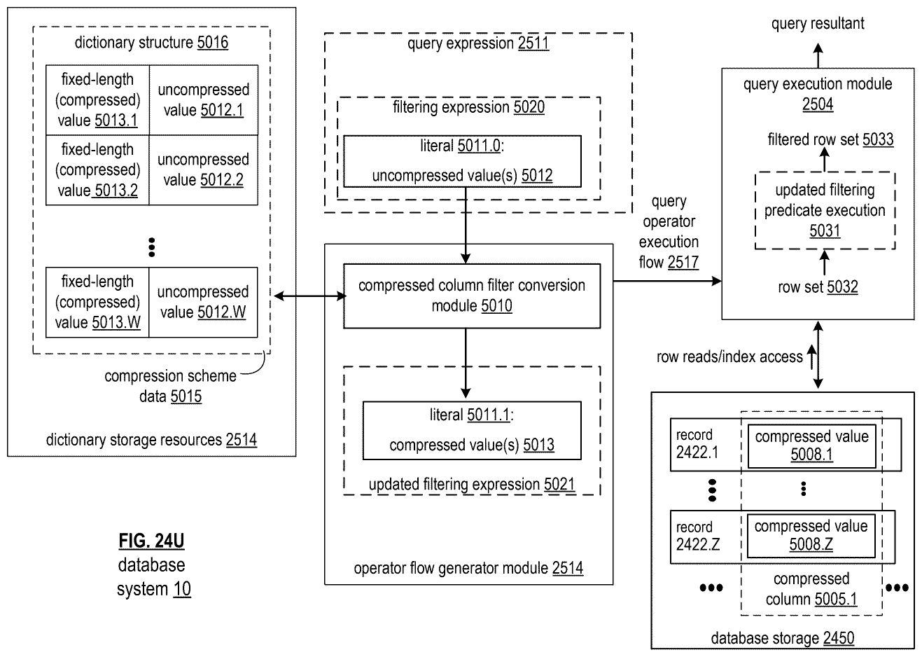

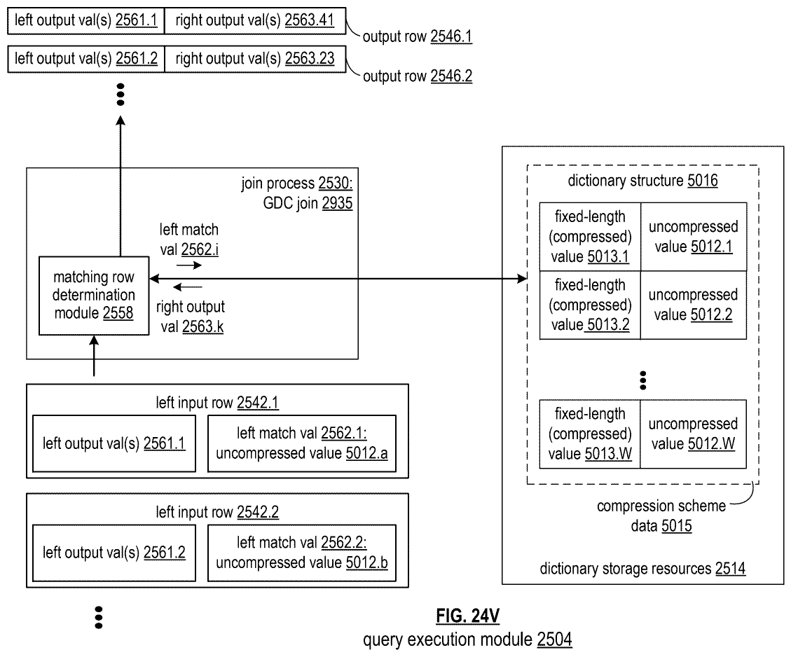

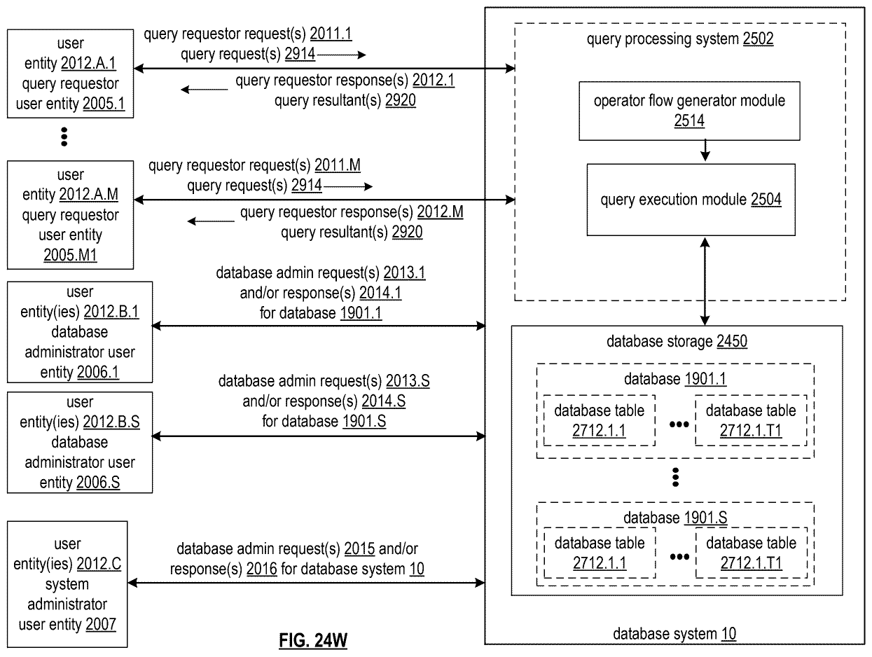

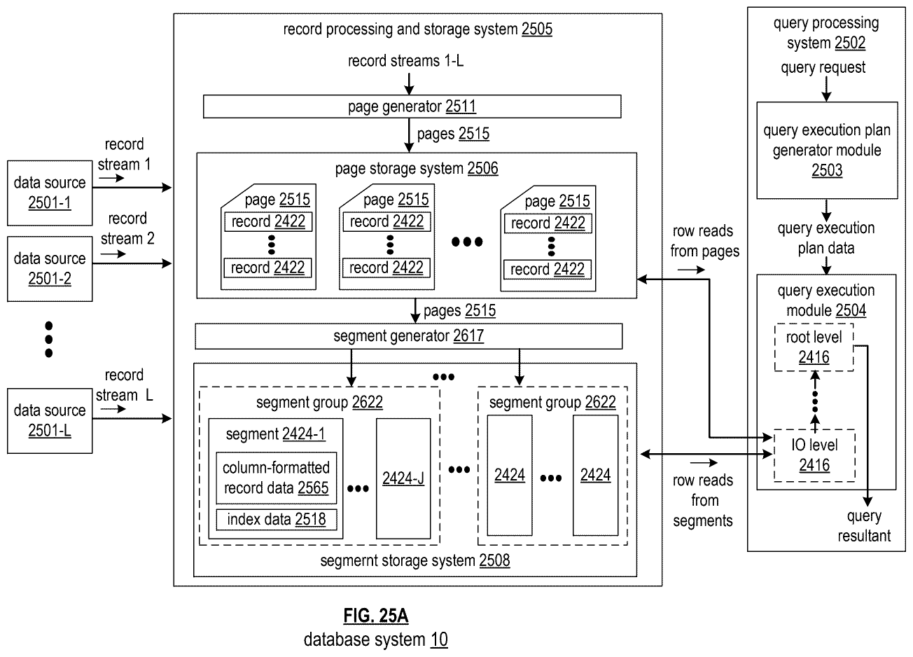

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H-1, and there are no other inner levels 2410.3-2410.H-2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H-1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined (e.g. as an acyclic directed graph of operators), and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H-1 includes at least one node from the IO level 2416 in the possible set of nodes. In such cases, while each selected node in level 2410.H-1 is depicted to process resultants sent from other nodes 37 in FIG. 24A, each selected node in level 2410.H-1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

Some or all features and/or functionality of FIG. 24A can be performed via at least one node 37 in conjunction with system metadata applied across a plurality of nodes 37, for example, where at least one node 37 participates in some or all features and/or functionality of FIG. 24A based on receiving and storing the system metadata in local memory of the at least one node 37 as configuration data and/or based on further accessing and/or executing this configuration data to participate in a query execution plan of FIG. 24A as part of its database functionality accordingly. Performance of some or all features and/or functionality of FIG. 24A can optionally change and/or be updated over time, and/or a set of nodes participating in executing some or all features and/or functionality of FIG. 24A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24B illustrates an embodiment of a node 37 executing a query in accordance with the query execution plan 2405 by implementing a query processing module 2435. The query processing module 2435 can be operable to execute a query operator execution flow 2433 determined by the node 37, where the query operator execution flow 2433 corresponds to the entirety of processing of the query upon incoming data assigned to the corresponding node 37 in accordance with its role in the query execution plan 2405. This embodiment of node 37 that utilizes a query processing module 2435 can be utilized to implement some or all of the plurality of nodes 37 of some or all computing devices 18-1-18-n, for example, of the of the parallelized data store, retrieve, and/or process sub-system 12, and/or of the parallelized query and results sub-system 13.

As used herein, execution of a particular query by a particular node 37 can correspond to the execution of the portion of the particular query assigned to the particular node in accordance with full execution of the query by the plurality of nodes involved in the query execution plan 2405. This portion of the particular query assigned to a particular node can correspond to execution of plurality of operators indicated by a query operator execution flow 2433 (e.g. as an acyclic directed graph of operators). In particular, the execution of the query for a node 37 at an inner level 2414 and/or root level 2412 corresponds to generating a resultant by processing all incoming resultants received from nodes at a lower level of the query execution plan 2405 that send their own resultants to the node 37. The execution of the query for a node 37 at the IO level corresponds to generating all resultant data blocks by retrieving and/or recovering all segments assigned to the node 37.

Thus, as used herein, a node 37's full execution of a given query corresponds to only a portion of the query's execution across all nodes in the query execution plan 2405. In particular, a resultant generated by an inner level node 37's execution of a given query may correspond to only a portion of the entire query result, such as a subset of rows in a final result set, where other nodes generate their own resultants to generate other portions of the full resultant of the query. In such embodiments, a plurality of nodes at this inner level can fully execute queries on different portions of the query domain independently in parallel by utilizing the same query operator execution flow 2433. Resultants generated by each of the plurality of nodes at this inner level 2414 can be gathered into a final result of the query, for example, by the node 37 at root level 2412 if this inner level is the top-most inner level 2414 or the only inner level 2414. As another example, resultants generated by each of the plurality of nodes at this inner level 2414 can be further processed via additional operators of a query operator execution flow 2433 being implemented by another node at a consecutively higher inner level 2414 of the query execution plan 2405, where all nodes at this consecutively higher inner level 2414 all execute their own same query operator execution flow 2433.

As discussed in further detail herein, the resultant generated by a node 37 can include a plurality of resultant data blocks generated via a plurality of partial query executions. As used herein, a partial query execution performed by a node corresponds to generating a resultant based on only a subset of the query input received by the node 37. In particular, the query input corresponds to all resultants generated by one or more nodes at a lower level of the query execution plan that send their resultants to the node. However, this query input can correspond to a plurality of input data blocks received over time, for example, in conjunction with the one or more nodes at the lower level processing their own input data blocks received over time to generate their resultant data blocks sent to the node over time. Thus, the resultant generated by a node's full execution of a query can include a plurality of resultant data blocks, where each resultant data block is generated by processing a subset of all input data blocks as a partial query execution upon the subset of all data blocks via the query operator execution flow 2433.

As illustrated in FIG. 24B, the query processing module 2435 can be implemented by a single processing core resource 48 of the node 37. In such embodiments, each one of the processing core resources 48-1-48-n of a same node 37 can be executing at least one query concurrently via their own query processing module 2435, where a single node 37 implements each of set of operator processing modules 2435-1-2435-n via a corresponding one of the set of processing core resources 48-1-48-n. A plurality of queries can be concurrently executed by the node 37, where each of its processing core resources 48 can each independently execute at least one query within a same temporal period by utilizing a corresponding at least one query operator execution flow 2433 to generate at least one query resultant corresponding to the at least one query.

Some or all features and/or functionality of FIG. 24B can be performed via a corresponding node 37 in conjunction with system metadata applied across a plurality of nodes 37 that includes the given node, for example, where the given node 37 participates in some or all features and/or functionality of FIG. 24B based on receiving and storing the system metadata in local memory of given node 37 as configuration data and/or based on further accessing and/or executing this configuration data to process data blocks via a query processing module as part of its database functionality accordingly. Performance of some or all features and/or functionality of FIG. 24B can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24C illustrates a particular example of a node 37 at the IO level 2416 of the query execution plan 2405 of FIG. 24A. A node 37 can utilize its own memory resources, such as some or all of its disk memory 38 and/or some or all of its main memory 40 to implement at least one memory drive 2425 that stores a plurality of segments 2424. Memory drives 2425 of a node 37 can be implemented, for example, by utilizing disk memory 38 and/or main memory 40. In particular, a plurality of distinct memory drives 2425 of a node 37 can be implemented via the plurality of memory devices 42-1-42-n of the node 37's disk memory 38.

Each segment 2424 stored in memory drive 2425 can be generated as discussed previously in conjunction with FIGS. 15-23. A plurality of records 2422 can be included in and/or extractable from the segment, for example, where the plurality of records 2422 of a segment 2424 correspond to a plurality of rows designated for the particular segment 2424 prior to applying the redundancy storage coding scheme as illustrated in FIG. 17. The records 2422 can be included in data of segment 2424, for example, in accordance with a column-format and/or other structured format. Each segments 2424 can further include parity data 2426 as discussed previously to enable other segments 2424 in the same segment group to be recovered via applying a decoding function associated with the redundancy storage coding scheme, such as a RAID scheme and/or erasure coding scheme, that was utilized to generate the set of segments of a segment group.

Thus, in addition to performing the first stage of query execution by being responsible for row reads, nodes 37 can be utilized for database storage, and can each locally store a set of segments in its own memory drives 2425. In some cases, a node 37 can be responsible for retrieval of only the records stored in its own one or more memory drives 2425 as one or more segments 2424. Executions of queries corresponding to retrieval of records stored by a particular node 37 can be assigned to that particular node 37. In other embodiments, a node 37 does not use its own resources to store segments. A node 37 can access its assigned records for retrieval via memory resources of another node 37 and/or via other access to memory drives 2425, for example, by utilizing system communication resources 14.

The query processing module 2435 of the node 37 can be utilized to read the assigned by first retrieving or otherwise accessing the corresponding redundancy-coded segments 2424 that include the assigned records its one or more memory drives 2425. Query processing module 2435 can include a record extraction module 2438 that is then utilized to extract or otherwise read some or all records from these segments 2424 accessed in memory drives 2425, for example, where record data of the segment is segregated from other information such as parity data included in the segment and/or where this data containing the records is converted into row-formatted records from the column-formatted row data stored by the segment. Once the necessary records of a query are read by the node 37, the node can further utilize query processing module 2435 to send the retrieved records all at once, or in a stream as they are retrieved from memory drives 2425, as data blocks to the next node 37 in the query execution plan 2405 via system communication resources 14 or other communication channels.

Some or all features and/or functionality of FIG. 24C can be performed via a corresponding node 37 in conjunction with system metadata applied across a plurality of nodes 37 that includes the given node, for example, where the given node 37 participates in some or all features and/or functionality of FIG. 24C based on receiving and storing the system metadata in local memory of given node 37 as configuration data and/or based on further accessing and/or executing this configuration data to read segments and/or extract rows from segments via a query processing module as part of its database functionality accordingly. Performance of some or all features and/or functionality of FIG. 24C can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24D illustrates an embodiment of a node 37 that implements a segment recovery module 2439 to recover some or all segments that are assigned to the node for retrieval, in accordance with processing one or more queries, that are unavailable. Some or all features of the node 37 of FIG. 24D can be utilized to implement the node 37 of FIGS. 24B and 24C, and/or can be utilized to implement one or more nodes 37 of the query execution plan 2405 of FIG. 24A, such as nodes 37 at the IO level 2416. A node 37 may store segments on one of its own memory drives 2425 that becomes unavailable, or otherwise determines that a segment assigned to the node for execution of a query is unavailable for access via a memory drive the node 37 accesses via system communication resources 14. The segment recovery module 2439 can be implemented via at least one processing module of the node 37, such as resources of central processing module 39. The segment recovery module 2439 can retrieve the necessary number of segments 1-K in the same segment group as an unavailable segment from other nodes 37, such as a set of other nodes 37-1-37-K that store segments in the same storage cluster 35. Using system communication resources 14 or other communication channels, a set of external retrieval requests 1-K for this set of segments 1-K can be sent to the set of other nodes 37-1-37-K, and the set of segments can be received in response. This set of K segments can be processed, for example, where a decoding function is applied based on the redundancy storage coding scheme utilized to generate the set of segments in the segment group and/or parity data of this set of K segments is otherwise utilized to regenerate the unavailable segment. The necessary records can then be extracted from the unavailable segment, for example, via the record extraction module 2438, and can be sent as data blocks to another node 37 for processing in conjunction with other records extracted from available segments retrieved by the node 37 from its own memory drives 2425.

Note that the embodiments of node 37 discussed herein can be configured to execute multiple queries concurrently by communicating with nodes 37 in the same or different tree configuration of corresponding query execution plans and/or by performing query operations upon data blocks and/or read records for different queries. In particular, incoming data blocks can be received from other nodes for multiple different queries in any interleaving order, and a plurality of operator executions upon incoming data blocks for multiple different queries can be performed in any order, where output data blocks are generated and sent to the same or different next node for multiple different queries in any interleaving order. IO level nodes can access records for the same or different queries any interleaving order. Thus, at a given point in time, a node 37 can have already begun its execution of at least two queries, where the node 37 has also not yet completed its execution of the at least two queries.

A query execution plan 2405 can guarantee query correctness based on assignment data sent to or otherwise communicated to all nodes at the IO level ensuring that the set of required records in query domain data of a query, such as one or more tables required to be accessed by a query, are accessed exactly one time: if a particular record is accessed multiple times in the same query and/or is not accessed, the query resultant cannot be guaranteed to be correct. Assignment data indicating segment read and/or record read assignments to each of the set of nodes 37 at the IO level can be generated, for example, based on being mutually agreed upon by all nodes 37 at the IO level via a consensus protocol executed between all nodes at the IO level and/or distinct groups of nodes 37 such as individual storage clusters 35. The assignment data can be generated such that every record in the database system and/or in query domain of a particular query is assigned to be read by exactly one node 37. Note that the assignment data may indicate that a node 37 is assigned to read some segments directly from memory as illustrated in FIG. 24C and is assigned to recover some segments via retrieval of segments in the same segment group from other nodes 37 and via applying the decoding function of the redundancy storage coding scheme as illustrated in FIG. 24D.

Assuming all nodes 37 read all required records and send their required records to exactly one next node 37 as designated in the query execution plan 2405 for the given query, the use of exactly one instance of each record can be guaranteed. Assuming all inner level nodes 37 process all the required records received from the corresponding set of nodes 37 in the IO level 2416, via applying one or more query operators assigned to the node in accordance with their query operator execution flow 2433, correctness of their respective partial resultants can be guaranteed. This correctness can further require that nodes 37 at the same level intercommunicate by exchanging records in accordance with JOIN operations as necessary, as records received by other nodes may be required to achieve the appropriate result of a JOIN operation. Finally, assuming the root level node receives all correctly generated partial resultants as data blocks from its respective set of nodes at the penultimate, highest inner level 2414 as designated in the query execution plan 2405, and further assuming the root level node appropriately generates its own final resultant, the correctness of the final resultant can be guaranteed.

In some embodiments, each node 37 in the query execution plan can monitor whether it has received all necessary data blocks to fulfill its necessary role in completely generating its own resultant to be sent to the next node 37 in the query execution plan. A node 37 can determine receipt of a complete set of data blocks that was sent from a particular node 37 at an immediately lower level, for example, based on being numbered and/or have an indicated ordering in transmission from the particular node 37 at the immediately lower level, and/or based on a final data block of the set of data blocks being tagged in transmission from the particular node 37 at the immediately lower level to indicate it is a final data block being sent. A node 37 can determine the required set of lower level nodes from which it is to receive data blocks based on its knowledge of the query execution plan 2405 of the query. A node 37 can thus conclude when a complete set of data blocks has been received each designated lower level node in the designated set as indicated by the query execution plan 2405. This node 37 can therefore determine itself that all required data blocks have been processed into data blocks sent by this node 37 to the next node 37 and/or as a final resultant if this node 37 is the root node. This can be indicated via tagging of its own last data block, corresponding to the final portion of the resultant generated by the node, where it is guaranteed that all appropriate data was received and processed into the set of data blocks sent by this node 37 in accordance with applying its own query operator execution flow 2433.

In some embodiments, if any node 37 determines it did not receive all of its required data blocks, the node 37 itself cannot fulfill generation of its own set of required data blocks. For example, the node 37 will not transmit a final data block tagged as the “last” data block in the set of outputted data blocks to the next node 37, and the next node 37 will thus conclude there was an error and will not generate a full set of data blocks itself. The root node, and/or these intermediate nodes that never received all their data and/or never fulfilled their generation of all required data blocks, can independently determine the query was unsuccessful. In some cases, the root node, upon determining the query was unsuccessful, can initiate re-execution of the query by re-establishing the same or different query execution plan 2405 in a downward fashion as described previously, where the nodes 37 in this re-established query execution plan 2405 execute the query accordingly as though it were a new query. For example, in the case of a node failure that caused the previous query to fail, the new query execution plan 2405 can be generated to include only available nodes where the node that failed is not included in the new query execution plan 2405.

Some or all features and/or functionality of FIG. 24D can be performed via a corresponding node 37 in conjunction with system metadata applied across a plurality of nodes 37 that includes the given node, for example, where the given node 37 participates in some or all features and/or functionality of FIG. 24D based on receiving and storing the system metadata in local memory of given node 37 as configuration data and/or based on further accessing and/or executing this configuration data to recover segments via external retrieval requests and performing a rebuilding process upon corresponding segments as part of its database functionality accordingly. Performance of some or all features and/or functionality of FIG. 24D can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24E illustrates an embodiment of an inner level 2414 that includes at least one shuffle node set 2485 of the plurality of nodes assigned to the corresponding inner level. A shuffle node set 2485 can include some or all of a plurality of nodes assigned to the corresponding inner level, where all nodes in the shuffle node set 2485 are assigned to the same inner level. In some cases, a shuffle node set 2485 can include nodes assigned to different levels 2410 of a query execution plan. A shuffle node set 2485 at a given time can include some nodes that are assigned to the given level, but are not participating in a query at that given time, as denoted with dashed outlines and as discussed in conjunction with FIG. 24A. For example, while a given one or more queries are being executed by nodes in the database system 10, a shuffle node set 2485 can be static, regardless of whether all of its members are participating in a given query at that time. In other cases, shuffle node set 2485 only includes nodes assigned to participate in a corresponding query, where different queries that are concurrently executing and/or executing in distinct time periods have different shuffle node sets 2485 based on which nodes are assigned to participate in the corresponding query execution plan. While FIG. 24E depicts multiple shuffle node sets 2485 of an inner level 2414, in some cases, an inner level can include exactly one shuffle node set, for example, that includes all possible nodes of the corresponding inner level 2414 and/or all participating nodes of the of the corresponding inner level 2414 in a given query execution plan.

While FIG. 24E depicts that different shuffle node sets 2485 can have overlapping nodes 37, in some cases, each shuffle node set 2485 includes a distinct set of nodes, for example, where the shuffle node sets 2485 are mutually exclusive. In some cases, the shuffle node sets 2485 are collectively exhaustive with respect to the corresponding inner level 2414, where all possible nodes of the inner level 2414, or all participating nodes of a given query execution plan at the inner level 2414, are included in at least one shuffle node set 2485 of the inner level 2414. If the query execution plan has multiple inner levels 2414, each inner level can include one or more shuffle node sets 2485. In some cases, a shuffle node set 2485 can include nodes from different inner levels 2414, or from exactly one inner level 2414. In some cases, the root level 2412 and/or the IO level 2416 have nodes included in shuffle node sets 2485. In some cases, the query execution plan 2405 includes and/or indicates assignment of nodes to corresponding shuffle node sets 2485 in addition to assigning nodes to levels 2410, where nodes 37 determine their participation in a given query as participating in one or more levels 2410 and/or as participating in one or more shuffle node sets 2485, for example, via downward propagation of this information from the root node to initiate the query execution plan 2405 as discussed previously.

The shuffle node sets 2485 can be utilized to enable transfer of information between nodes, for example, in accordance with performing particular operations in a given query that cannot be performed in isolation. For example, some queries require that nodes 37 receive data blocks from its children nodes in the query execution plan for processing, and that the nodes 37 additionally receive data blocks from other nodes at the same level 2410. In particular, query operations such as JOIN operations of a SQL query expression may necessitate that some or all additional records that were accessed in accordance with the query be processed in tandem to guarantee a correct resultant, where a node processing only the records retrieved from memory by its child IO nodes is not sufficient.

In some cases, a given node 37 participating in a given inner level 2414 of a query execution plan may send data blocks to some or all other nodes participating in the given inner level 2414, where these other nodes utilize these data blocks received from the given node to process the query via their query processing module 2435 by applying some or all operators of their query operator execution flow 2433 to the data blocks received from the given node. In some cases, a given node 37 participating in a given inner level 2414 of a query execution plan may receive data blocks to some or all other nodes participating in the given inner level 2414, where the given node utilizes these data blocks received from the other nodes to process the query via their query processing module 2435 by applying some or all operators of their query operator execution flow 2433 to the received data blocks.

This transfer of data blocks can be facilitated via a shuffle network 2480 of a corresponding shuffle node set 2485. Nodes in a shuffle node set 2485 can exchange data blocks in accordance with executing queries, for example, for execution of particular operators such as JOIN operators of their query operator execution flow 2433 by utilizing a corresponding shuffle network 2480. The shuffle network 2480 can correspond to any wired and/or wireless communication network that enables bidirectional communication between any nodes 37 communicating with the shuffle network 2480. In some cases, the nodes in a same shuffle node set 2485 are operable to communicate with some or all other nodes in the same shuffle node set 2485 via a direct communication link of shuffle network 2480, for example, where data blocks can be routed between some or all nodes in a shuffle network 2480 without necessitating any relay nodes 37 for routing the data blocks. In some cases, the nodes in a same shuffle set can broadcast data blocks.

In some cases, some nodes in a same shuffle node set 2485 do not have direct links via shuffle network 2480 and/or cannot send or receive broadcasts via shuffle network 2480 to some or all other nodes 37. For example, at least one pair of nodes in the same shuffle node set cannot communicate directly. In some cases, some pairs of nodes in a same shuffle node set can only communicate by routing their data via at least one relay node 37. For example, two nodes in a same shuffle node set do not have a direct communication link and/or cannot communicate via broadcasting their data blocks. However, if these two nodes in a same shuffle node set can each communicate with a same third node via corresponding direct communication links and/or via broadcast, this third node can serve as a relay node to facilitate communication between the two nodes. Nodes that are “further apart” in the shuffle network 2480 may require multiple relay nodes.

Thus, the shuffle network 2480 can facilitate communication between all nodes 37 in the corresponding shuffle node set 2485 by utilizing some or all nodes 37 in the corresponding shuffle node set 2485 as relay nodes, where the shuffle network 2480 is implemented by utilizing some or all nodes in the nodes shuffle node set 2485 and a corresponding set of direct communication links between pairs of nodes in the shuffle node set 2485 to facilitate data transfer between any pair of nodes in the shuffle node set 2485. Note that these relay nodes facilitating data blocks for execution of a given query within a shuffle node sets 2485 to implement shuffle network 2480 can be nodes participating in the query execution plan of the given query and/or can be nodes that are not participating in the query execution plan of the given query. In some cases, these relay nodes facilitating data blocks for execution of a given query within a shuffle node sets 2485 are strictly nodes participating in the query execution plan of the given query. In some cases, these relay nodes facilitating data blocks for execution of a given query within a shuffle node sets 2485 are strictly nodes that are not participating in the query execution plan of the given query.

Different shuffle node sets 2485 can have different shuffle networks 2480. These different shuffle networks 2480 can be isolated, where nodes only communicate with other nodes in the same shuffle node sets 2485 and/or where shuffle node sets 2485 are mutually exclusive. For example, data block exchange for facilitating query execution can be localized within a particular shuffle node set 2485, where nodes of a particular shuffle node set 2485 only send and receive data from other nodes in the same shuffle node set 2485, and where nodes in different shuffle node sets 2485 do not communicate directly and/or do not exchange data blocks at all. In some cases, where the inner level includes exactly one shuffle network, all nodes 37 in the inner level can and/or must exchange data blocks with all other nodes in the inner level via the shuffle node set via a single corresponding shuffle network 2480.

Alternatively, some or all of the different shuffle networks 2480 can be interconnected, where nodes can and/or must communicate with other nodes in different shuffle node sets 2485 via connectivity between their respective different shuffle networks 2480 to facilitate query execution. As a particular example, in cases where two shuffle node sets 2485 have at least one overlapping node 37, the interconnectivity can be facilitated by the at least one overlapping node 37, for example, where this overlapping node 37 serves as a relay node to relay communications from at least one first node in a first shuffle node sets 2485 to at least one second node in a second first shuffle node set 2485. In some cases, all nodes 37 in a shuffle node set 2485 can communicate with any other node in the same shuffle node set 2485 via a direct link enabled via shuffle network 2480 and/or by otherwise not necessitating any intermediate relay nodes. However, these nodes may still require one or more relay nodes, such as nodes included in multiple shuffle node sets 2485, to communicate with nodes in other shuffle node sets 2485, where communication is facilitated across multiple shuffle node sets 2485 via direct communication links between nodes within each shuffle node set 2485.

Note that these relay nodes facilitating data blocks for execution of a given query across multiple shuffle node sets 2485 can be nodes participating in the query execution plan of the given query and/or can be nodes that are not participating in the query execution plan of the given query. In some cases, these relay nodes facilitating data blocks for execution of a given query across multiple shuffle node sets 2485 are strictly nodes participating in the query execution plan of the given query. In some cases, these relay nodes facilitating data blocks for execution of a given query across multiple shuffle node sets 2485 are strictly nodes that are not participating in the query execution plan of the given query.

In some cases, a node 37 has direct communication links with its child node and/or parent node, where no relay nodes are required to facilitate sending data to parent and/or child nodes of the query execution plan 2405 of FIG. 24A. In other cases, at least one relay node may be required to facilitate communication across levels, such as between a parent node and child node as dictated by the query execution plan. Such relay nodes can be nodes within a and/or different same shuffle network as the parent node and child node, and can be nodes participating in the query execution plan of the given query and/or can be nodes that are not participating in the query execution plan of the given query.

Some or all features and/or functionality of FIG. 24E can be performed via at least one node 37 in conjunction with system metadata applied across a plurality of nodes 37, for example, where at least one node 37 participates in some or all features and/or functionality of FIG. 24E based on receiving and storing the system metadata in local memory of the at least one node 37 as configuration data and/or based on further accessing and/or executing this configuration data to participate in one or more shuffle node sets of FIG. 24E as part of its database functionality accordingly. Performance of some or all features and/or functionality of FIG. 24E can optionally change and/or be updated over time, and/or a set of nodes participating in executing some or all features and/or functionality of FIG. 24E can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24F illustrates an embodiment of a database system that receives some or all query requests from one or more external requesting entities 2912. The external requesting entities 2912 can be implemented as a client device such as a personal computer and/or device, a server system, or other external system that generates and/or transmits query requests 2914. A query resultant 2920 can optionally be transmitted back to the same or different external requesting entity 2912. Some or all query requests processed by database system 10 as described herein can be received from external requesting entities 2912 and/or some or all query resultants generated via query executions described herein can be transmitted to external requesting entities 2912.

For example, a user types or otherwise indicates a query for execution via interaction with a computing device associated with and/or communicating with an external requesting entity. The computing device generates and transmits a corresponding query request 2914 for execution via the database system 10, where the corresponding query resultant 2920 is transmitted back to the computing device, for example, for storage by the computing device and/or for display to the corresponding user via a display device.

As another example, a query is automatically generated for execution via processing resources via a computing device and/or via communication with an external requesting entity implemented via at least one computing device. For example, the query is automatically generated and/or modified from a request generated via user input and/or received from a requesting entity in conjunction with implementing a query generator system, a query optimizer, generative artificial intelligence (AI), and/or other artificial intelligence and/or machine learning techniques. The computing device generates and transmits a corresponding query request 2914 for execution via the database system 10, where the corresponding query resultant 2920 is transmitted back to the computing device, for example, for storage by the computing device, transmission to another system, and/or for display to at least one corresponding user via a display device.

Some or all features and/or functionality of FIG. 24F can be performed via at least one node 37 in conjunction with system metadata applied across a plurality of nodes 37, for example, where at least one node 37 participates in some or all features and/or functionality of FIG. 24F based on receiving and storing the system metadata in local memory of the at least one node 37 as configuration data, and/or based on further accessing and/or executing this configuration data to generate query execution plan data from query requests by implementing some or all of the operator flow generator module 2514 as part of its database functionality accordingly, and/or to participate in one or more query execution plans of a query execution module 2504 as part of its database functionality accordingly. Performance of some or all features and/or functionality of FIG. 24F can optionally change and/or be updated over time, and/or a set of nodes participating in executing some or all features and/or functionality of FIG. 24F can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24G illustrates an embodiment of a query processing system 2502 that generates a query operator execution flow 2517 from a query expression 2509 for execution via a query execution module 2504. The query processing system 2502 can be implemented utilizing, for example, the parallelized query and/or response sub-system 13 and/or the parallelized data store, retrieve, and/or process subsystem 12. The query processing system 2502 can be implemented by utilizing at least one computing device 18, for example, by utilizing at least one central processing module 39 of at least one node 37 utilized to implement the query processing system 2502. The query processing system 2502 can be implemented utilizing any processing module and/or memory of the database system 10, for example, communicating with the database system 10 via system communication resources 14.

As illustrated in FIG. 24G, an operator flow generator module 2514 of the query processing system 2502 can be utilized to generate a query operator execution flow 2517 for the query indicated in a query expression 2509. This can be generated based on a plurality of query operators indicated in the query expression and their respective sequential, parallelized, and/or nested ordering in the query expression (e.g. as an acyclic directed graph of operators), and/or based on optimizing the execution of the plurality of operators of the query expression. This query operator execution flow 2517 can include and/or be utilized to determine the query operator execution flow 2433 assigned to nodes 37 at one or more particular levels of the query execution plan 2405 and/or can include the operator execution flow to be implemented across a plurality of nodes 37, for example, based on a query expression indicated in the query request and/or based on optimizing the execution of the query expression.

In some cases, the operator flow generator module 2514 implements an optimizer to select the query operator execution flow 2517 based on determining the query operator execution flow 2517 is a most efficient and/or otherwise most optimal one of a set of query operator execution flow options and/or that arranges the operators in the query operator execution flow 2517 such that the query operator execution flow 2517 compares favorably to a predetermined efficiency threshold. For example, the operator flow generator module 2514 selects and/or arranges the plurality of operators of the query operator execution flow 2517 to implement the query expression in accordance with performing optimizer functionality, for example, by performing a deterministic function upon the query expression to select and/or arrange the plurality of operators in accordance with the optimizer functionality. This can be based on known and/or estimated processing times of different types of operators. This can be based on known and/or estimated levels of record filtering that will be applied by particular filtering parameters of the query. This can be based on selecting and/or deterministically utilizing a conjunctive normal form and/or a disjunctive normal form to build the query operator execution flow 2517 from the query expression. This can be based on selecting a determining a first possible serial ordering of a plurality of operators to implement the query expression based on determining the first possible serial ordering of the plurality of operators is known to be or expected to be more efficient than at least one second possible serial ordering of the same or different plurality of operators that implements the query expression. This can be based on ordering a first operator before a second operator in the query operator execution flow 2517 based on determining executing the first operator before the second operator results in more efficient execution than executing the second operator before the first operator. For example, the first operator is known to filter the set of records upon which the second operator would be performed to improve the efficiency of performing the second operator due to being executed upon a smaller set of records than if performed before the first operator. This can be based on other optimizer functionality that otherwise selects and/or arranges the plurality of operators of the query operator execution flow 2517 based on other known, estimated, and/or otherwise determined criteria.

A query execution module 2504 of the query processing system 2502 can execute the query expression via execution of the query operator execution flow 2517 to generate a query resultant. For example, the query execution module 2504 can be implemented via a plurality of nodes 37 that execute the query operator execution flow 2517. In particular, the plurality of nodes 37 of a query execution plan 2405 of FIG. 24A can collectively execute the query operator execution flow 2517. In such cases, nodes 37 of the query execution module 2504 can each execute their assigned portion of the query to produce data blocks as discussed previously, starting from IO level nodes propagating their data blocks upwards until the root level node processes incoming data blocks to generate the query resultant, where inner level nodes execute their respective query operator execution flow 2433 upon incoming data blocks to generate their output datablocks. The query execution module 2504 can be utilized to implement the parallelized query and results sub-system 13 and/or the parallelized data store, receive and/or process sub-system 12.

Some or all features and/or functionality of FIG. 24G can be performed via at least one node 37 in conjunction with system metadata applied across a plurality of nodes 37, for example, where at least one node 37 participates in some or all features and/or functionality of FIG. 24G based on receiving and storing the system metadata in local memory of the at least one node 37 as configuration data and/or based on further accessing and/or executing this configuration data to generate query execution plan data from query requests by executing some or all operators of a query operator flow 2517 as part of its database functionality accordingly. Performance of some or all features and/or functionality of FIG. 24G can optionally change and/or be updated over time, and/or a set of nodes participating in executing some or all features and/or functionality of FIG. 24G can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24H presents an example embodiment of a query execution module 2504 that executes query operator execution flow 2517. Some or all features and/or functionality of the query execution module 2504 of FIG. 24H can implement the query execution module 2504 of FIG. 24G and/or any other embodiment of the query execution module 2504 discussed herein. Some or all features and/or functionality of the query execution module 2504 of FIG. 24H can optionally be utilized to implement the query processing module 2435 of node 37 in FIG. 24B and/or to implement some or all nodes 37 at inner levels 2414 of a query execution plan 2405 of FIG. 24A.

The query execution module 2504 can execute the determined query operator execution flow 2517 by performing a plurality of operator executions of operators 2520 of the query operator execution flow 2517 in a corresponding plurality of sequential operator execution steps. Each operator execution step of the plurality of sequential operator execution steps can correspond to execution of a particular operator 2520 of a plurality of operators 2520-1-2520-M of a query operator execution flow 2433.

In some embodiments, a single node 37 executes the query operator execution flow 2517 as illustrated in FIG. 24H as their operator execution flow 2433 of FIG. 24B, where some or all nodes 37 such as some or all inner level nodes 37 utilize the query processing module 2435 as discussed in conjunction with FIG. 24B to generate output data blocks to be sent to other nodes 37 and/or to generate the final resultant by applying the query operator execution flow 2517 to input data blocks received from other nodes and/or retrieved from memory as read and/or recovered records. In such cases, the entire query operator execution flow 2517 determined for the query as a whole can be segregated into multiple query operator execution sub-flows 2433 that are each assigned to the nodes of each of a corresponding set of inner levels 2414 of the query execution plan 2405, where all nodes at the same level execute the same query operator execution flows 2433 upon different received input data blocks. In some cases, the query operator execution flows 2433 applied by each node 37 includes the entire query operator execution flow 2517, for example, when the query execution plan includes exactly one inner level 2414. In other embodiments, the query processing module 2435 is otherwise implemented by at least one processing module the query execution module 2504 to execute a corresponding query, for example, to perform the entire query operator execution flow 2517 of the query as a whole.

A single operator execution by the query execution module 2504, such as via a particular node 37 executing its own query operator execution flows 2433, by executing one of the plurality of operators of the query operator execution flow 2433. As used herein, an operator execution corresponds to executing one operator 2520 of the query operator execution flow 2433 on one or more pending data blocks 2537 in an operator input data set 2522 of the operator 2520. The operator input data set 2522 of a particular operator 2520 includes data blocks that were outputted by execution of one or more other operators 2520 that are immediately below the particular operator in a serial ordering of the plurality of operators of the query operator execution flow 2433. In particular, the pending data blocks 2537 in the operator input data set 2522 were outputted by the one or more other operators 2520 that are immediately below the particular operator via one or more corresponding operator executions of one or more previous operator execution steps in the plurality of sequential operator execution steps. Pending data blocks 2537 of an operator input data set 2522 can be ordered, for example as an ordered queue, based on an ordering in which the pending data blocks 2537 are received by the operator input data set 2522. Alternatively, an operator input data set 2522 is implemented as an unordered set of pending data blocks 2537.

If the particular operator 2520 is executed for a given one of the plurality of sequential operator execution steps, some or all of the pending data blocks 2537 in this particular operator 2520's operator input data set 2522 are processed by the particular operator 2520 via execution of the operator to generate one or more output data blocks. For example, the input data blocks can indicate a plurality of rows, and the operation can be a SELECT operator indicating a simple predicate. The output data blocks can include only proper subset of the plurality of rows that meet the condition specified by the simple predicate.

Once a particular operator 2520 has performed an execution upon a given data block 2537 to generate one or more output data blocks, this data block is removed from the operator's operator input data set 2522. In some cases, an operator selected for execution is automatically executed upon all pending data blocks 2537 in its operator input data set 2522 for the corresponding operator execution step. In this case, an operator input data set 2522 of a particular operator 2520 is therefore empty immediately after the particular operator 2520 is executed. The data blocks outputted by the executed data block are appended to an operator input data set 2522 of an immediately next operator 2520 in the serial ordering of the plurality of operators of the query operator execution flow 2433, where this immediately next operator 2520 will be executed upon its data blocks once selected for execution in a subsequent one of the plurality of sequential operator execution steps.

Operator 2520.1 can correspond to a bottom-most operator 2520 in the serial ordering of the plurality of operators 2520.1-2520.M. As depicted in FIG. 24G, operator 2520.1 has an operator input data set 2522.1 that is populated by data blocks received from another node as discussed in conjunction with FIG. 24B, such as a node at the IO level of the query execution plan 2405. Alternatively these input data blocks can be read by the same node 37 from storage, such as one or more memory devices that store segments that include the rows required for execution of the query. In some cases, the input data blocks are received as a stream over time, where the operator input data set 2522.1 may only include a proper subset of the full set of input data blocks required for execution of the query at a particular time due to not all of the input data blocks having been read and/or received, and/or due to some data blocks having already been processed via execution of operator 2520.1. In other cases, these input data blocks are read and/or retrieved by performing a read operator or other retrieval operation indicated by operator 2520.

Note that in the plurality of sequential operator execution steps utilized to execute a particular query, some or all operators will be executed multiple times, in multiple corresponding ones of the plurality of sequential operator execution steps. In particular, each of the multiple times a particular operator 2520 is executed, this operator is executed on set of pending data blocks 2537 that are currently in their operator input data set 2522, where different ones of the multiple executions correspond to execution of the particular operator upon different sets of data blocks that are currently in their operator queue at corresponding different times.

As a result of this mechanism of processing data blocks via operator executions performed over time, at a given time during the query's execution by the node 37, at least one of the plurality of operators 2520 has an operator input data set 2522 that includes at least one data block 2537. At this given time, one more other ones of the plurality of operators 2520 can have input data sets 2522 that are empty. For example, a given operator's operator input data set 2522 can be empty as a result of one or more immediately prior operators 2520 in the serial ordering not having been executed yet, and/or as a result of the one or more immediately prior operators 2520 not having been executed since a most recent execution of the given operator.

Some types of operators 2520, such as JOIN operators or aggregating operators such as SUM, AVERAGE, MAXIMUM, or MINIMUM operators, require knowledge of the full set of rows that will be received as output from previous operators to correctly generate their output. As used herein, such operators 2520 that must be performed on a particular number of data blocks, such as all data blocks that will be outputted by one or more immediately prior operators in the serial ordering of operators in the query operator execution flow 2517 to execute the query, are denoted as “blocking operators.” Blocking operators are only executed in one of the plurality of sequential execution steps if their corresponding operator queue includes all of the required data blocks to be executed. For example, some or all blocking operators can be executed only if all prior operators in the serial ordering of the plurality of operators in the query operator execution flow 2433 have had all of their necessary executions completed for execution of the query, where none of these prior operators will be further executed in accordance with executing the query.

Some operator output generated via execution of an operator 2520, alternatively or in addition to being added to the input data set 2522 of a next sequential operator in the sequential ordering of the plurality of operators of the query operator execution flow 2433, can be sent to one or more other nodes 37 in a same shuffle node set as input data blocks to be added to the input data set 2522 of one or more of their respective operators 2520. In particular, the output generated via a node's execution of an operator 2520 that is serially before the last operator 2520.M of the node's query operator execution flow 2433 can be sent to one or more other nodes 37 in a same shuffle node set as input data blocks to be added to the input data set 2522 of a respective operators 2520 that is serially after the last operator 2520.1 of the query operator execution flow 2433 of the one or more other nodes 37.

As a particular example, the node 37 and the one or more other nodes 37 in a shuffle node set all execute queries in accordance with the same, common query operator execution flow 2433, for example, based on being assigned to a same inner level 2414 of the query execution plan 2405. The output generated via a node's execution of a particular operator 2520.i this common query operator execution flow 2433 can be sent to the one or more other nodes 37 in a same shuffle node set as input data blocks to be added to the input data set 2522 the next operator 2520.i+1, with respect to the serialized ordering of the query of this common query operator execution flow 2433 of the one or more other nodes 37. For example, the output generated via a node's execution of a particular operator 2520.i is added input data set 2522 the next operator 2520.i+1 of the same node's query operator execution flow 2433 based on being serially next in the sequential ordering and/or is alternatively or additionally added to the input data set 2522 of the next operator 2520.i+1 of the common query operator execution flow 2433 of the one or more other nodes in a same shuffle node set based on being serially next in the sequential ordering.

In some cases, in addition to a particular node sending this output generated via a node's execution of a particular operator 2520.i to one or more other nodes to be input data set 2522 the next operator 2520.i+1 in the common query operator execution flow 2433 of the one or more other nodes 37, the particular node also receives output generated via some or all of these one or more other nodes' execution of this particular operator 2520.i in their own query operator execution flow 2433 upon their own corresponding input data set 2522 for this particular operator. The particular node adds this received output of execution of operator 2520.i by the one or more other nodes to the be input data set 2522 of its own next operator 2520.i+1.

This mechanism of sharing data can be utilized to implement operators that require knowledge of all records of a particular table and/or of a particular set of records that may go beyond the input records retrieved by children or other descendants of the corresponding node. For example, JOIN operators can be implemented in this fashion, where the operator 2520.i+1 corresponds to and/or is utilized to implement JOIN operator and/or a custom-join operator of the query operator execution flow 2517, and where the operator 2520.i+1 thus utilizes input received from many different nodes in the shuffle node set in accordance with their performing of all of the operators serially before operator 2520.i+1 to generate the input to operator 2520.i+1.

Some or all features and/or functionality of FIG. 24H can be performed via at least one node 37 in conjunction with system metadata applied across a plurality of nodes 37, for example, where at least one node 37 participates in some or all features and/or functionality of FIG. 24H based on receiving and storing the system metadata in local memory of the at least one node 37 as configuration data and/or based on further accessing and/or executing this configuration data execute some or all operators of a query operator flow 2517 as part of its database functionality accordingly. Performance of some or all features and/or functionality of FIG. 24H can optionally change and/or be updated over time, and/or a set of nodes participating in executing some or all features and/or functionality of FIG. 24H can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24I illustrates an example embodiment of multiple nodes 37 that execute a query operator execution flow 2433. For example, these nodes 37 are at a same level 2410 of a query execution plan 2405, and receive and perform an identical query operator execution flow 2433 in conjunction with decentralized execution of a corresponding query. Each node 37 can determine this query operator execution flow 2433 based on receiving the query execution plan data for the corresponding query that indicates the query operator execution flow 2433 to be performed by these nodes 37 in accordance with their participation at a corresponding inner level 2414 of the corresponding query execution plan 2405 as discussed in conjunction with FIG. 24G. This query operator execution flow 2433 utilized by the multiple nodes can be the full query operator execution flow 2517 generated by the operator flow generator module 2514 of FIG. 24G. This query operator execution flow 2433 can alternatively include a sequential proper subset of operators from the query operator execution flow 2517 generated by the operator flow generator module 2514 of FIG. 24G, where one or more other sequential proper subsets of the query operator execution flow 2517 are performed by nodes at different levels of the query execution plan.

Each node 37 can utilize a corresponding query processing module 2435 to perform a plurality of operator executions for operators of the query operator execution flow 2433 as discussed in conjunction with FIG. 24H. This can include performing an operator execution upon input data sets 2522 of a corresponding operator 2520, where the output of the operator execution is added to an input data set 2522 of a sequentially next operator 2520 in the operator execution flow, as discussed in conjunction with FIG. 24H, where the operators 2520 of the query operator execution flow 2433 are implemented as operators 2520 of FIG. 24H. Some or operators 2520 can correspond to blocking operators that must have all required input data blocks generated via one or more previous operators before execution. Each query processing module can receive, store in local memory, and/or otherwise access and/or determine necessary operator instruction data for operators 2520 indicating how to execute the corresponding operators 2520.

Some or all features and/or functionality of FIG. 24I can be performed via at least one node 37 in conjunction with system metadata applied across a plurality of nodes 37, for example, where at least one node 37 participates in some or all features and/or functionality of FIG. 24I based on receiving and storing the system metadata in local memory of the at least one node 37 as configuration data and/or based on further accessing and/or executing this configuration data to execute some or all operators of a query operator flow 2517 in parallel with other nodes, send data blocks to a parent node, and/or process data blocks from child nodes as part of its database functionality accordingly. Performance of some or all features and/or functionality of FIG. 24I can optionally change and/or be updated over time, and/or a set of nodes participating in executing some or all features and/or functionality of FIG. 24I can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24J illustrates an embodiment of a query execution module 2504 that executes each of a plurality of operators of a given operator execution flow 2517 via a corresponding one of a plurality of operator execution modules 3215. The operator execution modules 3215 of FIG. 24J can be implemented to execute any operators 2520 being executed by a query execution module 2504 for a given query as described herein.

In some embodiments, a given node 37 can optionally execute one or more operators, for example, when participating in a corresponding query execution plan 2405 for a given query, by implementing some or all features and/or functionality of the operator execution module 3215, for example, by implementing its operator processing module 2435 to execute one or more operator execution modules 3215 for one or more operators 2520 being processed by the given node 37. For example, a plurality of nodes of a query execution plan 2405 for a given query execute their operators based on implementing corresponding query processing modules 2435 accordingly.

FIG. 24K illustrates an embodiment of database storage 2450 operable to store a plurality of database tables 2712, such as relational database tables or other database tables as described previously herein. Database storage 2450 can be implemented via the parallelized data store, retrieve, and/or process sub-system 12, via memory drives 2425 of one or more nodes 37 implementing the database storage 2450, and/or via other memory and/or storage resources of database system 10. The database tables 2712 can be stored as segments as discussed in conjunction with FIGS. 15-23 and/or FIGS. 24B-24D. A database table 2712 can be implemented as one or more datasets and/or a portion of a given dataset, such as the dataset of FIG. 15.

A given database table 2712 can be stored based on being received for storage, for example, via the parallelized ingress sub-system 24 and/or via other data ingress. Alternatively or in addition, a given database table 2712 can be generated and/or modified by the database system 10 itself based on being generated as output of a query executed by query execution module 2504, such as a Create Table As Select (CTAS) query or Insert query.

A given database table 2712 can be in accordance with a schema 2409 defining columns of the database table, where records 2422 correspond to rows having values 2708 for some or all of these columns. Different database tables can have different numbers of columns and/or different datatypes for values stored in different columns. For example, the set of columns 27070.1_{A}-2707.C_{A} of schema 2709.A for database table 2712.A can have a different number of columns than and/or can have different datatypes for some or all columns of the set of columns 2707.1_{B}-2707.C_{B} of schema 2709.B for database table 2712.B. The schema 2409 for a given n database table 2712 can denote same or different datatypes for some or all of its set of columns. For example, some columns are variable-length and other columns are fixed-length. As another example, some columns are integers, other columns are binary values, other columns are Strings, and/or other columns are char types.

Row reads performed during query execution, such as row reads performed at the IO level of a query execution plan 2405, can be performed by reading values 2708 for one or more specified columns 2707 of the given query for some or all rows of one or more specified database tables, as denoted by the query expression defining the query to be performed. Filtering, join operations, and/or values included in the query resultant can be further dictated by operations to be performed upon the read values 2708 of these one or more specified columns 2707.

FIG. 24L illustrates an embodiment of a dataset 2502 having one or more columns 3023 implemented as array fields 2712. Some or all features and/or functionality of the dataset 2502 of FIG. 24L can be utilized to implement one or more of the database tables 2712 of FIG. 24K and/or any embodiment of any database table and/or dataset received, stored, and processed via the database system 10 as described herein.

Columns 3023 implemented as array fields 2712 can include array structures 2718 as values 3024 for some or all rows. A given array structure 2718 can have a set of elements 2709.1-2709.M. The value of M can be fixed for a given array field 2712, or can be different for different array structures 2718 of a given array field 2712. In embodiments where the number of elements is fixed, different array fields 2712 can have different fixed numbers of array elements 2709, for example, where a first array field 2712.A has array structures having M elements, and where a second array field 2712.B has array structures having N elements.

Note that a given array structure 2718 of a given array field can optionally have zero elements, where such array structures are considered as empty arrays satisfying the empty array condition. An empty array structure 2718 is distinct from a null value 3852, as it is a defined structure as an array 2718, despite not being populated with any values. For example, consider an example where an array field for rows corresponding to people is implemented to note a list of spouse names for all marriages of each person. An empty array for this array field for a first given row denotes a first corresponding person was never married, while a null value for this array field for a second given row denotes that it is unknown as to whether the second corresponding person was ever married, or who they were married to.

Array elements 2709 of a given array structure can have the same or different data type. In some embodiments, data types of array elements 2709 can be fixed for a given array field (e.g. all array elements 2709 of all array structures 2718 of array field 2712.A are string values, and all array elements 2709 of all array structures 2718 of array field 2712.B are integer values). In other embodiments, data types of array elements 2709 can be different for a given array field and/or a given array structure.

Some array structures 2718 that are non-empty can have one or more array elements having the null value 3852, where the corresponding value 3024 thus meets the null-inclusive array condition. This is distinct from the null value condition 3842, as the value 3024 itself is not null, but is instead an array structure 2718 having some or all of its array elements 2709 with values of null. Continuing example where an array field for rows corresponding to people is implemented to note a list of spouse names for all marriages of each person, a null value for this array field for the second given row denotes that it is unknown as to whether the second corresponding person was ever married or who they were married to, while a null value within an array structure for a third given row denotes that the name of the spouse for a corresponding one of a set of marriages of the person is unknown.

Some array structures 2718 that are non-empty can have all non-null values for its array elements 2709, where all corresponding array elements 2709 were populated and/or defined. Some array structures 2718 that are non-empty can have values for some of its array elements 2709 that are null, and values for others of its array elements 2709 that are non-null values.

Some array structures 2718 that are non-empty can have values for all of its array elements 2709 that are null. This is still distinct from the case where the value 3024 denotes a value of null with no array structure 2718. Continuing example where an array field for rows corresponding to people is implemented to note a list of spouse names for all marriages of each person, a null value for this array field for the second given row denotes that it is unknown as to whether the second corresponding person was ever married, how many times they were married or who they were married to, while the array structure for the third given row denotes a set of three null values and non-null values, denoting that the person was married three times, but the names of the spouses for all three marriages are unknown.

FIGS. 24M-24N illustrates an example embodiment of a query execution module 2504 of a database system 10 that executes queries via generation, storage, and/or communication of a plurality of column data streams 2968 corresponding to a plurality of columns. Some or all features and/or functionality of query execution module 2504 of FIGS. 24M-24N can implement any embodiment of query execution module 2504 described herein and/or any performance of query execution described herein. Some or all features and/or functionality of column data streams 2968 of FIGS. 24M-24N can implement any embodiment of data blocks 2537 and/or other communication of data between operators 2520 of a query operator execution flow 2517 when executed by a query execution module 2504, for example, via a corresponding plurality of operator execution modules 3215.

As illustrated in FIG. 24M, in some embodiments, data values of each given column 2915 are included in data blocks of their own respective column data stream 2968. Each column data stream 2968 can correspond to one given column 2915, where each given column 2915 is included in one data stream included in and/or referenced by output data blocks generated via execution of one or more operator execution module 3215, for example, to be utilized as input by one or more other operator execution modules 3215. Different columns can be designated for inclusion in different data streams. For example, different column streams are written do different portions of memory, such as different sets of memory fragments of query execution memory resources.

As illustrated in FIG. 24N, each data block 2537 of a given column data stream 2968 can include values 2918 for the respective column for one or more corresponding rows 2916. In the example of FIG. 24N, each data block includes values for V corresponding rows, where different data blocks in the column data stream include different respective sets of V rows, for example, that are each a subset of a total set of rows to be processed. In other embodiments, different data blocks can have different numbers of rows. The subsets of rows across a plurality of data blocks 2537 of a given column data stream 2968 can be mutually exclusive and collectively exhaustive with respect to the full output set of rows, for example, emitted by a corresponding operator execution module 3215 as output.

Values 2918 of a given row utilized in query execution are thus dispersed across different A given column 2915 can be implemented as a column 2707 having corresponding values 2918 implemented as values 2708 read from database table 2712 read from database storage 2450, for example, via execution of corresponding IO operators. Alternatively or in addition, a given column 2915 can be implemented as a column 2707 having new and/or modified values generated during query execution, for example, via execution of an extend expression and/or other operation. Alternatively or in addition, a given column 2915 can be implemented as a new column generated during query execution having new values generated accordingly, for example, via execution of an extend expression and/or other operation. The set of column data streams 2968 generated and/or emitted between operators in query execution can correspond to some or all columns of one or more tables 2712 and/or new columns of an existing table and/or of a new table generated during query execution.

Additional column streams emitted by the given operator execution module can have their respective values for the same full set of output rows across for other respective columns. For example, the values across all column streams are in accordance with a consistent ordering, where a first row's values 2918.1.1-2918.1.C for columns 2915.1-2915.C are included first in every respective column data stream, where a second row's values 2918.2.1-2918.2.C for columns 2915.1-2915.C are included second in every respective column data stream, and so on. In other embodiments, rows are optionally ordered differently in different column streams. Rows can be identified across column streams based on consistent ordering of values, based on being mapped to and/or indicating row identifiers, or other means.

As a particular example, for every fixed-length column, a huge block can be allocated to initialize a fixed length column stream, which can be implemented via mutable memory as a mutable memory column stream, and/or for every variable-length column, another huge block can be allocated to initialize a binary stream, which can be implemented via mutable memory as a mutable memory binary stream. A given column data stream 2968 can be continuously appended with fixed length values to data runs of contiguous memory and/or may grow the underlying huge page memory region to acquire more contiguous runs and/or fragments of memory.

In other embodiments, rather than emitting data blocks with values 2918 for different columns in different column streams, values 2918 for a set of multiple columns can be emitted in a same multi-column data stream.

FIG. 24O illustrates an example of operator execution modules 3215.C that each write their output memory blocks to one or more memory fragments 2622 of query execution memory resources 3045 and/or that each read/process input data blocks based on accessing the one or more memory fragments 2622 Some or all features and/or functionality of the operator execution modules 3215 of FIG. 24O can implement the operator execution modules of FIG. 24J and/or can implement any query execution described herein. The data blocks 2537 can implement the data blocks of column streams of FIGS. 24M and/or 24N, and/or any operator 2520's input data blocks and/or output data blocks described herein.

A given operator execution module 3215.A for an operator that is a child operator of the operator executed by operator execution module 3215.B can emit its output data blocks for processing by operator execution module 3215.B based on writing each of a stream of data blocks 2537.1-2537.K of data stream 2917.A to contiguous or non-contiguous memory fragments 2622 at one or more corresponding memory locations 2951 of query execution memory resources 3045.

Operator execution module 3215.A can generate these datablocks 2537.1-2537.K of data stream 2917.A in conjunction with execution of the respective operator on incoming data. This incoming data can correspond to one or more other streams of data blocks 2537 of another data stream 2917 accessed in memory resources 3045 based on being written by one or more child operator execution modules corresponding to child operators of the operator executed by operator execution module 3215.A. Alternatively or in addition, the incoming data is read from database storage 2450 and/or is read from one or more segments stored on memory drives, for example, based on the operator executed by operator execution module 3215.A being implemented as an IO operator.

The parent operator execution module 3215.B of operator execution module 3215.A can generate its own output data blocks 2537.1-2537.J of data stream 2917.B based on execution of the respective operator upon data blocks 2537.1-2537.K of data stream 2917.A. Executing the operator can include reading the values from and/or performing operations toy filter, aggregate, manipulate, generate new column values from, and/or otherwise determine values that are written to data blocks 2537.1-2537.J.

In other embodiments, the operator execution module 3215.B does not read the values from these data blocks, and instead forwards these data blocks, for example, where data blocks 2537.1-2537.J include memory reference data for the data blocks 2537.1-2537.K to enable one or more parent operator modules, such as operator execution module 3215.C, to access and read the values from forwarded streams.

In the case where operator execution module 3215.A has multiple parents, the datablocks 2537.1-2537.K of data stream 2917.A can be read, forwarded, and/or otherwise processed by each parent operator execution module 3215 independently in a same or similar fashion. Alternatively or in addition, in the case where operator execution module 3215.B has multiple children, each child's emitted set of data blocks 2537 of a respective data stream 2917 can be read, forwarded, and/or otherwise processed by operator execution module 3215.B in a same or similar fashion.

The parent operator execution module 3215.C of operator execution module 3215.B can similarly read, forward, and/or otherwise process data blocks 2537.1-2537.J of data stream 2917.B based on execution of the respective operator to render generation and emitting of its own data blocks in a similar fashion. Executing the operator can include reading the values from and/or performing operations to filter, aggregate, manipulate, generate new column values from, and/or otherwise process data blocks 2537.1-2537.J to determine values that are written to its own output data. For example, the operator execution module 3215.C reads data blocks 2537.1-2537.K of data stream 2917.A and/or the operator execution module 3215.B writes data blocks 2537.1-2537.J of data stream 2917.B. As another example, the operator execution module 3215.C reads data blocks 2537.1-2537.K of data stream 2917.A, or data blocks of another descendent, based on having been forwarded, where corresponding memory reference information denoting the location of these data blocks is read and processed from the received data blocks data blocks 2537.1-2537.J of data stream 2917.B enable accessing the values from data blocks 2537.1-2537.K of data stream 2917.A. As another example, the operator execution module 3215.B does not read the values from these data blocks, and instead forwards these data blocks, for example, where data blocks 2537.1-2537.J include memory reference data for the datablocks 2537.1-2537.J to enable one or more parent operator modules to read these forwarded streams.

This pattern of reading and/or processing input data blocks from one or more children for use in generating output data blocks for one or more parents can continue until ultimately a final operator, such as an operator executed by a root level node, generates a query resultant, which can itself be stored as data blocks in this fashion in query execution memory resources and/or can be transmitted to a requesting entity for display and/or storage.

For example, rather than accessing this large data for some or all potential records prior to filtering in a query execution, for example, via IO level 2416 of a corresponding query execution plan 2405 as illustrated in FIGS. 24A and 24C, and/or rather than passing this large data to other nodes 37 for processing, for example, from IO level nodes 37 to inner level nodes 37 and/or between any nodes 37 as illustrated in FIGS. 24A, 24B, and 24C, this large data is not accessed until a final stage of a query. As a particular example, this large data of the projected field is simply joined at the end of the query for the corresponding outputted rows that meet query predicates of the query. This ensures that, rather than accessing and/or passing the large data of these fields for some or all possible records that may be projected in the resultant, only the large data of these fields for final, filtered set of records that meet the query predicates are accessed and projected.

FIG. 24P illustrates an embodiment of a database system 10 that implements a segment generator 2507 to generate segments 2424. Some or all features and/or functionality of the database system 10 of FIG. 24P can implement any embodiment of the database system 10 described herein. Some or all features and/or functionality of segments 2424 of FIG. 24P can implement any embodiment of segment 2424 described herein.

A plurality of records 2422.1-2422.Z of one or more datasets 2505 to be converted into segments can be processed to generate a corresponding plurality of segments 2424.1-2424.Y. Each segment can include a plurality of column slabs 2610.1-2610.C corresponding to some or all of the C columns of the set of records.

In some embodiments, the dataset 2505 can correspond to a given database table 2712. In some embodiments, the dataset 2505 can correspond to only portion of a given database table 2712 (e.g. the most recently received set of records of a stream of records received for the table over time), where other datasets 2505 are later processed to generate new segments as more records are received over time. In some embodiments, the dataset 2505 can correspond to multiple database tables. The dataset 2505 optionally includes non-relational records and/or any records/files/data that is received from/generated by a given data source multiple different data sources.

Each record 2422 of the incoming dataset 2505 can be assigned to be included in exactly one segment 2424. In this example, segment 2424.1 includes at least records 2422.3 and 2422.7, while segment 2424 includes at least records 2422.1 and 2422.9. All of the Z records can be guaranteed to be included in exactly one segment by segment generator 2507. Rows are optionally grouped into segments based on a cluster-key based grouping or other grouping by same or similar column values of one or more columns. Alternatively, rows are optionally grouped randomly, in accordance with a round robin fashion, or by any other means.

A given row 2422 can thus have all of its column values 2708.1-2708.C included in exactly one given segment 2424, where these column values are dispersed across different column slabs 2610 based on which columns each column value corresponds. This division of column values into different column slabs can implement the columnar-format of segments described herein. The generation of column slabs can optionally include further processing of each set of column values assigned to each column slab. For example, some or all column slabs are optionally compressed and stored as compressed column slabs.

The database storage 2450 can thus store one or more datasets as segments 2424, for example, where these segments 2424 are accessed during query execution to identify/read values of rows of interest as specified in query predicates, where these identified rows/the respective values are further filtered/processed/etc., for example, via operators 2520 of a corresponding query operator execution flow 2517, or otherwise accordance with the query to render generation of the query resultant.

FIG. 24Q illustrates an example embodiment of a segment generator 2507 of database system 10. Some or all features and/or functionality of the database system 10 of FIG. 24Q can implement any embodiment of the database system 10 described herein. Some or all features and/or functionality of the segment generator 2507 of FIG. 24Q can implement the segment generator 2507 of FIG. 24P and/or any embodiment of the segment generator 2507 described herein.

The segment generator 2507 can implement a cluster key-based grouping module 2620 to group records of a dataset 2505 by a predetermined cluster key 2607, which can correspond to one or more columns. The cluster key can be received, accessed in memory, configured via user input, automatically selected based on an optimization, or otherwise determined. This grouping by cluster key can render generation of a plurality of record groups 2625.1-2625.X.

The segment generator 2507 can implement a columnar rotation module 2630 to generate a plurality of column formatted record data (e.g. column slabs 2610 to be included in respective segments 2424). Each record group 2625 can have a corresponding set of J column-formatted record data 2565.1-2565.J generated, for example, corresponding to J segments in a given segment group.

A metadata generator module 2640 can further generate parity data, index data, statistical data, and/or other metadata to be included in segments in conjunction with the column-formatted record data. A set of X segment groups corresponding to the X record groups can be generated and stored in database storage 2450. For example, each segment group includes J segments, where parity data of a proper subset of segments in the segment group can be utilized to rebuild column-formatted record data of other segments in the same segment group as discussed previously.

In some embodiments, the segment generator 2507 implements some or all features and/or functionality of the segment generator disclosed by: U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility patent application for all purposes; U.S. Utility application Ser. No. 16/985,957 entitled “PARALLELIZED SEGMENT GENERATION VIA KEY-BASED SUBDIVISION IN DATABASE SYSTEMS”, filed Aug. 5, 2020, which is hereby incorporated herein by reference in its entirety and made part of the present U.S. Utility patent application for all purposes; and/or U.S. Utility application Ser. No. 16/985,930, entitled “RECORD DEDUPLICATION IN DATABASE SYSTEMS”, filed Aug. 5, 2020, issued as U.S. Pat. No. 11,321,288 on May 3, 2022, which is hereby incorporated herein by reference in its entirety and made part of the present U.S. Utility patent application for all purposes. For example, the database system 10 implements some or all features and/or functionality of record processing and storage system of U.S. Utility application Ser. No. 16/985,723, U.S. Utility application Ser. No. 16/985,957, and/or U.S. Utility application Ser. No. 16/985,930.

FIG. 24R illustrates an embodiment of a query processing system 2510 that implements an IO pipeline generator module 2834 to generate a plurality of IO pipelines 2835.1-2835.R for a corresponding plurality of segments 2424.1-2424.R, where these IO pipelines 2835.1-2835.R are each executed by an IO operator execution module 2840 to facilitate generation of a filtered record set by accessing the corresponding segment. Some or all features and/or functionality of the query processing system 2510 of FIG. 24R can implement any embodiment of query processing system 2510, any embodiment of query execution module 2504, and/or any embodiment of executing a query described herein.

Each IO pipeline 2835 can be generated based on corresponding segment configuration data 2833 for the corresponding segment 2424, such as secondary indexing data for the segment, statistical data/cardinality data for the segment, compression schemes applied to the column slabs of the segment, or other information denoting how the segment is configured. For example, different segments 2424 have different IO pipelines 2835 generated for a given query based on having different secondary indexing schemes, different statistical data/cardinality data for its values, different compression schemes applied for some of all of the columns of its records, or other differences.

An IO operator execution module 2840 can execute each respective IO pipeline 2835. For example, the IO operator execution module 2840 is implemented by nodes 37 at the IO level of a corresponding query execution plan 2405, where a node 37 storing a given segment 2424 is responsible for accessing the segment as described previously, and thus executes the IO pipeline for the given segment.

This execution of IO pipelines 2835 by IO operator execution module 2840 correspond to executing IO operators 2421 of a query operator execution flow 2517. The output of IO operators 2421 can correspond to output of IO operators 2421 and/or output of IO level. This output can correspond to data blocks that are further processed via additional operators 2520, for example, by nodes at inner levels and/or the root level of a corresponding query execution plan.

Each IO pipeline 2835 can be generated based on pushing some or all filtering down to the IO level, where query predicates are applied via the IO pipeline based on accessing index structures, sourcing values, filtering rows, etc. Each IO pipeline 2835 can be generated to render semantically equivalent application of query predicates, despite differences in how the IO pipeline is arranged/executed for the given segment. For example, an index structure of a first segment is used to identify a set of rows meeting a condition for a corresponding column in a first corresponding IO pipeline while a second segment has its row values sourced and compared to a value to identify which rows meet the condition, for example, based on the first segment having the corresponding column indexed and the second segment not having the corresponding column indexed. As another example, the IO pipeline for a first segment applies a compressed column slab processing element to identify where rows are stored in a compressed column slab and to further facilitate decompression of the rows, while a second segment accesses this column slab directly for the corresponding column based on this column being compressed in the first segment and being uncompressed for the second segment.

FIG. 24S illustrates an example embodiment of an IO pipeline 2835 that is generated to include one or more index elements 3512, one or more source elements 3014, and/or one or more filter elements 3016. These elements can be arranged in a serialized ordering that includes one or more parallelized paths (e.g. the IO pipeline includes an acyclic directed graph of elements). These elements can implement sourcing and/or filtering of rows based on query predicates 2822 applied to one or more columns, identified by corresponding column identifiers 3041 and corresponding filter parameters 3048. Some or all features and/or functionality of the IO pipeline 2835 and/or IO pipeline generator module 2834 of FIG. 24S can implement the IO pipeline 2835 and/or IO pipeline generator module 2834 of FIG. 24R, and/or any embodiment of IO pipeline 2835, of IO pipeline generator module 2834, or of any query execution via accessing segments described herein.

In some embodiments, the IO pipeline generator module 2834, IO pipeline 2835, IO operator execution module 2840, and/or any embodiment of IO pipeline generation and/or IO pipeline execution described herein, implements some or all features and/or functionality of the IO pipeline generator module 2834, IO pipeline 2835, IO operator execution module 2840, and/or pushing of filtering and/or other operations to the IO level as disclosed by: U.S. Utility application Ser. No. 17/303,437, entitled “QUERY EXECUTION UTILIZING PROBABILISTIC INDEXING” and filed May 28, 2021; U.S. Utility application Ser. No. 17/450,109, entitled “MISSING DATA-BASED INDEXING IN DATABASE SYSTEMS” and filed Oct. 6, 2021; U.S. Utility application Ser. No. 18/310,177, entitled “OPTIMIZING AN OPERATOR FLOW FOR PERFORMING AGGREGATION VIA A DATABASE SYSTEM” and filed May 1, 2023; U.S. Utility application Ser. No. 18/355,505, entitled “STRUCTURING GEOSPATIAL INDEX DATA FOR ACCESS DURING QUERY EXECUTION VIA A DATABASE SYSTEM” and filed Jul. 20, 2023; and/or U.S. Utility application Ser. No. 18/485,861, entitled “QUERY PROCESSING IN A DATABASE SYSTEM BASED ON APPLYING A DISJUNCTION OF CONJUNCTIVE NORMAL FORM PREDICATES” and filed Oct. 12, 2023; all of which hereby incorporated herein by reference in its entirety and made part of the present U.S. Utility patent application for all purposes.

FIG. 24T presents an embodiment of a database system 10 that includes a plurality of storage clusters 2535. Storage clusters 2535.1-2535.Z of FIG. 24T can implement some or all features and/or functionality of storage clusters 35-1-35-Z described herein, and/or can implement some or all features and/or functionality of any embodiment of a storage cluster described herein. Some or all features and/or functionality of database system 10 of FIG. 24T can implement any embodiment of database system 10 described herein.

Each storage cluster 2535 can be implemented via a corresponding plurality of nodes 37. In some embodiments, a given node 37 of database system 10 is optionally included in exactly one storage cluster. In some embodiments, one or more nodes 37 of database system 10 are optionally included in no storage clusters (e.g. aren't configured to store segments). In some embodiments, one or more nodes 37 of database system 10 can be included in multiple storage clusters.

In some embodiments, some or all nodes 37 in a storage cluster 2535 participate at the IO level 2416 in query execution plans based on storing segments 2424 in corresponding memory drives 2425, and based on accessing these segments 2424 during query execution. This can include executing corresponding IO operators, for example, via executing an IO pipeline 2835 (and/or multiple IO pipelines 2835, where each IO pipeline is configured for each respective segment 2424). All segments in a given same segment group (e.g. a set of segments collectively storing parity data and/or replicated parts enabling any given segment in the segment group to be rebuilt/accessed as a virtual segment during query execution via access to some or all other segments in the same segment group as described previously) are optionally guaranteed to be stored in a same storage cluster 2535, where segment rebuilds and/or virtual segment use in query execution can thus be facilitated via communication between nodes in a given storage cluster 2535 accordingly, for example, in response to a node failing and/or a segment becoming unavailable.

Each storage cluster 2535 can further mediate cluster state data 3105 in accordance with a consensus protocol mediated via the plurality of nodes 37 of the given storage cluster. Cluster state data 3105 can implement any embodiment of state data and/or system metadata described herein. In some embodiments, cluster state data 3105 can indicate data ownership information indicating ownership of each segments stored by the cluster by exactly one node (e.g. as a physical segment or a virtual segment) to ensure queries are executed correctly via processing rows in each segment (e.g. of a given dataset against which the query is executed) exactly once.

Consensus protocol 3100 can be implemented via the raft consensus protocol and/or any other consensus protocol. Consensus protocol 3100 can be implemented be based on distributing a state machine across a plurality of nodes, ensuring that each node in the cluster agrees upon the same series of state transitions and/or ensuring that each node operates in accordance with the currently agreed upon state transition. Consensus protocol 3100 can implement any embodiment of consensus protocol described herein.

Coordination across different storage clusters 2535 can be minimal and/or non-existent, for example, based on each storage cluster coordinating state data and/or corresponding query execution separately. For example, state data 3105 across different storage clusters is optionally unrelated.

Each storage cluster's nodes 37 can perform various database tasks (e.g. participate in query execution) based on accessing/utilizing the state data 3105 of its given storage cluster, for example, without knowledge of state data of other storage clusters. This can include nodes syncing state data 3105 and/or otherwise utilizing the most recent version of state data 3105, for example, based on receiving updates from a leader node in the cluster, triggering a sync process in response to determining to perform a corresponding task requiring most recent state data, accessing/updating a locally stored copy of the state data, and/or otherwise determining updated state data.

In some embodiments, updating of state data (such as configuration data, system metadata, data shared via a consensus protocol, and/or any other state data described herein), for example, utilized by nodes to perform respective functionality over time, can be performed in conjunction with an event driven model. In some embodiments, such updating of state data over time can be performed in a same or similar fashion as updating of configuration data as disclosed by: U.S. Utility application Ser. No. 18/321,212, entitled COMMUNICATING UPDATES TO SYSTEM METADATA VIA A DATABASE SYSTEM, filed May 22, 2023; and/or U.S. Utility application Ser. No. 18/310,262, entitled “GENERATING A SEGMENT REBUILD PLAN VIA A NODE OF A DATABASE”, filed May 1, 2023; which are hereby incorporated herein by reference in their entirety and made part of the present U.S. Utility patent application for all purposes.

In some embodiments, system metadata can be generated and/or updated over time with different corresponding metadata sequence numbers (MSNs). For example, such generation/updating of metadata over time can be implemented via any features and/or functionality of the generation of data ownership information over time with corresponding OSNs as disclosed by U.S. Utility application Ser. No. 16/778,194, entitled “SERVICING CONCURRENT QUERIES VIA VIRTUAL SEGMENT RECOVERY”, filed Jan. 31, 2020, and issued as U.S. Pat. No. 11,061,910 on Jul. 13, 2021, which is hereby incorporated herein by reference in its entirety and made part of the present U.S. Utility patent application for all purposes. In some embodiments, the system metadata management system 2702 and/or a corresponding metadata system protocol can be implemented via a consensus protocols mediated via a plurality of nodes, for example, to update system metadata 2710, in a via any features and/or functionality of the execution of consensus protocols mediated via a plurality of nodes as disclosed by this U.S. Utility application Ser. No. 16/778,194. In some embodiments, each version of system metadata 2710 can assign nodes to different tasks and/or functionality via any features and/or functionality of assigning nodes to different segments for access in query execution in different versions of data ownership information as disclosed by this U.S. Utility application Ser. No. 16/778,194. In some embodiments, system metadata indicates a current version of data ownership information, where nodes utilize system metadata and corresponding system configuration data to determine their own ownership of segments for use in query execution accordingly, and/or to execute queries utilizing correct sets of segments accordingly, based on processing the denoted data ownership information as U.S. Utility application Ser. No. 16/778,194.

FIGS. 24U and 24V illustrate embodiments of a database system 10 that utilizes a dictionary structure to store compressed columns. Some or all features and/or functionality of the dictionary structure 5016 of FIGS. 24U and/or 24V can implement any compression scheme data and/or means of generating and/or accessing compressed columns described herein. Any other features and/or functionality of database system 10 of FIG. 24U and/or 24V can implement any other embodiment of database system 10 described herein.

In some embodiments, columns are compressed as compressed columns 5005 based on a globally maintained dictionary (e.g. dictionary structure 5016), for example, in conjunction with applying Global Dictionary Compression (GDC). Applying Global Dictionary Compression can include replaces variable length column values with fixed length integers on disk (e.g. in database storage 2450), where the globally maintained dictionary is stored elsewhere, for example, via different (e.g. slower/less efficient) memory resources of a different type/in a different location from the database storage 2450 that stores the compressed columns 5005 accessed during query execution.

The dictionary structure can store a plurality of fixed-length, compressed values 5013 (e.g. integers) each mapped to a single uncompressed value 5012 (e.g. variable-length values, such as strings). The mapping of compressed values 5013 to uncompressed values 5012 can be in accordance with a one-to-one mapping. The mapping of compressed values 5013 to uncompressed values 5012 can be based on utilizing the fixed-length values 5013 as keys of a corresponding map and/or dictionary data structure, and/or can be based on utilizing the uncompressed values 5012 as keys of a corresponding map and/or dictionary data structure.

A given uncompressed value 5012 that is included in many rows of one or more tables can be replaced (i.e. “compressed”) via a same corresponding compressed value 5013 mapped to this uncompressed value 5012 as the compressed value 5008 for these rows in compressed column 5005 in database storage. As new rows are received for storage over time, their column values for one or more compressed columns 5005 can be replaced via corresponding compressed values 5008 based on accessing the dictionary structure and determining whether the uncompressed value 5012 of this column is stored in the dictionary structure 5016. If yes, the compressed value 5013 mapped to the uncompressed value 5012 in this existing entry is stored as compressed value 5008 in the compressed column 5005 in the database storage 2450. If no, the dictionary structure 5016 can be updated to include a new entry that includes the uncompressed value 5012 and a new compressed value 5013 (e.g. different from all existing compressed values in the structure) generated for this uncompressed value 5012, where this new compressed value 5013 is stored as is applied as compressed value 5008 in the database storage 2450.

The dictionary structure 5016 can be stored in dictionary storage resources 2514, which can be different types of resources from and/or can be stored in a different location from the database storage 2450 storing the compressed columns for query execution. In some embodiments, the dictionary storage resources 2514 storing dictionary structure 5016 can be considered a portion/type of memory as of database storage 2450 that are accessed during query execution as necessary for decompressing column values. In some embodiments, the dictionary storage resources 2514 storing dictionary structure 5016 can be implemented as metadata storage resources, for example, implemented by a metadata consensus state mediated via a metadata storage cluster of nodes maintaining system metadata such as GDCs of the database system 10.

The dictionary structure 5016 can correspond to a given column 5005, where different columns optionally have their own dictionary structure 5016 built and maintained. Alternatively, a common dictionary structure 5016 can optionally be maintained for multiple columns of a same table/same dataset, and/or for multiple columns across different tables/different datasets. For example, a given uncompressed value 5012 appearing in different columns 5005 of the same or different table is compressed via the same fixed-length value 5013 as dictated by the dictionary structure 5016.

This dictionary structure 5016 can be globally maintained (e.g. across some or all nodes, indicating fixed length values mapped across one or more segments stored in conjunction with storing one or more relational database tables) and can be updated overtime (e.g. as more data is added with new variable length values requiring mapping to fixed length values). For example, the dictionary structure 5016 is maintained/stored in state data that is mediated/accessible by some or all nodes 37 of the database system 10 via the dictionary structure 5016 being included in any embodiment of state data described herein.

In some embodiments, dictionary compression via dictionary structure 5016 can implement the compression scheme utilized to generate (e.g. compress/decompress the values of) compressed columns 5005 of FIG. 24U based on implementing some or all features and/or functionality of the compression of data during ingress via a dictionary as disclosed by U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility patent application for all purposes.

In some embodiments, dictionary compression via dictionary structure 5016 can implement the compression scheme utilized to generate (e.g. compress/decompress the values of) compressed columns 5005 of FIG. 24U based on implementing some or all features and/or functionality of global dictionary compression as disclosed by U.S. Utility application Ser. No. 16/220,454, entitled “DATA SET COMPRESSION WITHIN A DATABASE SYSTEM”, filed Dec. 14, 2018, issued as U.S. Pat. No. 11,256,696 on Feb. 22, 2022, which is hereby incorporated herein by reference in its entirety and made part of the present U.S. Utility patent application for all purposes.

In some embodiments, dictionary compression via dictionary structure 5016 can be utilized in performing GDC join processes during query execution to enable recovery of uncompressed values during query execution, for example, based on implementing some or all features and/or functionality of GDC joins as disclosed by U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility patent application for all purposes.

FIG. 24U illustrates an embodiment of database system 10 where a compressed column filter conversion module 5010 accesses a dictionary structure 5016 to generate an updated filtering expression 5021 in conjunction with query execution.

The compressed column filter conversion module 5010 can generate updated filtering expression 5021 based on updating one or more literals 5011.1 from corresponding literals 5011.0 based on replacing uncompressed values 5012 with compressed values 5013 mapped to these compressed values based on accessing dictionary structure 5016 and determining which fixed-length compressed value 5013 is mapped to each given uncompressed value 5012. Such functionality can be implemented for one or more queries executed by database system 10 to reduce access to the dictionary structure during query execution in conjunction with performing one or more optimizations of the query operator execution flow to improve query performance.

FIG. 24V illustrates an embodiment of executing a join process 2530 that is implemented as a global dictionary compression (GDC) join. This can include applying a matching row determination module 2558 via access to a dictionary structure 5016,

In some embodiments, unlike hash maps generated during query execution for access in conjunction with executing other types of JOIN operations (e.g. as described in U.S. Utility application Ser. No. 18/266,525), the dictionary structure 5016 can optionally be accessed during GDC join processes based on being globally maintained, and thus being generated prior to execution of the corresponding query. In particular, the dictionary structure 5016 can be implemented in conjunction with compressing one or more columns, such as a variable length values stored in one or more variable length columns, by mapping these variable length, uncompressed values (e.g. strings, other large values of a given column) to corresponding fixed-length, compressed values 5013 (e.g. integers or other fixed length values).

For example, segments can store the fixed length values to improve storage efficiency and/or queries can access and process these fixed length values, where the uncompressed variable length values are only required via access to dictionary structure 5016 to emit an uncompressed value 5012 for a given fixed-length value 5013 of a given input row. This functionality can be achieved via performing a corresponding join as described herein, where the matching condition 2519 is implemented for a compressed column and indicates matching by the value of the compressed column, such as simply emitting the uncompressed value mapped to the compressed column as the right output value 2563 for a given input row, implemented as a left input row 2542 of a join operation.

FIG. 24W illustrates an embodiment of database system 10 operable to communicate with a plurality of user entities. Some or all features and/or functionality of FIG. 24W can implement any embodiment of database system 10 described herein.

Various users can send data to and/or receive data from database system 10 over time, for example, as corresponding requests and/or responses. Requests can indicate requests for queries to be executed, requests that include data to be loaded/stored, requests that include configuration data configuring any values/functionality utilized by database system 10 to perform its functionality, data supplied in response to a request from database system 10, and/or other requests to database system 10 for processing by database system 10. Responses can indicate query resultants of executed queries, notifications/confirmation that requests were processed successfully or rendered failure, error notifications, data supplied in response to a request from user entity 2012, and/or other information.

Some or all user entities 2012 can be implemented as user entities corresponding to humans that communicate with database system 10 (e.g. requests are configured via user input to a corresponding computing device of database system 10 or communicating with database system 10); user entities corresponding to groups of multiple people, for example, corresponding to companies/establishments that communicate with database system 10; user entities corresponding to automated entities such as one or more computing devices and/or server systems (e.g. implemented via artificial intelligence, machine learning, and/or configured instructions to cause these automated entities to send requests and/or process responses; and/or corresponding to a given person and configured to send/receive data based on user input from a corresponding person); and/or other user entities. Some or all user entities 2012 can be implemented as humans and/or devices included in/associated with database system 10 (e.g. personnel/employees of a service provided by database system 10; computing devices implementing nodes/processing modules of database system 10 that communicate via internal communication resources of database system 10, etc.). Some or all user entities 2012 can be implemented as humans and/or devices external from database system 10 (e.g. humans/companies that are customers of a service provided by database system 10; computing devices external from the computing devices/nodes/processing resources of database system 10 that communicate with database system 10 via a corresponding communication interface, etc.)

User entities 2012 can include various type of user entities 2012, which can include one or more user entities 2012.A, one or more user entities 2012.B, and/or one or more user entities 2012.C. A given user entity can optionally implement multiple types of user entities 2012 (e.g. a given user entity 2012 operates as both a user entity 2012.A and a user entity 2012.B). Multiple different users (e.g. different people, different devices) can implement a given user entity 2012 (e.g. different employees of a given company implement a given user entity 2012 at different times; different devices associated with a given person or company implement a given user entity 2012 at different times, etc.).

In some embodiments, some or all user entities 2012 can configure/perform functionality corresponding to workload management (WLM).

User entities 2012 can include one or more user entities 2012.A.1-2012.A.M corresponding to query requestor user entities 2005.1-2005.M. Query requestor user entities 2005 can send query requests 2914 indicating queries for execution and/or receive query resultants in response 2920. User entities 2012 can optionally be implemented in a same or similar fashion as external requesting entity 2912.

User entities 2012 can include one or more user entities 2012.B.1-2012.B.S corresponding to database administrator user entities 2006 that request/configure/monitor loading/storage of/access to a corresponding database 1901 that stores a corresponding plurality of database tables 2712.1-2712-T (e.g. database administrator user entities 2006 optionally correspond to data sources that load their data to the system for use in query execution, where this data source sources data included in tables 2712 of a corresponding database 1901).

For example, in some embodiments, database system 10 can implement database storage 2450 to store various tables 2712 corresponding to multiple different databases 1902.1-1901.S, for example, each sourced by, accessible by, and/or configured via corresponding user entities 2012.B. Different databases 1901 can store same or different types of data, same or different numbers of tables 2712, etc. Some or all user entities 2012.A can correspond to a given database 1901 (e.g. based on being associated with the corresponding data source and/or user entities 2012.B) for example, where these user entities are only allowed to query against the given database 1901.

User entities 2012 can include one or more user entities 2012.C corresponding to system administrators of the database system 10 that request/configure/monitor loading/storage of/access to databases in query execution and/or otherwise configure/monitor functionality of database system 10 described herein.

Different user entities can have different corresponding permissions/privileges/access types, for example, indicated in corresponding user permissions data stored by and/or accessible by database system 10. In some embodiments, one or more given user entities can configure permissions of other user entities. Such permissions can configure types of requests that can be sent, restrictions on data included in responses, and/or which data can be accessed (e.g. in loading data and/or requesting data). For example, some users entities 2012.A can be restricted to certain types of queries/query functions be performed, access to only some databases 1902 and/or only some tables 2712, limits on how many queries be executed/how much data be returned, certain levels of query priority, certain service classes of query execution defining corresponding attributes of how queries be executed/how query execution be restricted, etc. As another example, some user entities 2012.B can be restricted to certain types/rates of data loading to a corresponding database 1901, certain permissions regarding how much configuration of database system 10 they can have power over, etc. As another example, different user entities 2012.C can have different permissions regarding how much configuration of database system 10 they can have power over, different functionalities/aspects of database system that they have permissions to configure, etc.

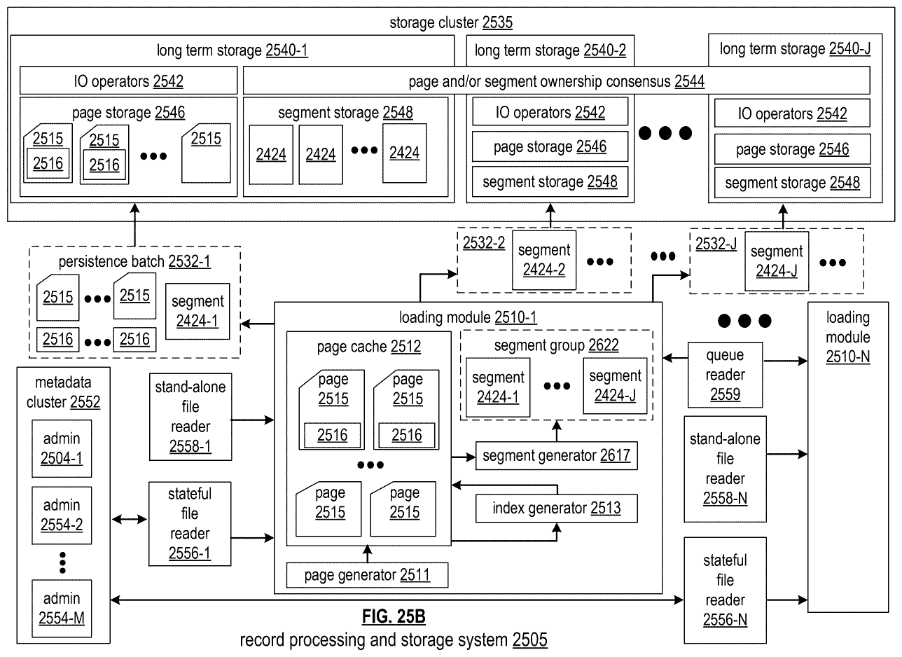

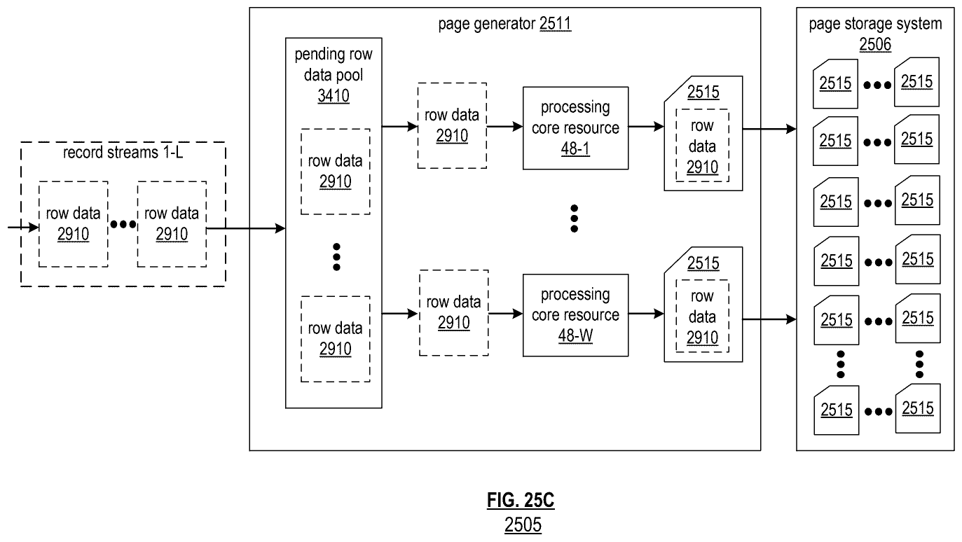

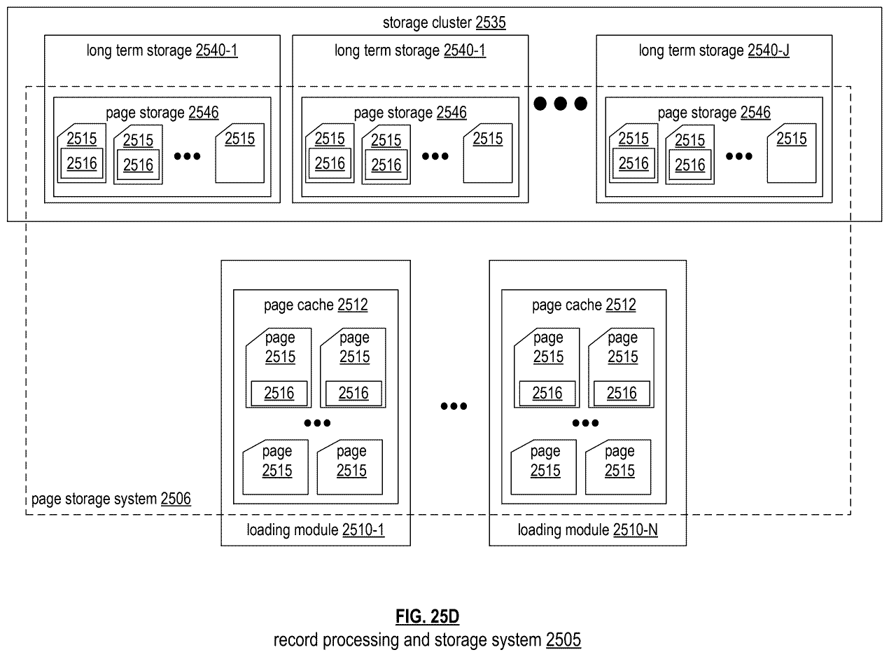

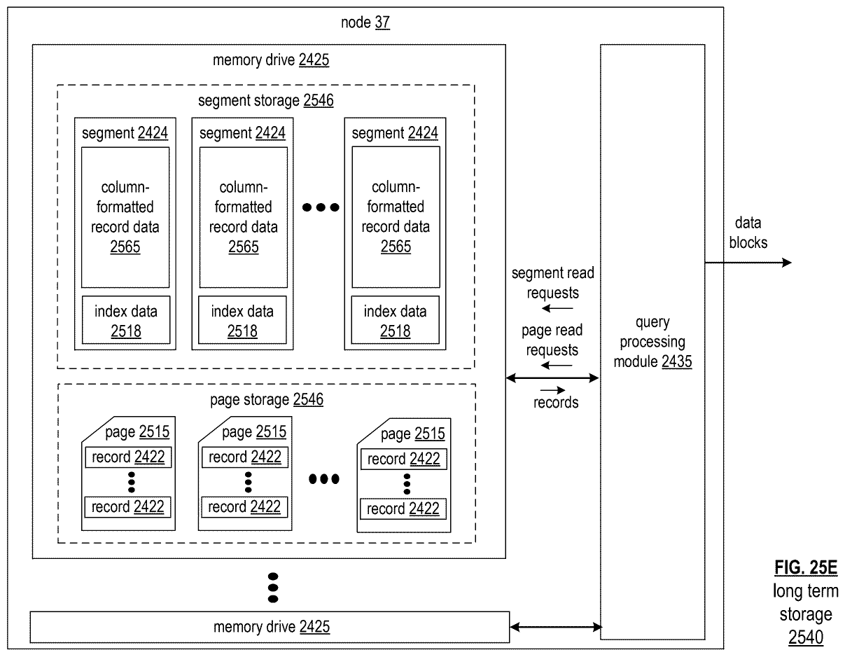

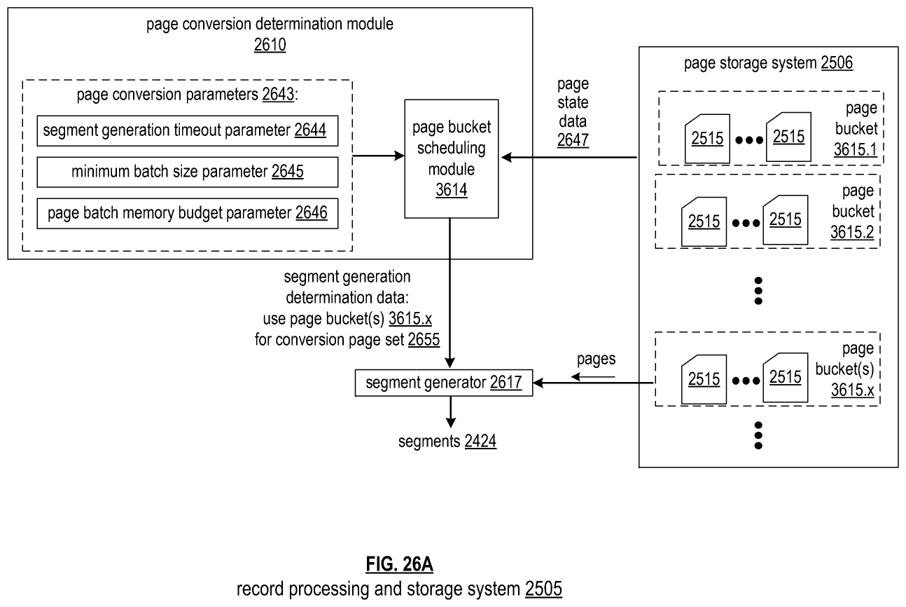

FIGS. 25A-25C illustrate embodiments of a database system 10 operable to execute queries indicating join expressions based on implementing corresponding join processes via one or more join operators. Some or all features and/or functionality of FIGS. 25A-25C can be utilized to implement the database system 10 of FIGS. 24A-24I when executing queries indicating join expressions. Some or all features and/or functionality of FIGS. 25A-25C can be utilized to implement any embodiment of the database system 10 described herein.

FIG. 25A illustrates an embodiment of a database system 10 that implements a record processing and storage system 2505. The record processing and storage system 2505 can be operable to generate and store the segments 2424 discussed previously by utilizing a segment generator 2617 to convert sets of row-formatted records 2422 into column-formatted record data 2565. These row-formatted records 2422 can correspond to rows of a database table with populated column values of the table, for example, where each record 2422 corresponds to a single row as illustrated in FIG. 15. For example, the segment generator 2617 can generate the segments 2424 in accordance with the process discussed in conjunction with FIGS. 15-23. The segments 2424 can be generated to include index data 2518, which can include a plurality of index sections such as the index sections 0-X illustrated in FIG. 23. The segments 2424 can optionally be generated to include other metadata, such as the manifest section and/or statistics section illustrated in FIG. 23.

The generated segments 2424 can be stored in a segment storage system 2508 for access in query executions. For example, the records 2422 can be extracted from generated segments 2424 in various query executions performed by via a query processing system 2502 of the database system 10, for example, as discussed in FIGS. 25A-25D. In particular, the segment storage system 2508 can be implemented by utilizing the memory drives 2425 of a plurality of IO level nodes 37 that are operable to store segments. As discussed previously, nodes 37 at the IO level 2416 can store segments 2424 in their memory drives 2425 as illustrated in FIG. 24C. These nodes can perform IO operations in accordance with query executions by reading rows from these segments 2424 and/or by recovering segments based on receiving segments from other nodes as illustrated in FIG. 24D. The records 2422 can be extracted from the column-formatted record data 2565 for these IO operations of query executions by utilizing the index data 2518 of the corresponding segment 2424.

To enhance the performance of query executions via access to segments 2424 to read records 2422 in this fashion, the sets of rows included in each segment are ideally clustered well. In the ideal case, rows sharing the same cluster key are stored together in the same segment or same group of segments. For example, rows having matching values of key columns(s) of FIG. 18 utilized to sort the rows into groups for conversion into segments are ideally stored in the same segments. As used herein, a cluster key can be implemented as any one or more columns, such as key columns(s) of FIG. 18, that are utilized to cluster records into segment groups for segment generation. As used herein, more favorable levels of clustering correspond to more rows with same or similar cluster keys being stored in the same segments, while less favorable levels of clustering correspond to less rows with same or similar cluster keys being stored in the same segments. More favorable levels of clustering can achieve more efficient query performance. In particular, query filtering parameters of a given query can specify particular sets of records with particular cluster keys be accessed, and if these records are stored together, fewer segments, memory drives, and/or nodes need to be accessed and/or utilized for the given query.

These favorable levels of clustering can be hard to achieve when relying upon the incoming ordering of records in record streams 1-L from a set of data sources 2501-1-2501-L. No assumptions can necessarily be made about the clustering, with respect to the cluster key, of rows presented by external sources as they are received in the data stream. For example, the cluster key value of a given row received at a first time t₁ gives no information about the cluster key value of a row received at a second time t₂ after t₁. It would therefore be unideal to frequently generate segments by performing a clustering process to group the most recently received records by cluster key. In particular, because records received within a given time frame from a particular data source may not be related and have many different cluster key values, the resulting record groups utilized to generate segments would render unfavorable levels of clustering.

To achieve more favorable levels of clustering, the record processing and storage system 2505 implements a page generator 2511 and a page storage system 2506 to store a plurality of pages 2515. The page generator 2511 is operable to generate pages 2515 from incoming records 2422 of record streams 1-L, for example, as is discussed in further detail in conjunction with FIG. 25C. Each page 2515 generated by the page generator 2511 can include a set of records, for example, in their original row format and/or in a data format as received from data sources 2501-1-2501-L. Once generated, the pages 2515 can be stored in a page storage system 2506, which can be implemented via memory drives and/or cache memory of one or more computing devices 18, such as some or all of the same or different nodes 37 storing segments 2424 as part of the segment storage system 2508.

This generation and storage of pages 2515 stored by can serve as temporary storage of the incoming records as they await conversion into segments 2424. Pages 2515 can be generated and stored over lengthy periods of time, such as hours or days. During this length time frame, pages 2515 can continue to be accumulated as one or more record streams of incoming records 1-L continue to supply additional records for storage by the database system.

The plurality of pages generated and stored over this period of time can be converted into segments, for example once a sufficient amount of records have been received and stored as pages, and/or once the page storage system 2506 runs out of memory resources to store any additional pages. It can be advantageous to accumulate and store as many records as possible in pages 2515 prior to conversion to achieve more favorable levels of clustering. In particular, performing a clustering process upon a greater numbers of records, such as the greatest number of records possible can achieve more favorable levels of clustering. For example, greater numbers of records with common cluster keys are expected to be included in the total set of pages 2515 of the page storage system 2506 when the page storage system 2506 accumulates pages over longer periods of time to include a greater number of pages. In other words. delaying the grouping of rows into segments as long as possible increases the chances of having sufficient numbers of records with same and/or similar cluster keys to group together in segments. Determining when to generate segments such that the conversion from pages into segments is delayed as long as possible, and/or such that a sufficient amount of records are converted all at once to induce more favorable levels of cluster. Alternatively, the conversion of pages into segments can occur at any frequency, for example, where pages are converted into segments more frequently and/or in accordance with any schedule or determination in other embodiments of the record processing and storage system 2505.

This mechanism of improving clustering levels in segment generation by delaying the clustering process required for segment generation as long as possible can be further leveraged to reduce resource utilization of the record processing and storage system 2505. As the record processing and storage system 2505 is responsible for receiving records streams from data sources for storage, for example, in the scale of terabyte per second load rates, this process of generating pages from the record streams should therefore be as efficient as possible. The page generator 2511 can be further implemented to reduce resource consumption of the record processing and storage system 2505 in page generation and storage by minimizing the processing of, movement of, and/or access to records 2422 of pages 2515 once generated as they await conversion into segments.

To reduce the processing induced upon the record processing and storage system 2505 during this data ingress, sets of incoming records 2422 can be included in a corresponding page 2515 without performing any clustering or sorting. For example, as clustering assumptions cannot be made for incoming data, incoming rows can be placed into pages based on the order that they are received and/or based on any order that best conserves resources. In some embodiments, the entire clustering process is performed by the segment generator 2617 upon all stored pages all at once, where the page generator 2511 does not perform any stages of the clustering process.

In some embodiments, to further reduce the processing induced upon the record processing and storage system 2505 during this data ingress, incoming record data of data streams 1-L undergo minimal reformatting by the page generator 2511 in generating pages 2515. In some cases, the incoming data of record streams 1-L is not reformatted and is simply “placed” into a corresponding page 2515. For example, a set of records are included in given page in accordance with formatted row data received from data sources.

While delaying segment generation in this fashion improves clustering and further improves ingress efficiency, it can be unideal to wait for records to be processed into segments before they appear in query results, particularly because the most recent data may be of the most interest to end users requesting queries. The record processing and storage system 2505 can resolve this problem by being further operable to facilitate page reads in addition to segment reads in facilitating query executions.

As illustrated in FIG. 25A, a query processing system 2502 can implement a query execution plan generator module 2503 to generate query execution plan data based on a received query request. The query execution plan data can be relayed to nodes participating in the corresponding query execution plan 2405 indicated by the query execution plan data, for example, as discussed in conjunction with FIG. 24A. A query execution module 2504 can be implemented via a plurality of nodes participating in the query execution plan 2405, for example, where data blocks are propagated upwards from nodes at IO level 2416 to a root node at root level 2412 to generate a query resultant. The nodes at IO level 2416 can perform row reads to read records 2422 from segments 2424 as discussed previously and as illustrated in FIG. 24C. The nodes at IO level 2416 can further perform row reads to read records 2422 from pages 2515. For example, once records 2422 are durably stored by being stored in a page 2515, and/or by being duplicated and stored in multiple pages 2515, the record 2422 can be available to service queries, and will be accessed by nodes 37 at IO level 2416 in executing queries accordingly. This enables the availability of records 2422 for query executions more quickly, where the records need not be processed for storage in their final storage format as segments 2424 to be accessed in query requests. Execution of a given query can include utilizing a set of records stored in a combination of pages 2515 and segments 2424. An embodiment of an IO level node that stores and accesses both segments and pages is illustrated in FIG. 25E.

The record processing and storage system 2505 can be implemented utilizing the parallelized data input sub-system 11 and/or the parallelized ingress sub-system 24 of FIG. 4. The record processing and storage system 2505 can alternatively or additionally be implemented utilizing the parallelized data store, retrieve, and/or process sub-system 12 of FIG. 6. The record processing and storage system 2505 can alternatively or additionally be implemented by utilizing one or more computing devices 18 and/or by utilizing one or more nodes 37.

The record processing and storage system 2505 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the page generator 2511 and/or of the segment generator 2617 discussed herein. In some cases, one or more individual nodes 37 and/or one or more individual processing core resources 48 can be operable to perform some or all of the functionality of the record processing and storage system 2505, such as some or all of the functionality of the page generator 2511 and/or of the segment generator 2617, independently or in tandem by utilizing their own processing resources and/or memory resources.

The query processing system 2502 can be alternatively or additionally implemented utilizing the parallelized query and results sub-system 13 of FIG. 5. The query processing system 2502 can be alternatively or additionally implemented utilizing the parallelized data store, retrieve, and/or process sub-system 12 of FIG. 6. The query processing system 2502 can alternatively or additionally be implemented by utilizing one or more computing devices 18 and/or by utilizing one or more nodes 37.

The query processing system 2502 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the query execution plan generator module 2503 and/or of the query execution module 2504 discussed herein. In some cases, one or more individual nodes 37 and/or one or more individual processing core resources 48 can be operable to perform some or all of the functionality of the query processing system 2502, such as some or all of the functionality of query execution plan generator module 2503 and/or of the query execution module 2504, independently or in tandem by utilizing their own processing resources and/or memory resources.

In some embodiments, one or more nodes 37 of the database system 10 as discussed herein can be operable to perform multiple functionalities of the database system 10 illustrated in FIG. 25A. For example, a single node can be utilized to implement the page generator 2511, the page storage system 2506, the segment generator 2617, the segment storage system 2508, the query execution plan generator module, and/or the query execution module 2504 as a node 37 at one or more levels 2410 of a query execution plan 2405. In particular, the single node can utilize different processing core resources 48 to implement different functionalities in parallel, and/or can utilize the same processing core resources 48 to implement different functionalities at different times.

Some or all data sources 2501 can be implemented utilizing at least one processor and at least one memory. Some or all data sources 2501 can be external from database system 10 and/or can be included as part of database system 10. For example, the at least one memory of a data source 2501 can store operational instructions that, when executed by the at least one processor of the data source 2501, cause the data source 2501 to perform some or all of the functionality of data sources 2501 described herein. In some cases, data sources 2501 can receive application data from the database system 10 for download, storage, and/or installation. Execution of the stored application data by processing modules of data sources 2501 can cause the data sources 2501 to execute some or all of the functionality of data sources 2501 discussed herein.

In some embodiments, system communication resources 14, external network(s) 17, local communication resources 25, wide area networks 22, and/or other communication resources of database system 10 can be utilized to facilitate any transfer of data by the record processing and storage system 2505. This can include, for example: transmission of record streams 1-L from data sources 2501 to the record processing and storage system 2505; transfer of pages 2515 to page storage system 2506 once generated by the page generator 2511; access to pages 2515 by the segment generator 2617; transfer of segments 2424 to the segment storage system 2508 once generated by the segment generator 2617; communication of query execution plan data to the query execution module 2504, such as the plurality of nodes 37 of the corresponding query execution plan 2405; reading of records by the query execution module 2504, such as IO level nodes 37, via access to pages 2515 stored page storage system 2506 and/or via access to segments 2424 stored segment storage system 2508; sending of data blocks generated by nodes 37 of the corresponding query execution plan 2405 to other nodes 37 in conjunction with their execution of the query; and/or any other accessing of data, communication of data, and/or transfer of data by record processing and storage system 2505 and/or within the record processing and storage system 2505 as discussed herein.

The record processing and storage system 2505 and/or the query processing system 2502 of FIG. 25A, and/or any other embodiment of record processing and storage system 2505 and/or the query processing system 2502 described herein, can be implemented at a massive scale, for example, by being implemented by a database system 10 that is operable to receive, store, and perform queries against a massive number of records of one or more datasets, such as millions, billions, and/or trillions of records stored as many Terabytes, Petabytes, and/or Exabytes of data as discussed previously. In particular, the record processing and storage system 2505 and/or the query processing system 2502 can each be implemented by a large number, such as hundreds, thousands, and/or millions of computing devices 18, nodes 37, and/or processing core resources 48 that perform independent processes in parallel, for example, with minimal or no coordination, to implement some or all of the features and/or functionality of the record processing and storage system 2505 and/or the query processing system 2502 at a massive scale.

Some or all functionality performed by the record processing and storage system 2505 and/or the query processing system 2502 as described herein cannot practically be performed by the human mind, particularly when the database system 10 is implemented to store and perform queries against records at a massive scale as discussed previously. In particular, the human mind is not equipped to perform record processing, record storage, and/or query execution for millions, billions, and/or trillions of records stored as many Terabytes, Petabytes, and/or Exabytes of data. Furthermore, the human mind is not equipped to distribute and perform record processing, record storage, and/or query execution as multiple independent processes, such as hundreds, thousands, and/or millions of independent processes, in parallel and/or within overlapping time spans.

Some or all features and/or functionality of FIG. 25A can be performed via at least one node 37 in conjunction with system metadata, applied across a plurality of nodes 37, for example, where at least one node 37 participates in some or all features and/or functionality of FIG. 25A based on receiving and storing the system metadata in local memory of the at least one node 37 as configuration data, and/or based on further accessing and/or executing this configuration data to implement some or all functionality of the record processing storage system and/or to implement some or all functionality of the query processing system as part of its database functionality accordingly. Performance of some or all features and/or functionality of FIG. 25A can optionally change and/or be updated over time, and/or a set of nodes participating in executing some or all features and/or functionality of FIG. 25A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25B illustrates an example embodiment of the record processing and storage system 2505 of FIG. 25A. Some or all of the features illustrated and discussed in conjunction with the record processing and storage system 2505 FIG. 25B can be utilized to implement the record processing and storage system 2505 and/or any other embodiment of the record processing and storage system 2505 described herein.

The record processing and storage system 2505 can include a plurality of loading modules 2510-1-2510-N. Each loading module 2510 can be implemented via its own processing and/or memory resources. For example, each loading module 2510 can be implemented via its own computing device 18, via its own node 37, and/or via its own processing core resource 48. The plurality of loading modules 2510-1-2510-N can be implemented to perform some or all of the functionality of the record processing and storage system 2505 in a parallelized fashion.

The record processing and storage system 2505 can include queue reader 2559, a plurality of stateful file readers 2556-1-2556-N, and/or stand-alone file readers 2558-1-2558-N. For example, the queue reader 2559, a plurality of stateful file readers 2556-1-2556-N, and/or stand-alone file readers 2558-1-2558-N are utilized to enable each loading modules 2510 to receive one or more of the record streams 1-L received from the data sources 2501-1-2501-L as illustrated in FIG. 25A. For example, each loading module 2510 receives a distinct subset of the entire set of records received by the record processing and storage system 2505 at a given time.

Each loading module 2510 can receive records 2422 in one or more record streams via its own stateful file reader 2556 and/or stand-alone file reader 2558. Each loading module 2510 can optionally receive records 2422 and/or otherwise communicate with a common queue reader 2559. Each stateful file reader 2556 can communicate with a metadata cluster 2552 that includes data supplied by and/or corresponding to a plurality of administrators 2554-1-2554-M. The metadata cluster 2552 can be implemented by utilizing the administrative processing sub-system 15 and/or the configuration sub-system 16. The queue reader 2559, each stateful file reader 2556, and/or each stand-alone file reader 2558 can be implemented utilizing the parallelized ingress sub-system 24 and/or the parallelized data input sub-system 11. The metadata cluster 2552, the queue reader 2559, each stateful file reader 2556, and/or each stand-alone file reader 2558 can be implemented utilizing at least one computing device 18 and/or at least one node 37. In cases where a given loading module 2510 is implemented via its own computing device 18 and/or node 37, the same computing device 18 and/or node 37 can optionally be utilized to implement the stateful file reader 2556, and/or each stand-alone file reader 2558 communicating with the given loading module 2510.

Each loading module 2510 can implement its own page generator 2511, its own index generator 2513, and/or its own segment generator 2617, for example, by utilizing its own processing and/or memory resources such as the processing and/or memory resources of a corresponding computing device 18. For example, the page generator 2511 of FIG. 25A can be implemented as a plurality of page generators 2511 of a corresponding plurality of loading modules 2510 as illustrated in FIG. 25B. Each page generator 2511 of FIG. 25B can process its own incoming records 2422 to generate its own corresponding pages 2515.

As pages 2515 are generated by the page generator 2511 of a loading module 2510, they can be stored in a page cache 2512. The page cache 2512 can be implemented utilizing memory resources of the loading module 2510, such as memory resources of the corresponding computing device 18. For example, the page cache 2512 of each loading module 2010-1-2010-N can individually or collectively implement some or all of the page storage system 2506 of FIG. 25A.

The segment generator 2617 of FIG. 25A can similarly be implemented as a plurality of segment generators 2617 of a corresponding plurality of loading modules 2510 as illustrated in FIG. 25B. Each segment generator 2617 of FIG. 25B can generate its own set of segments 2424-1-2424-J included in one or more segment groups 2622. The segment group 2622 can be implemented as the segment group of FIG. 23, for example, where J is equal to five or another number of segments configured to be included in a segment group. In particular, J can be based on the redundancy storage encoding scheme utilized to generate the set of segments and/or to generate the corresponding parity data 2426.

The segment generator 2617 of a loading module 2510 can access the page cache 2512 of the loading module 2510 to convert the pages 2515 previously generated by the page generator 2511 into segments. In some cases, each segment generator 2617 requires access to all pages 2515 generated by the segment generator 2617 since the last conversion process of pages into segments. The page cache 2512 can optionally store all pages generated by the page generator 2511 since the last conversion process, where the segment generator 2617 accesses all of these pages generated since the last conversion process to cluster records into groups and generate segments. For example, the page cache 2512 is implemented as a write-through cache to enable all previously generated pages since the last conversion process to be accessed by the segment generator 2617 once the conversion process commences.

In some cases, each loading module 2510 implements its segment generator 2617 upon only the set of pages 2515 that were generated by its own page generator 2511, accessible via its own page cache 2512. In such cases, the record grouping via clustering key to create segments with the same or similar cluster keys are separately performed by each segment generator 2617 independently without coordination, where this record grouping via clustering key is performed on N distinct sets of records stored in the N distinct sets of pages generated by the N distinct page generators 2511 of the N distinct loading modules 2510. In such cases, despite records never being shared between loading modules 2510 to further improve clustering, the level of clustering of the resulting segments generated independently by each loading module 2510 on its own data is sufficient, for example, due to the number of records in each loading module's 2510 set of pages 2515 for conversion being sufficiently large to attain favorable levels of clustering.

In such embodiments, each loading modules 2510 can independently initiate its own conversion process of pages 2515 into segments 2424 by waiting as long as possible based on its own resource utilization, such as memory availability of its page cache 2512. Different segment generators 2617 of the different loading modules 2510 can thus perform their own conversion of the corresponding set of pages 2515 into segments 2424 at different times, based on when each loading modules 2510 independently determines to initiate the conversion process, for example, based on each independently making the determination to generate segments. Thus, as discussed herein, the conversion process of pages into segments can correspond to a single loading module 2510 converting all of its pages 2515 generated by its own page generator 2511 since its own last the conversion process into segments 2424, where different loading modules 2510 can initiate and execute this conversion process at different times and/or with different frequency.

In other cases, it is ideal for even more favorable levels of clustering to be attained via sharing of all pages for conversion across all loading modules 2510. In such cases, a collective decision to initiate the conversion process can be made across some or all loading modules 2510, for example, based on resource utilization across all loading modules 2510. The conversion process can include sharing of and/or access to all pages 2515 generated via the process, where each segment generator 2617 accesses records in some or all pages 2515 generated by and/or stored by some or all other loading modules 2510 to perform the record grouping by cluster key. As the full set of records is utilized for this clustering instead of N distinct sets of records, the levels of clustering in resulting segments can be further improved in such embodiments. This improved level of clustering can offset the increased page movement and coordination required to facilitate page access across multiple loading modules 2510. As discussed herein, the conversion process of pages into segments can optionally correspond to multiple loading modules 2510 converting all of their collectively generated pages 2515 since their last conversion process into segments 2424 via sharing of their generated pages 2515.

An index generator 2513 can optionally be implemented by some or all loading modules 2510 to generate index data 2516 for some or all pages 2515 prior to their conversion into segments. The index data 2516 generated for a given page 2515 can be appended to the given page, can be stored as metadata of the given page 2515, and/or can otherwise be mapped to the given page 2515. The index data 2516 for a given page 2515 correspond to page metadata, for example, indexing records included in the corresponding page. As a particular example, the index data 2516 can include some or all of the data of index data 2518 generated for segments 2424 as discussed previously, such as index sections 0-x of FIG. 23. As another example, the index data 2516 can include indexing information utilized to determine the memory location of particular records and/or particular columns within the corresponding page 2515.

In some cases, the index data 2516 can be generated to enable corresponding pages 2515 to be processed by query IO operators utilized to read rows from pages, for example, in a same or similar fashion as index data 2518 is utilized to read rows from segments. In some cases, index probing operations can be utilized by and/or integrated within query IO operators to filter the set of rows returned in reading a page 2515 based on its index data 2516 and/or to filter the set of rows returned in reading a segment 2424 based on its index data 2518.

In some cases, index data 2516 is generated by index generator 2513 for all pages 2515, for example, as each page 2515 is generated, or at some point after each page 2515 is generated. In other cases, index data 2516 is only generated for some pages 2515, for example, where some pages do not have index data 2516 as illustrated in FIG. 25B. For example, some pages 2515 may never have corresponding index data 2516 generated prior to their conversion into segments. In some cases, index data 2516 is generated for a given page 2515 with its records are to be read in execution of a query by the query processing system 2502. For example, a node 37 at IO level 2416 can be implemented as a loading module 2510 and can utilize its index generator 2513 to generate index data 2516 for a particular page 2515 in response to having query execution plan data indicating that records 2422 be read the particular page from the page cache 2512 of the loading module in conjunction with execution of a query. The index data 2516 can be optionally stored temporarily for the life of the given query to facilitate reading of rows from the corresponding page for the given query only. The index data 2516 alternatively be stored as metadata of the page 2515 once generated, as illustrated in FIG. 25B. This enables the previously generated index data 2516 of a given page to be utilized in subsequent queries requiring reads from the given page.

As illustrated in FIG. 25B, each loading modules 2510 can generate and send pages 2515, corresponding index data 2516, and/or segments 2424 to long term storage 2540-1-2540-J of a particular storage cluster 2535. For example, system communication resources 14 can be utilized to facilitate sending of data from loading modules 2510 to storage cluster 2535 and/or to facilitate sending of data from storage cluster 2535 to loading modules 2510.

The storage cluster 2535 can be implemented by utilizing a storage cluster 35 of FIG. 6, where each long term storage 2540-1-2540-J is implemented by a corresponding computing device 18-1-18-J and/or by a corresponding node 37-1-37-J. In some cases, each storage cluster 35-1-35-z of FIG. 6 can receive pages 2515, corresponding index data 2516, and/or segments 2424 from its own set of loading modules 2510-1-2510-N, where the record processing and storage system 2505 of FIG. 25B can include z sets of loading modules 2510-1-2510-N that each generate pages 2515, segments 2524, and/or index data 2516 for storage in its own corresponding storage cluster 35.

The processing and/or memory resources utilized to implement each long term storage 2540 can be distinct from the processing and/or memory resources utilized to implement the loading modules 2510. Alternatively, some loading modules can optionally share processing and/or memory resources long term storage 2540, for example, where a same computing device 18 and/or a same node 37 implements a particular long term storage 2540 and also implements a particular loading modules 2510.

Each loading module 2510 can generate and send the segments 2424 to long term storage 2540-1-2540-J in a set of persistence batches 2532-1-2532-J sent to the set of long term storage 2540-1-2540-J as illustrated in FIG. 25B. For example, upon generating a segment group 2522 of J segments 2424, a loading module 2510 can send each of the J segments in the same segment group to a different one of the set of long term storage 2540-1-2540-J in the storage cluster 2535. For example, a particular long term storage 2540 can generate recovered segments as necessary for processing queries and/or for rebuilding missing segments due to drive failure as illustrated in FIG. 24D, where the value K of FIG. 24D is less than the value J and wherein the nodes 37 of FIG. 24D are utilized to implement the long term storage 2540-1-2540-J.

As illustrated in FIG. 25B, each persistence batch 2532-1-2532-J can optionally or additionally include pages 2515 and/or their corresponding index data 2516 generated via index generator 2513. Some or all pages 2515 that are generated via a loading module 2510's page generator 2511 can be sent to one or more long term storage 2540-1-2540-J. For example, a particular page 2515 can be included in some or all persistence batches 2532-1-2532-J sent to multiple ones of the set of long term storage 2540-1-2540-J for redundancy storage as replicated pages stored in multiple locations for the purpose of fault tolerance. Some or all pages 2515 can be sent to storage cluster 2535 for storage prior to being converted into segments 2424 via segment generator 2617. Some or all pages 2515 can be stored by storage cluster 2535 until corresponding segments 2424 are generated, where storage cluster 2535 facilitates deletion of these pages from storage in one or more long term storage 2540-1-2540-J once these pages are converted and/or have their records 2422 successfully stored by storage cluster 2535 in segments 2424.

In some cases, a loading module 2510 maintains storage of pages 2515 via page cache 2512, even if they are sent to storage cluster 2535 in persistence batches 2532. This can enable the segment generator 2617 to efficiently read pages 2515 during the conversion process via reads from this local page cache 2512. This can be ideal in minimizing page movement, as pages do not need to be retrieved from long term storage 2540 for conversion into segments by loading modules 2510 and can instead be locally accessed via maintained storage in page cache 2512. Alternatively, a loading module 2510 removes pages 2515 from storage via page cache 2512 once they are determined to be successfully stored in long term storage 2540. This can be ideal in reducing the memory resources required by loading module 2510 to store pages, as only pages that are not yet durably stored in long term storage 2540 need be stored in page cache 2512.

Each long term storage 2540 can include its own page storage 2546 that stores received pages 2515 generated by and received from one or more loading modules 2010-1-2010-N, implemented utilizing memory resources of the long term storage 2540. For example, the page storage 2546 of each long term storage 2540-1-2540-J can individually or collectively implement some or all of the page storage system 2506 of FIG. 25A. The page storage 2546 can optionally store index data 2516 mapped to and/or included as metadata of its pages 2515. Each long term storage 2540 can alternatively or additionally include its own segment storage 2548 that stores segments generated by and received from one or more loading modules 2010-1-2010-N. For example, the segment storage 2548 of each long term storage 2540-1-2540-J can individually or collectively implement some or all of the segment storage system 2508 of FIG. 25A.

The pages 2515 stored in page storage 2546 of long term storage 2540 and/or the segments 2424 stored in segment storage 2548 of long term storage 2540 can be accessed to facilitate execution of queries. As illustrated in FIG. 25B, each long term storage 2540-1-2540-J can perform IO operators 2542 to facilitate reads of records in pages 2515 stored in their page storage 2546 and/or to facilitate reads of records in segments 2424 stored in their segment storage 2548. For example, some or all long term storage 2540-1-2540-J can be implemented as nodes 37 at the IO level 2416 of one or more query execution plans 2405. In particular, the some or all long term storage 2540-1-2540-J can be utilized to implement the query processing system 2502 by facilitating reads to stored records via IO operators 2542 in conjunction with query executions.

Note that at a given time, a given page 2515 may be stored in the page cache 2512 of the loading module 2510 that generated the given page 2515, and may alternatively or additionally be stored in one or more long term storage 2540 of the storage cluster 2535 based on being sent to the in one or more long term storage 2540. Furthermore, at a given time, a given record may be stored in a particular page 2515 in a page cache 2512 of a loading module 2510, may be stored the particular page 2515 in page storage 2546 of one or more long term storage 2540, and/or may be stored in exactly one particular segment 2424 in segment storage 2548 of one long term storage 2540.

Because records can be stored in multiple locations of storage cluster 2535, the long term storage 2540 of storage cluster 2535 can be operable to collectively store page and/or segment ownership consensus 2544. This can be useful in dictating which long term storage 2540 is responsible for accessing each given record stored by the storage cluster 2535 via IO operators 2542 in conjunction with query execution. In particular, as a query resultant is only guaranteed to be correct if each required record is accessed exactly once, records reads to a particular record stored in multiple locations could render a query resultant as incorrect. The page and/or segment ownership consensus 2544 can include one or more versions of ownership data, for example, that is generated via execution of a consensus protocol mediated via the set of long term storage 2540-1-2540-J. The page and/or segment ownership consensus 2544 can dictate that every record is owned by exactly one long term storage 2540 via access to either a page 2515 storing the record or a segment 2424 storing the record, but not both. The page and/or segment ownership consensus 2544 can indicate, for each long term storage 2540 in the storage cluster 2535, whether some or all of its pages 2515 or some or all of its segments 2424 are to be accessed in query executions, where each long term storage 2540 only accesses the pages 2515 and segments 2424 indicated in page and/or segment ownership consensus 2544.

In such cases, all record access for query executions performed by query execution module 2504 via nodes 37 at IO level 2416 can optionally be performed via IO operators 2542 accessing page storage 2546 and/or segment storage 2548 of long term storage 2540, as this access can guarantee reading of records exactly once via the page and/or segment ownership consensus 2544. For example, the long term storage 2540 can be solely responsible for durably storing the records utilized in query executions. In such embodiments, the cached and/or temporary storage of pages and/or segments of loading modules 2510, such as pages 2515 in page caches 2512, are not read for query executions via accesses to storage resources of loading modules 2510.

Some or all features and/or functionality of FIG. 25B can be performed via at least one node 37 in conjunction with system metadata applied across a plurality of nodes 37, for example, where at least one node 37 participates in some or all features and/or functionality of FIG. 25B based on receiving and storing the system metadata in local memory of the at least one node 37 as configuration data and/or based on further accessing and/or executing this configuration data to implement some or all functionality of a loading module 2510, to implement some or all functionality of a file reader, and/or to implement some or all functionality of the storage cluster 2535 as part of its database functionality accordingly. Performance of some or all features and/or functionality of FIG. 25B can optionally change and/or be updated over time, and/or a set of nodes participating in executing some or all features and/or functionality of FIG. 25B can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25C illustrates an example embodiment of a page generator 2511. The page generator 2511 of FIG. 25C can be utilized to implement the page generator 2511 of FIG. 25A, can be utilized to implement each page generator 2511 of each loading module 2510 of FIG. 25B, and/or can be utilized to implement any embodiments of page generator 2511 described herein.

A single incoming record stream, or multiple incoming record streams 1-L, can include the incoming records 2422 as a stream of row data 2910. Each row data 2910 can be transmitted as an individual packet and/or a set of packets by the corresponding data source 2501 to include a single record 2422, such as a single row of a database table. Alternatively each row data 2910 can be transmitted by the corresponding data source 2501 as an individual packet and/or a set of packets to include a batched set of multiple records 2422, such as multiple rows of a database table. Row data 2910 received from the same or different data source over time can each include a same number of rows or a different number of rows, and can be sent in accordance with a particular format. Row data 2910 received from the same or different data source over time can include records with the same or different numbers of columns, with the same or different types and/or sizes of data populating its columns, and/or with the same or different row schemas. In some cases, row data 2910 is received in a stream over time for processing by a loading module 2510 via a stateful file reader 2556 and/or via a stand-alone file reader 2558.

Incoming rows can be stored in a pending row data pool 3410 while they await conversion into pages 2515. The pending row data pool 3410 can be implemented as an ordered queue or an unordered set. The pending row data pool 3410 can be implemented by utilizing storage resources of the record processing and storage system. For example, each loading module 2510 can have its own pending row data pool 3410. Alternatively, multiple loading modules 2510 can access the same pending row data pool 3410 that stores all incoming row data 2910, for example, by utilizing queue reader 2559.

The page generator 2511 can facilitate parallelized page generation via a plurality of processing core resources 48-1-48-W. For example, each loading module 2510 has its own plurality of processing core resources 48-1-48-W, where the processing core resources 48-1-48-W of a given loading module 2510 is implemented via the set of processing core resources 48 of one or more nodes 37 utilized to implement the given loading module 2510. As another example, the plurality of processing core resources 48-1-48-W are each implemented by a corresponding one of the set of each loading module 2510-1-2510-N, for example, where each loading module 2510-1-2510-N is implemented via its own processing core resources 48-1-48-W.

Over time, each processing core resource 48 can retrieve and/or can be assigned pending row data 2910 in the pending row data pool 3410. For example, when a given processing core resource 48 has finished another job, such as completed processing of another row data 2910, the processing core resource 48 can fetch a new row data 2910 for processing into a page 2515. For example, the processing core resource 48 retrieves a first ordered row data 2910 from a queue of the pending row data pool 3410, retrieves a highest priority row data 2910 from the pending row data pool 3410, retrieves an oldest row data 2910 from the pending row data pool 3410, and/or retrieves a random row data 2910 from the pending row data pool 3410. Once one processing core resource 48 retrieves and/or otherwise utilizes a particular row data 2910 for processing into a page, the particular row data 2910 is removed from the pending row data pool 3410 and/or is otherwise not available for processing by other processing core resources 48.

Each processing core resource 48 can generate pages 2515 from the row data received over time. As illustrated in FIG. 25C, the pages 2515 are depicted to include only one row data, such as a single row or multiple rows batched together in the row data 2910. For example, each page is generated directly from corresponding row data 2910. Alternatively, a page 2515 can include multiple row data 2910, for example, in sequence and/or concatenated in the page 2515. The page can include multiple row data 2910 from a single data source 2501 and/or can include multiple row data 2910 from multiple different data sources 2501. For example, the processing core resource 48 can retrieve one row data 2910 from the pending row data pool 3410 at a time, and can append each row data 2910 to a given page until the page 2515 is complete, where the processing core resource 48 appends subsequently retrieved row data 2910 to a new page. Alternatively, the processing core resource 48 can retrieve multiple row data 2910 at once, and can generate a corresponding page 2515 to include this set of multiple row data 2910.

Once a page 2515 is complete, the corresponding processing core resource 48 can facilitate storage of the page in page storage system 2506. This can include adding the page 2515 to the page cache 2512 of the corresponding loading module 2510. This can include facilitating sending of the page 2515 to one or more long term storage 2540 for storage in corresponding page storage 2546. Different processing core resources 48 can each facilitate storage of the page via common resources, or via designated resources specific to each processing core resources 48, of the page storage system 2506.

Some or all features and/or functionality of FIG. 25C can be performed via at least one node 37 in conjunction with system metadata applied across a plurality of nodes 37, for example, where at least one node 37 participates in some or all features and/or functionality of FIG. 25C based on receiving and storing the system metadata in local memory of the at least one node 37 as configuration data and/or based on further accessing and/or executing this configuration data to implement some or all functionality of a loading module 2510, to implement some or all functionality of page generator 2511 and/or page storage system 2506 as part of its database functionality accordingly. Performance of some or all features and/or functionality of FIG. 25C can optionally change and/or be updated over time, and/or a set of nodes participating in executing some or all features and/or functionality of FIG. 25C can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25D illustrates an example embodiment of the page storage system 2506. As used herein, the page storage system 2506 can include page cache 2512 of a single loading module 2510; can include page caches 2512 of some or all loading module 2510-1-2510-N; can include page storage 2546 of a single long term storage 2540 of a storage cluster 2535; can include page storage 2546 of some or all long term storage 2540-1-2540-J of a single storage cluster 2535; can include page storage 2546 of some or all long term storage 2540-1-2540-J of multiple different storage clusters, such as some or all storage clusters 35-1-35-z; and/or can include any other memory resources of database system 10 that are utilized to temporarily and/or durably store pages.

Some or all features and/or functionality of FIG. 25D can be performed via at least one node 37 in conjunction with system metadata applied across a plurality of nodes 37, for example, where at least one node 37 participates in some or all features and/or functionality of FIG. 25D based on receiving and storing the system metadata in local memory of the at least one node 37 as configuration data and/or based on further accessing and/or executing this configuration data to implement some or all functionality of a loading module 2510 and/or a given long term storage 2540 as part of its database functionality accordingly. Performance of some or all features and/or functionality of FIG. 25D can optionally change and/or be updated over time, and/or a set of nodes participating in executing some or all features and/or functionality of FIG. 25D can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25E illustrates an example embodiment of a node 37 utilized to implement a given long term storage 2540 of FIG. 25B. The node 37 of FIG. 25E can be utilized to implement the node 37 of FIG. 25B, FIG. 25C, 25D, some or all nodes 37 at the IO level 2416 of a query execution plan 2405 of FIG. 24A, and/or any other embodiments of node 37 described herein. As illustrated a given node 37 can have its own segment storage 2548 and/or its own page storage 2546 by utilizing one or more of its own memory drives 2425. Note that while the segment storage 2548 and page storage 2546 are segregated in the depiction of a memory drives 2425, any resources of a given memory drive or set of memory drives can be allocated for and/or otherwise utilized to store either pages 2515 or segments 2424. Optionally, some particular memory drives 2425 and/or particular memory locations within a particular memory drive can be designated for storage of pages 2515, while other particular memory drives 2425 and/or other particular memory locations within a particular memory drive can be designated for storage of segments 2424.

The node 37 can utilize its query processing module 2435 to access pages and/or records in conjunction with its role in a query execution plan 2405, for example, at the IO level 2416. For example, the query processing module 2435 generates and sends segment read requests to access records stored in segments of segment storage 2548, and/or generates and sends page read requests to access records stored in pages 2515 of page storage 2546. In some cases, in executing a given query, the node 37 reads some records from segments 2424 and reads other records from pages 2515, for example, based on assignment data indicated in the page and/or segment ownership consensus 2544. The query processing module 2435 can generate its data blocks to include the raw row data of the read records and/or can perform other query operators to generate its output data blocks as discussed previously. The data blocks can be sent to another node 37 in the query execution plan 2405 for processing as discussed previously, such as a parent node and/or a node in a shuffle node set within the same level 2410.

Some or all features and/or functionality of FIG. 25E can be performed a given node 37 in conjunction with system metadata applied across a plurality of nodes 37, for example, where the given node 37 performs some or all features and/or functionality of FIG. 25E based on receiving and storing the system metadata in local memory of the at least one node 37 as configuration data, and/or based on further accessing and/or executing this configuration data to implement some or all functionality of the given node 37 of FIG. 25E as part of its database functionality accordingly. Performance of some or all features and/or functionality of FIG. 25E can optionally change and/or be updated over time based on the system metadata applied across the plurality of nodes 37 being updated over time and/or based on nodes on updating their configuration data stored in local memory to reflect changes in the system metadata based on receiving data indicating these changes to the system metadata.

In some embodiments, some or all features and/or functionality of loading new data (e.g. as new pages and/or new segments), for example, via one or more loading modules 2510 and/or via record processing and storage system 2505 as described herein implements some or all features and/or functionality of loading modules, record processing and storage system, and/or any loading of data for storage and access in query execution as disclosed by: U.S. Utility application Ser. No. 18/355,497, entitled “TRANSFER OF A SET OF SEGMENTS BETWEEN STORAGE CLUSTERS OF A DATABASE SYSTEM”, filed Jul. 20, 2023; and/or U.S. Utility application Ser. No. 18/308,954, entitled “QUERY EXECUTION DURING STORAGE FORMATTING UPDATES”, filed Apr. 28, 2023; which are hereby incorporated herein by reference in its entirety and made part of the present U.S. Utility patent application for all purposes.

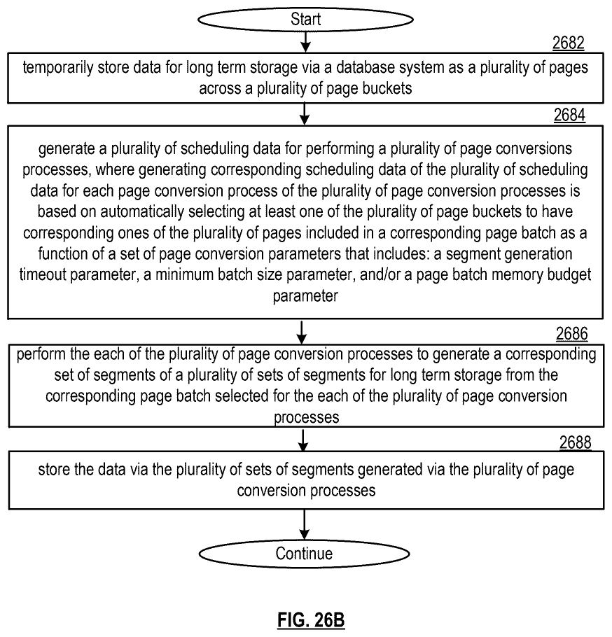

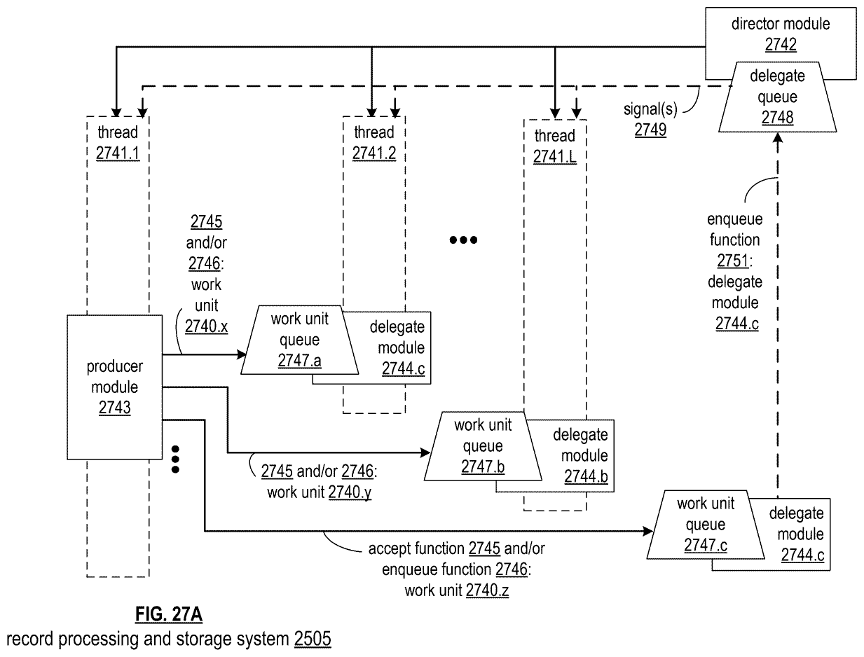

FIG. 26A illustrates an embodiment of database system 10 where page conversion process is performed based on implementing a page bucket scheduling module 3614 to schedule page buckets 3615 to have corresponding pages 2515 converted based on page conversion parameters 2643, such as a segment generation timeout parameter 2644, minimum batch size parameter 2645, and/or page batch memory budget parameter 2646. For example, page state data 2647 (e.g. indicating ages and/or sizes of pages in page buckets 3615 at a given time) can be received and/or measured over time to determine when any corresponding page buckets 3615 should have their pages included in conversion page set 2655 (e.g. corresponding page batch for conversion), as dictated by the page conversion parameters 2643. In this example, one or more page buckets 3615.x is selected to have some or all of its pages (e.g. an amount of data dictated by page batch memory budget parameter 2646) included in conversion page set 2655 for a given page conversion process, for example, based on having an oldest page with an age, for example, corresponding to a difference in current time and creation time of the page, that is greater than or otherwise compares unfavorably to a predetermined fraction (e.g. one half) of an amount of time indicated by segment generation timeout parameter 2644. Other buckets can be selected over time for other page conversion processes.

The embodiment illustrated in FIG. 26A can be utilized to implement one or more nodes 37 of one or more computing devices 18 implementing database system 10. Some or all features and/or functionality of FIG. 26A can be utilized to implement any embodiment of database system 10 described herein.

In some embodiments, the page conversion determination module 2610 (e.g. corresponding loading module 2610), determines, when determining to initiate a corresponding page conversion process, when to start draining pages, which and how many pages to drain, and/or how many buckets/batches to drain concurrently.

In some embodiments, every page bucket is evaluated at regular time intervals (e.g. every second) to detect if the page bucket meets any eligibility conditions that would trigger a corresponding page conversion process (e.g. in corresponding page state data 2647 measured/collected at the regular time intervals). For example, a page bucket already draining (e.g. triggered manually and/or by CTAS/IAS) can trigger a page conversion process. As another example, once an oldest page in a page bucket exceeds a timeout, for example, dictated by a segment generation timeout parameter 2644 (e.g. corresponding value of a segmentGenerationTimeout parameter), that page bucket is scheduled for conversion into segments via its pages being included in a conversion page set of a corresponding page conversion process. As another example, when a sum of page sizes exceeds a watermark (e.g. corresponding value of a segmentGenerationWatermark parameter) and/or by memory usage models (e.g. implemented via an adaptive watermark), a set of one or more buckets are scheduled for conversion into segments via its pages being included in a conversion page set of a corresponding page conversion process.

In some embodiments, if a page bucket is eligible and/or is scheduled for use in conversion page process, a maximum batch size (e.g. maxBatchSize) is calculated (e.g. as the same value as watermark in some embodiments and/or set based on the page batch memory budget parameter), where pages from the selected bucket(s) are selected, oldest to youngest, to comprise a page batch of size less than or equal to this maximum batch size.

In some embodiments, multiple page buckets may be processed by segment generation process (e.g. “drained”) at the same time (e.g. if there is hugepage and/or heap memory available). Page buckets can be prioritized roughly by an order of a set of conditions for inclusion in conversion page set (e.g. already flushing is highest priority, followed by page buckets with pages older than a predetermined fraction of segment generation timeout parameter 2644 being a next higher priority, where further page buckets not meeting these two conditions are optionally added if enough memory is available (e.g. until an amount/percentage of memory indicated by page batch memory budget parameter 2646 is utilized).

In some embodiments, the scheduling of page buckets for page conversion processes is configured to maximize page batch size and consequently segment size. In other embodiments, there is less pressure for large segments (e.g. based on the database system 10 implementing a segment directory as discussed in further detail herein). This allowance can enable optimizing for higher parallelism and reliable time-to-segment (e.g. time-to-segment measures the time between a row being ingested by a loading module and it becoming durable as a segment). Segment generation can correspond to a significant fraction of this process, and page batch management can control its input, for example, based on applying page conversion parameters 2643.

In some embodiments, segment generation timeout parameter 2644 can specify a target time-to-segment, which can be attained in some or all page conversion processes (e.g. this goal can be impossible if the ingest rate is greater than peak segment generation throughput—in these scenarios, pages will build up and time-to-segment will increase). Within this constraint, segment size can then be maximized (e.g. segments are generated to be as large as possible so long as a maximum time-to-segment indicated by segment generation timeout parameter 2644 is met).

In some embodiments, such page batch management (e.g. dictating when, how large, and/or from which pages conversion page set 2655 is built for a corresponding page conversion process) is controlled by page conversion parameters 2643, which can include a segment generation timeout parameter 2644, a minimum batch size parameter 2645, a page batch memory budget parameter 2646, and/or one or more other parameters.

In some embodiments, some or all of the page conversion parameters 2643 are configurable (e.g. via user input, for example, in a corresponding SQL command or other instruction generated by and/or received from a computing device based on user input from a corresponding user entity). In some embodiments, some or all of the page conversion parameters have default values utilized in the case where user input does not indicate configured values for these parameters. A given value for a given parameter 2643 can be re-tuned over time (e.g. by a same or different user entity), for example, based on changes in the user's desire for any of these constraints (e.g. changes in their tradeoff of time-to-segment vs. maximizing segment size). A given value for a different parameter 2643 can be different for different relational database tables (e.g. a given user entity sets different values for one or more parameters to be applied to different tables of a given dataset(s) controlled by this user entity; and/or multiple different user entities controlling different datasets each set their own configured values for some of all of the parameters to be applied to some or all tables of their given dataset).

The segment generation timeout parameter 2644 (e.g. configured as the value for variable “segmentGenerationTimeout”) can indicate the time-to-segments target (e.g. in seconds and/or minutes). Pages older than a predetermined fraction of the value of segment generation timeout parameter 2644 (e.g. pages older than segmentGenerationTimeout/2, or some other fraction of segmentGenerationTimeout) can trigger their respective page bucket to be eligible for segment generation (e.g. can trigger inclusion in a conversion page set 2655 for an upcoming page conversion process. The segment generation timeout parameter 2644 can be set per-table. A default value of segment generation timeout parameter 2644 can be 7.5 minutes, and/or another value.

The minimum batch size parameter 2645 (e.g. configured as the value for variable “minBatchSize”) can indicate the smallest a page batch (e.g. conversion page set 2655) is allowed to be. A non-zero value can imply that pages can exist indefinitely (a manual flush request would be necessary to drain them). The minimum batch size parameter 2645 can be set per-table. A default value of minimum batch size parameter 2645 can be 1 GB, and/or another value.

The page batch memory budget parameter 2646 (e.g. configured as the value for variable “pageBatchMemoryBudgef”) can indicate a percentage of memory (e.g. percentage of hugepage memory) allocated for staging page data for segment generation. A default value page batch memory budget parameter 2646 can be configured to be low enough to avoid out of memory (OOM) in all cases, and/or a predetermined cap can be applied that cannot be exceeded by any user-configured values to avoid out of memory (OOM) in all cases. In some embodiments, the value for page batch memory budget parameter 2646 cannot be set per-table, where all tables thus share the same allocation dictated by page batch memory budget parameter 2646. The default value of page batch memory budget parameter 2646 can be 20%, and/or another value.

In some embodiments, a page buckets can be selected to have pages included in a corresponding conversion page set 2655 of an upcoming page conversion process if it satisfies one of three criteria (e.g. as indicated in page state data 2647): (1) flushing: a flush (e.g. drain) was triggered manually or by CTAS/IAS for this bucket's table/scope (e.g. page state data 2647 indicates whether each page bucket 3615 is already flushing); (2) timed out: its oldest page's age exceeds segmentGenerationTimeout/2 (or other fraction of segment generation timeout parameter 2644) for its table (e.g. page state data 2647 indicates creation times/corresponding ages of pages 2515); (3) overflowed: its size exceeds pageBatchMemoryBudget in bytes (e.g. page state data 2647 indicates the current size of each page bucket 3615). In some embodiments, flushing buckets have top priority and will consume as much memory budget as needed.

In some embodiments, if there are one or more timed out buckets, they will be scheduled together, where the memory budget for the conversion page set (e.g. dictated by page batch memory budget) is divided proportional to how much data is in each bucket. In some embodiments, buckets may or may not need all of the budget allocated to them depending on how much page data there is.

In some embodiments, if there are no flushing or timed out buckets, buckets are selected for inclusion in conversion page set based on checking for buckets that have overflowed, and/or filling the budget with the oldest bucket. Once buckets are decided, the memory budget each bucket is allocated can be filled with pages from that bucket, oldest to youngest (e.g. one or more buckets are not completely drained for a given page conversion process, and are optionally top priority to have their remaining pages included in a next conversion page set of a subsequent page conversion process).

In some embodiments, when a loading module 2510 implementing page conversion process goes down and comes back up, it loses information about when its pages were created and/or (roughly) assumes they were created at bring-up time. It can therefore lose information about the pages' priority from before bring-down. To resolve this problem, in some embodiments, a created time (e.g. “createTime”) field for each segment group on the storage cluster can be utilized to communicate the page creation time (e.g. through the ownership updates), where the loading module 2510 uses that as the creation timestamp of each page to figure out which pages have expired. In some embodiments, this is only relevant when a loader is coming online from an offline state. In some embodiments, the loading module 2510 notes the time when it receives complete responses for each page group (e.g. because ownership updates are not received on a regular interval).

In some embodiments, the page conversion determination module 2610 implements page bucket scheduling module 2614 in conjunction with implementing some or all features and/or functionality of the page conversion determination module 2610, loading module 2510, and/or identification and/or draining of pages for inclusion in conversion page set 2655 of a page conversion process disclosed by: U.S. Utility application Ser. No. 18/632,629, entitled “DATABASE SYSTEM PERFORMANCE OF A STORAGE REBALANCING PROCESS”, filed Apr. 11, 2024, which is hereby incorporated herein by reference in its entirety and made part of the present U.S. Utility patent application for all purposes.

FIG. 26B illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 26B, for example, based on participating in execution of a loading operation or other operation being executed by the database system 10. Some or all of the method of FIG. 26B can be performed by nodes executing a loading operation, for example, via one or more nodes 37 implemented as loading modules 2510. In some embodiments, a node 37 can implement some or all of FIG. 26B based on implementing a corresponding plurality of processing core resources 48.1-48.W. Some or all of the steps of FIG. 26B can optionally be performed by any other one or more processing modules of the database system 10.

Some or all steps of FIG. 26B can be performed in parallel and/or concurrently via a plurality of parallelized processing resources (e.g. implemented via a plurality of nodes 37 and/or a plurality of processing core resources 48). For example, multiple instances of any given step of FIG. 26B can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of FIG. 26B can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step.

Some or all of the steps of FIG. 26B can be performed to implement some or all of the functionality of the database system 10 as described in conjunction with FIGS. 26A, for example, by implementing some or all of the functionality of page conversion determination module 2610 of record processing and storage system 2505. Some or all steps of FIG. 26B can be performed by database system 10 in accordance with other embodiments of the database system 10 and/or nodes 37 discussed herein. Some or all of the steps of FIG. 26B can be performed in conjunction with performing some or all steps of any other method described herein.

Step 2682 includes temporarily storing data for long term storage via a database system as a plurality of pages across a plurality of page buckets. Step 2684 includes generating a plurality of scheduling data for performing a plurality of page conversions processes. In various examples, generating corresponding scheduling data of the plurality of scheduling data for each page conversion process of the plurality of page conversion processes is based on automatically selecting at least one of the plurality of page buckets to have corresponding ones of the plurality of pages included in a corresponding page batch as a function of a set of page conversion parameters that includes: a segment generation timeout parameter, a minimum batch size parameter, a page batch memory budget parameter, and/or at least one additional parameter. Step 2686 includes performing the each of the plurality of page conversion processes to generate a corresponding set of segments of a plurality of sets of segments for long term storage from the corresponding page batch selected for the each of the plurality of page conversion processes. Step 2688 includes storing the data via the plurality of sets of segments generated via the plurality of page conversion processes.

In various examples, generating corresponding scheduling data for a first one of the plurality of page conversion processes includes automatically selecting a first page bucket of the plurality of page buckets for inclusion in a first page batch based on determining an oldest page in the first page bucket has an age comparing unfavorably to a predetermined fraction of the segment generation timeout parameter.

In various examples, the predetermined fraction is one half.

In various examples, a first set of segments is generated via the first one of the plurality of page conversion processes performed via a first loading module of a plurality of loading modules. In various examples, the first loading module transitions from an online state to an offline state during performance of the first one of the plurality of page conversion processes. In various examples, the age of the oldest page in the first page bucket is determined by the loading module, after transitioning from the offline state back to the online state, based on accessing a creation timestamp indicated in ownership updates for the corresponding set of segments

In various examples, generating corresponding scheduling data for a second one of the plurality of page conversion processes includes automatically selecting a second page bucket of the plurality of page buckets for inclusion in a second page batch based on determining the second page bucket has a bucket size comparing unfavorably to the page batch memory budget parameter.

In various examples, generating corresponding scheduling data for a third one of the plurality of page conversion processes includes automatically selecting a third page bucket of the plurality of page buckets for inclusion in a third page batch based on determining a flush of the third page bucket has already been initiated.

In various examples, the flush of the third page bucket is initiated via one of: a user command, a Create Table As Select operation, or an Insert As Select operation.

In various examples, a segment generation timeout value for the segment generation timeout parameter is configured via user input. In various examples, a minimum batch size value for minimum batch size parameter is configured via the user input. In various examples, a page batch memory budget value for the page batch memory budget parameter is configured via the user input.

In various examples, the user input is generated via a computing device of a user entity that is one of: a data supplier user entity that supplies the data for storage, or a query user entity that generates query requests for execution against the data for storage.

In various examples, all of the set of page conversion parameters have corresponding values configured via the user input.

In various examples, the segment generation timeout value for the segment generation timeout parameter is set as a default segment generation timeout value based on the user input not including any user configured value for the segment generation timeout parameter. In various examples, the minimum batch size value for the minimum batch size parameter is set as a default minimum batch size value based on the user input not including any user configured value for the minimum batch size parameter. In various examples, the page batch memory budget value for the page batch memory budget parameter is set as a default page batch memory budget value based on the user input not including any user configured value for the page batch memory budget parameter.

In various examples, the default segment generation timeout value indicates an amount of time longer than one minute and less than ten minutes (e.g. 7.5 minutes). In various examples, the default minimum batch size value indicates an amount of data greater than 100 megabytes and less than 10 gigabytes (e.g. 1 GB). In various examples, the default page batch memory budget value indicates a percentage of memory greater than ten percent and less than twenty-five percent (e.g. 20%).

In various examples, generating the corresponding scheduling data includes identifying an oldest subset of pages in each page of the at least one of the plurality of page buckets for inclusion in the corresponding page batch consuming up to a maximum amount of memory dictated by the page batch memory budget parameter.

In various examples, multiple page buckets are automatically selected in the corresponding scheduling data for one of the plurality of page conversion processes. In various examples, a budgeted amount of memory for the corresponding page batch (indicated by page batch memory budget parameter) is divided into a plurality of maximum amounts of memory, each corresponding to one of the multiple page buckets and each proportional to a corresponding amount of data included in the one of the multiple page buckets relative to other corresponding amounts of data included in other ones of the multiple page buckets.

In various examples, the multiple page buckets are automatically selected based on selecting, at a time the corresponding scheduling data for one of the plurality of page conversion processes is generated, all page buckets having ages comparing unfavorably to a predetermined fraction of the segment generation timeout parameter.

In various examples, the data includes a plurality of records for a plurality of relational database tables. In various examples, each set of segments of the plurality of sets of segments corresponds to one of the plurality of relational database tables;

In various examples, the set of page conversion parameters includes a plurality of different segment generation timeout values for the segment generation timeout parameter each corresponding to a different one of the plurality of relational database tables. In various examples, the set of page conversion parameters includes a plurality of different minimum batch size values for the minimum batch size parameter that each correspond to a different one of the plurality of relational database tables. In various examples, the set of page conversion parameters includes a plurality of different page batch memory budget values for the page batch memory budget parameter that each correspond to a different one of the plurality of relational database tables.

In various examples, the each page conversion process is performed to generate corresponding segments storing data belonging to one corresponding relational database table. In various examples, generating the corresponding scheduling data of the plurality of scheduling data for the each page conversion process of the plurality of page conversion processes is based on applying ones of the set of page conversion parameters for the one corresponding relational database table.

In various examples, the plurality of pages are generated at a corresponding plurality of creation times. In various examples, the segment generation timeout parameter indicates a maximum amount of time frame from a corresponding creation time that a given page have corresponding data stored in at least one corresponding segment. In various examples, at least a threshold proportion of pages of the plurality of pages have corresponding data stored in corresponding segments within the time frame from corresponding creation times based on generating plurality of scheduling data as a function of the segment generation timeout parameter.

In various examples, after performance of a proper subset of the plurality of page conversion processes, a first subset of the data is stored in a first subset of segments of the plurality of sets of segments generated via the proper subset of the plurality of page conversion processes and a second subset of the data is stored in a set of remaining pages of the plurality of pages awaiting conversion into a segments. In various examples, the method further includes: determining a query for execution against a dataset that includes the data and/or executing the query to generate a corresponding query resultant based on accessing: at least one of the first subset of segments; and/or at least one of the set of remaining pages.

In various examples, performing one of the plurality of page conversion processes includes executing a segment generation operation to generate a single segment based on: generating, via a director module, a plurality of parallelized threads for generating the single segment; generating, via a producer module implemented based on utilizing a first parallelized thread of the plurality of parallelized threads, a plurality of work units assigned to a plurality of delegate modules for processing; and/or processing, via each of the plurality of delegate modules while utilizing a corresponding parallelized thread of a subset of parallelized threads of the plurality of parallelized threads, a corresponding subset of work units of the plurality of work units assigned to the each of the plurality of delegate modules.

In various examples, the method further includes: generating a tree topology for a segment directory group that includes a corresponding plurality of segments included in the plurality of sets of segments, wherein a plurality of leaf tree nodes of the tree topology correspond to the corresponding plurality of segments; storing a set of files for the segment directory group in the disk memory resources, wherein each file of the set of files corresponds to a corresponding tree node of a set of internal tree nodes of the tree topology, wherein the each file indicates a corresponding set of memory locations in the disk memory resources each storing data corresponding to a corresponding child tree node of a set of child tree nodes of the corresponding tree node in the tree topology; and/or storing root tree node data for a root tree node of the of the tree topology as state data maintained via a consensus protocol mediated via the plurality of nodes, wherein the root tree node data includes a set of memory locations for a subset of the set of files corresponding to child tree nodes of the root tree node in the tree topology.

In various examples, the segment directory group includes a plurality of segment directories, wherein each directory of the plurality of segment directories contains directory metadata indicating, for each child tree node of a set of child tree nodes of the tree topology: a storage identifier for the child tree node and an owner field for the each child tree node. In various examples, the method further includes accessing the corresponding plurality of segments and the set of files of the tree topology based on: when a root directory owner field for the segment directory group has one of: and unowned value or the value of the owner field, applying a first owned storage identifier indicated by the storage identifier and a value of the owner field; and/or when a root directory owner field for the segment directory group has one another value different from the value of the owner field, applying a second owned storage identifier indicated by the storage identifier and the another value of the root directory owner field.

In various embodiments, any one of more of the various examples listed above are implemented in conjunction with performing some or all steps of FIG. 26B. In various embodiments, any set of the various examples listed above can be implemented in tandem, for example, in conjunction with performing some or all steps of FIG. 26B, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 26B described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 26B, for example, in conjunction with further implementing any one or more of the various examples described above.

In various embodiments, the operational instructions, when executed by the at least one processor, cause the database system to: temporarily store data for long term storage via a database system as a plurality of pages across a plurality of page buckets; generate a plurality of scheduling data for performing a plurality of page conversions processes, wherein generating corresponding scheduling data of the plurality of scheduling data for each page conversion process of the plurality of page conversion processes is based on automatically selecting at least one of the plurality of page buckets to have corresponding ones of the plurality of pages included in a corresponding page batch as a function of a set of page conversion parameters that includes: a segment generation timeout parameter, a minimum batch size parameter, and/or a page batch memory budget parameter; perform the each of the plurality of page conversion processes to generate a corresponding set of segments of a plurality of sets of segments for long term storage from the corresponding page batch selected for the each of the plurality of page conversion processes; and/or store the data via the plurality of sets of segments generated via the plurality of page conversion processes.

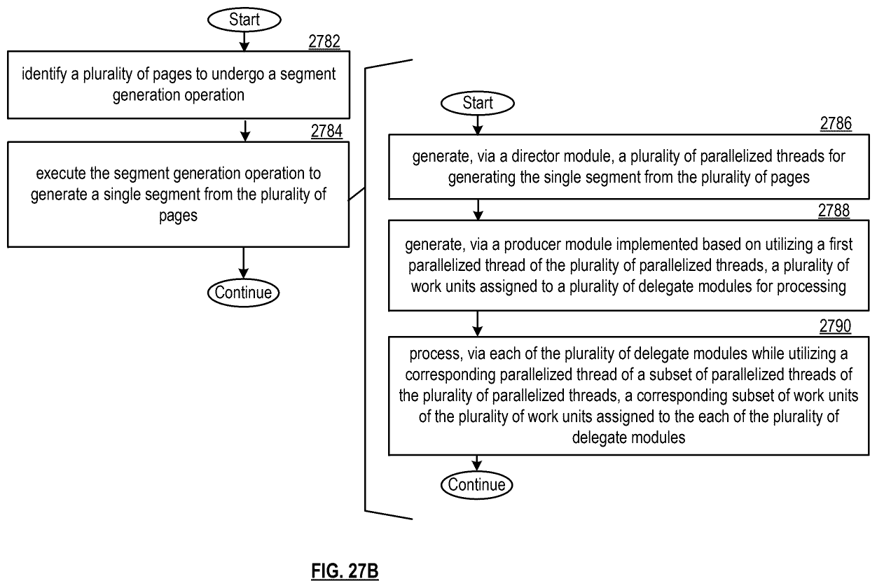

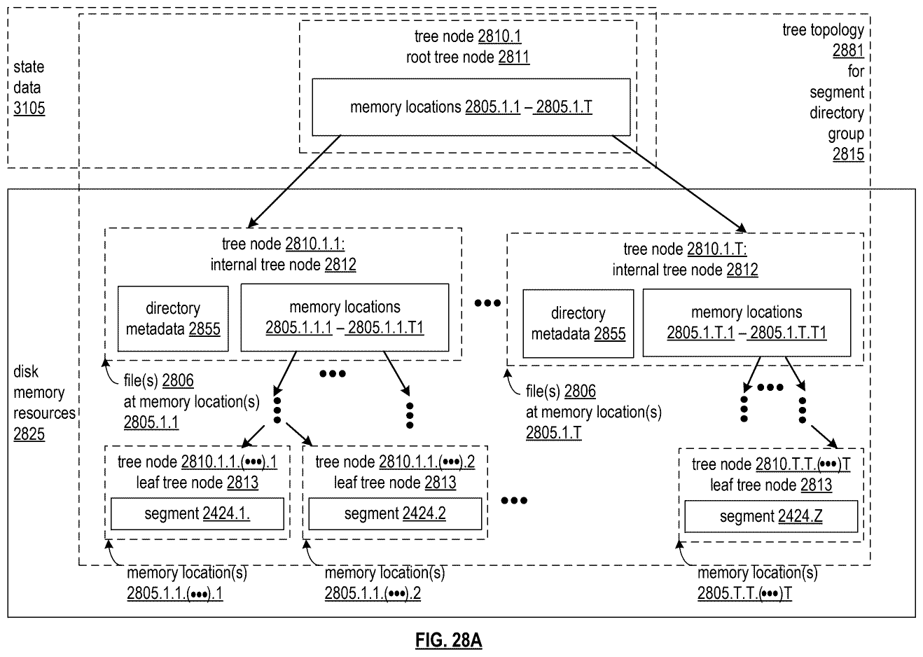

FIG. 27A illustrates an embodiment of database system 10 where a segment generation portion of page conversion process is performed via a plurality of parallelized threads 2741.1-2741.L (e.g. implemented via a corresponding plurality of processing core resources 48.1-48.L of a given node, for example, operating as a given loading module 2510), for example, based on implementing: a director module 2742 to generate and/or manage the plurality of parallelized threads 2741.1-2741.L; a producer module 2743 that generates work units 2740; and/or a plurality of delegate modules 2744 each operable to enqueue respective work units 2740 assigned to them by producer module 2743 for execution via a corresponding parallelized thread 2741, assigned for utilization by a given delegate module 2744 by director module 2741.

The embodiment illustrated in FIG. 27A can be utilized to implement one or more nodes 37 of one or more computing devices 18 implementing database system 10. Some or all features and/or functionality of FIG. 27A can be utilized to implement any embodiment of database system 10 described herein.

In some embodiments, performance of a segment generation operation is the first step in the process of replacing pages with segments (e.g. via a corresponding page conversion process), for example, followed by a segment grouping operation and/or segment transfer operation. For example, to perform a round of segment generation, a page batch (e.g. some or all of conversion page set 2655) is loaded into memory and/or its rows are divided into several partitions. A corresponding loading coordinator can assign each partition to a segment generator worker thread, which can convert the rows in that partition into a single segment (e.g. a TKT segment) such as a segment generated prior to cluster key-based grouping, formatted in a same fashion as segment 2424 generated after cluster key-based grouping. This single segment can be returned to the loading coordinator, which can await all segments from the page batch before continuing to segment grouping.

In some embodiments, while processing the partition data by a segment generator worker thread: (1) the respective data is rotated from row major for to a columnar representation; (2) secondary index generation is performed; and/or (3) statistics generation is performed.

In some embodiments, these three steps run in a sequential order on one segment generation worker thread, where the process is bound to the single thread performance of a loader node. In such embodiments, because one worker thread is occupied with all stages of turning partition data into a segment, a tuning knob can be implemented to adjust the number of segment generator threads (which by default can be set to the number of cores—N) to produce large enough segments with the highest parallelism possible. In such embodiments, the page batch data was split into N partitions, which can render poor segment quality in some cases.

In some embodiments, such embodiments of the loading process are operable to accumulate data in pages up to the point of turning the pages into segments. Although page data is queryable, the performance benefit database system 10 can bring to a customer workload can be often achieved when secondary indexes (e.g. like N-gram or geospatial indexes) have been generated and pages got turned into segments.

In some embodiments, the data being loaded has a wide spectrum, from large amounts to small fractions (couple of GB only) of either well ordered (with respect to time buckets) or totally random ordered data.

In some embodiments, a main criteria for good load performance can be driven by the segment size and the throughput (e.g. bytes loaded). In some embodiments, time-to-query (e.g. time-to-segment and/or time from page creation until data is present in dumbly stored segments) can be favorable to improve the speed of query processing (e.g. based on the ability to leverage secondary index structures during query execution). Because of the nature of the loaded data, the load process can require sensitive tuning of configuration values for loading, the number of segment generation, the segment generation timeout, the page size etc.

FIG. 27A presents an embodiment of record processing and storage system 2505 that generates a single segment (e.g. formatted as a segment 2424 prior to segment grouping being performed) via a plurality of parallelized threads 2741.1-2741.L. This can improve the technology of database systems, for example, based on improving the speed by which segment generation occurs, which can in turn improve the speed by which the entire page conversion process is completed to generate segments 2424 for storage, which can make respective querying faster, for example due to the presence and use of secondary indexes (e.g. rather than accessing corresponding rows in pages awaiting conversion in the case of a lengthier process, where these indexes are not yet generated which can cause query execution to be slower).

In particular, rather than generating one segment by a single thread, the work to generate this single segment can be divided up and worked on by multiple different threads. This can allow a healthy (e.g. full) utilization of hardware resources without having to sacrifice segment sizes and latency (e.g. time-to-query).

This multi-threaded approach can be achieved via a component implemented as a director module 2742 for segment generation operations performed by a loading module 2510. The director module 2742 can implement a combination of work scheduling and a thread pool. During construction, the director can generate L threads, for example, that are bound to the cores (e.g. processing core resources 48) of the respective loader node 2510. In some embodiments, there are no more threads than cores available. The threads can be managed by the director module 2742, which can give director module 2742 the thread pool characteristic.

In some embodiments, the director module 2742 director furthermore provides interface functions to schedule work, for example, in the form of work items. Work items can interact with each other through work units. Some work items correspond to producer work items (e.g. producerWorkItem) for example, implemented via producer module 2743, which are operable to produce work units. Other work items correspond to delegate work items, for example, implemented via delegate modules 2744, which are each operable to consume these work units and the associated data (e.g. via performing a corresponding work item routine, such as delegatedWorkItemRoutine_t).

In some embodiments, producer work items (e.g. a given producer module 2743) will block a thread/core through the complete lifetime of the overall operation (e.g. based on utilizing this core throughout the operation in generating and assigning work units). The work units that they produced can be handled by the delegate modules 2744, where delegate modules 2744 run on some or all of the remaining threads 2741 of the loader node. Work unit assignment between a producer and a delegate can be performed through a corresponding queue 2747 (e.g. a single producer single consumer (spsc) queue). Every delegate can have its own queue 2747, which can ensure no shared queue (and/or locking) is necessary to assign work units.

In some embodiments, if a delegate module 2744 is active on a thread and processes work units of its queue 2747, new work units can be dispatched to the delegate and will be processed. Where the delegate will continue to occupy the corresponding thread resource. This can be achieved through an accept function 2745 (e.g. an accept( ) method) right before a following call to enqueue function 2746 (e.g. an enqueue( ) call).

In some embodiments, if a delegate module 2744 is not active on a threads, it's queue 2747 can have one or more queued work units. The accept function 2745 (e.g. accept( ) method) can cause the delegate module to be placed on a queue 2748 of delegates (e.g. queueltem_t) within the director module 2742. This second queue can signaling the threads of the directory (e.g. via one or more signals 2749) that a new delegate is ready to be served. Only idling threads are sensitive to this signal (e.g. implemented by a futex) and will execute the delegate (e.g. one idling thread will be utilized by the given delegate).

An active delegate module 2744 can try to clean its queue of any work unit before freeing the occupied thread. While other delegates (e.g. with a filled and/or non-empty work unit queue) occupy the thread, the queue of the previous work item fills again with new work units.

In some embodiments, it is intended to have way more work items than threads on a loader node (e.g. loading module 2510). For example, delegate modules 2744 will “fight” for compute capacity (e.g. thread occupation) on the loader node to allow full CPU utilization (e.g. >90%) when generating one segment only.

In some embodiments, producer module 2743 and delegate modules 2744 have a parent-child relation. In some embodiments, errors in the producer module lead to stop-executing signals in the delegate module, and/or errors in a delegate module need to be propagated to the producer module, and all other delegates of that producer.

For segment generation, producer module 2743 can be implemented via a segment generation work item (e.g. “segmentGeneratorWorkltem”), that serves as producer and/or holds 3 delegatedWorkItemRoutine types: a column slab work item (e.g. “columnSlabWorkltem_t”), a secondary index work item (e.g. “secondarylndexWorkltem_t”), and/or a statistics work item (e.g. “statisticsWorkltem_t”).

In some embodiments, the segment generation work item (e.g. the corresponding producer module 2743) performs heavyweight data rotation work (e.g. converting data from row representation in pages to columnar representation) of data and/or generates work units on this rotated data to build the secondary indexes, the statistics and the column slab.

When processing data for a table, the number of columns and secondary indexes can determine the number of delegates that exist for one producer module 2743. For example, each column is associated with a statistics work item and a column slab work item. If a column is part of a secondary index, another secondary index work item is added.

In some embodiments, it is possible to schedule multiple rounds of segment generation to the director module 2742. For example, each round can create exactly one producer work item that monopolizes its thread, where it's important that the director doesn't over-schedule producer work items and leaves at least one thread to drain the delegates' queues to prevent any deadlocks. Furthermore, in some embodiments, scheduling work from the available producers while the delegate threads are already saturated and busy doesn't result in any additional throughput and in fact might have adverse effects such as deprioritizing a round that was scheduled earlier and further increasing its latency. In some embodiments, to handle these two scenarios, the director module 2742 can handle the aforementioned two scenarios in scheduling work based on keeping track of how many producer threads currently exist and/or the average work queue depth of all of the non-producer thread.

As illustrated in the example of FIG. 27A, at a given time during execution of the respective segment generation operation, producer module 2743 generates work unit 2740.x for assignment to delegate module 2740.a (e.g. based on delegate module 2740.a being designated for the respective type of work unit, for example, based on being configured to process a respective column corresponding to the work unit 2740.x and/or based on being configured to process a type of task, such as column slab generation vs. secondary index generation vs. statistics data generation corresponding to the work unit 2740.x), and similarly generates work units 2740.y and 2740.z for assignment to delegate modules 2740.b and 2740.c, respectively. These work units 2740 can be assigned and enqueued in respective queues 2747 based on accept function 2745 (e.g. accepto) and/or enqueue function 2746 (e.g. enqueue( )). At the given time illustrated in this example, delegate module 2744.a is already active on thread 2741.1 (e.g. based on not having an empty queue and currently executing a previously enqueued work item 2740 via thread 2741.1) and delegate module 2744.b is similarly already active on thread 2741.2, where each of these delegate modules will optionally continue executing enqueued work items 2740 in their respective queues 2747, including the newly assigned work items 2740.x and 2740.y, respectively, until their queue 2747 is empty and they become inactive (e.g. freeing the respective thread 2741 for use by another delegate module 2744, such as a first delegate module 2744 in delegate queue 2748, for example, based becoming idle and responding to signal 2749 while idle). At the given time illustrated in this example, delegate module 2744.c is inactive, and is enqueued to delegate queue 2748 via enqueue function 2751 (e.g. in response to the accept function 2745 being performed in response to assignment of work unit 2740.z). Once director module 2742 assigns delegate module 2744.c to a respective thread 2741 (e.g. a thread responds to signal 2749 once idle), the delegate module 2744.c can execute work item 2740.z and/or any other enqueued work units 2740 that were enqueued to their queue 2747.c while awaiting activation via a corresponding thread (e.g. due to being assigned further work units waiting in delegate queue 2748 behind other enqueued delegate modules that were enqueued previously).

FIG. 27B illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 27B, for example, based on participating in execution of a loading operation or other operation being executed by the database system 10. Some or all of the method of FIG. 27B can be performed by nodes executing a loading operation, for example, via one or more nodes 37 implemented as loading modules 2510. In some embodiments, a node 37 can implement some or all of FIG. 27B based on implementing a corresponding plurality of processing core resources 48.1-48.W. Some or all of the steps of FIG. 27B can optionally be performed by any other one or more processing modules of the database system 10.

Some or all steps of FIG. 27B can be performed in parallel and/or concurrently via a plurality of parallelized processing resources (e.g. implemented via a plurality of nodes 37 and/or a plurality of processing core resources 48). For example, multiple instances of any given step of FIG. 27B can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of FIG. 27B can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step.

Some or all of the steps of FIG. 27B can be performed to implement some or all of the functionality of the database system 10 as described in conjunction with FIGS. 27B, for example, by implementing some or all of the functionality of director module 2742, producer module 2743, and/or one or more delegate modules 2744. Some or all steps of FIG. 27B can be performed by database system 10 in accordance with other embodiments of the database system 10 and/or nodes 37 discussed herein. Some or all of the steps of FIG. 27B can be performed in conjunction with performing some or all steps of any other method described herein.

Step 2782 includes identifying a plurality of pages to undergo a segment generation operation. Step 2784 includes executing the single segment generation operation to generate a single segment from the plurality of pages.

Performing step 2784 can include performing step 2786. 2788, and/or 2790. Step 2786 includes generating, via a director module, a plurality of parallelized threads for generating the single segment from the plurality of pages. Step 2788 includes generating, via a producer module implemented based on utilizing a first parallelized thread of the plurality of parallelized threads, a plurality of work units assigned to a plurality of delegate modules for processing. Step 2790 includes processing, via each of the plurality of delegate modules while utilizing a corresponding parallelized thread of a subset of parallelized threads of the plurality of parallelized threads, a corresponding subset of work units of the plurality of work units assigned to the each of the plurality of delegate modules.

In various examples, the single segment is generated from the plurality of pages based on processing of plurality of work units via the plurality of delegate modules.

In various examples, the segment generation operation is executed via a loading module that includes a central processing unit that includes a plurality of processing core resources. In various examples, each of the plurality of parallelized threads is implemented via one of the plurality of processing core resources.

In various examples, the plurality of parallelized threads includes a selected number of threads that is less than or equal to a number of available processing core resources of the plurality of processing core resources of the loading module.

In various examples, a plurality of loading modules each execute a corresponding segment generation operation upon a corresponding page batch partition of a plurality of page batch partitions of a corresponding page batch. In various examples, the loading module is one of the plurality of loading modules. In various examples, the plurality of pages are included in one of the plurality of page batch partitions.

In various examples, the plurality of pages include a plurality of rows. In various examples, generating the single segment from the plurality of pages includes generating a plurality of column slabs of the single segment corresponding to a plurality of columns of a relational database table. In various examples, each of the plurality of column slabs is generated to include, for each of the plurality of rows, column values for a corresponding column of the plurality of columns. In various examples, a corresponding column slab of the plurality of column slabs is generated for each of the plurality of columns.

In various examples, generating the single segment from the plurality of pages includes generating a set of secondary indexes. In various examples, each of the set of secondary indexes is generated for a corresponding column of the plurality of columns. In various examples, a corresponding secondary index of the set of secondary indexes is generated for at least one of the plurality of columns. In various examples, some or all of the plurality of columns do not have corresponding secondary indexes generated, where only a proper subset of the plurality of columns have corresponding secondary indexes generated.

In various examples, generating the single segment from the plurality of pages includes generating a plurality of statistics data. In various examples, each statistics data of the plurality of statistics data is generated for a corresponding one of the plurality of columns. In various examples, corresponding statistics data of the plurality of statistics data is generated for the each of the plurality of columns;

In various examples, the plurality of work units generated by the producer module includes a plurality of column slab work units, a plurality of secondary index work units, and/or a plurality of statistics work units. In various examples, the plurality of column slabs is generated based on processing of the plurality of column slab work units via a first subset of the plurality of delegate modules. In various examples, the set of secondary indexes is generated based on processing of the plurality of secondary index work units via a second subset of the plurality of delegate modules. In various examples, the plurality of statistics data is generated based on processing of the plurality of statistics work units via a third subset of the plurality of delegate modules.

In various examples, at least one delegate module of the plurality of delegate modules is included in at least two of: the first subset of the plurality of delegate modules, the second subset of the plurality of delegate modules, or the third subset of the plurality of delegate modules.

In various examples, every delegate module of the plurality of delegate modules is included in exactly one of: the first subset of the plurality of delegate modules, the second subset of the plurality of delegate modules, or the third subset of the plurality of delegate modules.

In various examples, a number of delegate modules in the plurality of delegate modules is based on at least one of: a total number of columns in the plurality of columns, and a number of columns in a subset of columns of the plurality of columns for which secondary indexes are generated.

In various examples, the plurality of delegate modules includes a plurality of per-column column slab delegate modules, a plurality of per-column secondary index delegate modules, and/or a plurality of per-column statistics delegate modules. In various examples, each of the plurality of per-column column slab delegate modules is assigned to process column slab work units for one corresponding column of the plurality of columns. In various examples, each of the plurality of per-column secondary index delegate modules is assigned to process secondary index work units for one corresponding column of the subset of columns of the plurality of columns. In various examples, each of the plurality of per-column statistics delegate modules is assigned to process statistics work units for one corresponding column of the plurality of columns.

In various examples, each of the plurality of columns has: exactly one corresponding per-column column slab delegate module, exactly one corresponding per-column statistics delegate module, and/or up to one corresponding secondary index module (e.g. depending on whether a corresponding secondary index is generated for the given column).

In various examples, each of the plurality of columns has: multiple corresponding per-column column slab delegate modules, multiple corresponding per-column statistics delegate modules, and/or, if a corresponding secondary index is generated for the given column, multiple corresponding secondary index modules.

In various examples, executing the segment generation operation to generate the single segment from the plurality of pages is further based on assigning, by the director module, the plurality of delegate modules to corresponding ones of the plurality of parallelized threads during performance of the segment generation operation. In various examples, each delegate module processes the corresponding subset of work units of the plurality of work units via assignment to at least one of the plurality of parallelized threads during the performance of the segment generation operation.

In various examples, the each delegate module processes the corresponding subset of work units of the plurality of work units via processing a plurality of subsets of the corresponding subset of work units during a corresponding plurality of time frames during the performance of the segment generation operation based on processing each subset of the plurality of subsets of the corresponding subset of work units via utilizing a corresponding parallelized thread of the plurality of parallelized threads to which the each delegate module is assigned at a start of a corresponding time frame of the corresponding plurality of time frames. In various examples, at least one delegate module processes different ones of their corresponding subset of work units via different ones of the subset of parallelized threads during different non-overlapping time frames.

In various examples, a number of delegate modules of the plurality of delegate modules is strictly greater than a number of threads in the plurality of parallelized threads. In various examples, each of the subset of the plurality of parallelized threads is utilized by up to one delegate module of the plurality of delegate modules at a time.

In various examples, at a given time during execution of the segment generation operation, each of a first subset of the plurality of delegate modules are actively processing corresponding work units via a corresponding one of the plurality of parallelized threads. In various examples, a second subset of the plurality of delegate modules are inactive based on all of the subset of the plurality of parallelized threads being utilized by the first subset of the plurality of delegate modules.

In various examples, one parallelized thread of the subset of parallelized threads is utilized via a first delegate module of the plurality of delegate modules during a first temporal period during execution of the segment generation operation. In various examples, the one parallelized thread of the subset of parallelized threads is utilized via a second delegate module of the plurality of delegate modules during a second temporal period after the first temporal period during execution of the segment generation operation.

In various examples, each of the plurality of delegate modules has a corresponding queue of assigned work units pending processing. In various examples, each work unit generated by the producer module is added to the corresponding queue for a corresponding one of the plurality of delegate modules to which the each work unit is assigned. In various examples, utilization of one parallelized thread by a first delegate module finishes at a corresponding time based on the first delegate module completing processing of a corresponding work unit and based on a first queue of assigned work units for the first delegate module being empty. In various examples, utilization of the one parallelized thread by a second delegate module begins at the corresponding time based on the second delegate module having second queue of assigned work units that is non-empty and further based on the second delegate module being inactive prior to the corresponding time.

In various examples, the director module maintains a queue of inactive delegate modules awaiting assignment to threads of the subset of parallelized threads. In various examples, the subset includes the second subset of the plurality of delegate modules at the given time.

In various examples, the first parallelized thread is distinct from the subset of parallelized threads. In various examples, a set difference between threads of the plurality of parallelized threads and a set union of threads included in the first parallelized thread and the subset of parallelized threads includes at least one additional thread implemented for deadlock prevention.

In various examples, the producer module is one of a plurality of producer modules that each generate a corresponding plurality of work units assigned to a corresponding plurality of delegate modules for processing, wherein each producer module of the plurality of producer modules utilizes a corresponding parallelized thread of the plurality of parallelized threads.

In various examples, the method further includes performing a segment grouping operation and a segment transfer operation to generate and store a plurality of segments from the single segment.

In various examples, the segment generation operation is performed in conjunction with performing one of a plurality of page conversion processes. In various examples, the method further includes generating a plurality of scheduling data for performing the plurality of page conversions processes. In various examples, generating corresponding scheduling data of the plurality of scheduling data for each page conversion process of the plurality of page conversion processes is based on automatically selecting at least one of a plurality of page buckets to have corresponding pages included in a corresponding page batch as a function of a set of page conversion parameters that includes: a segment generation timeout parameter, a minimum batch size parameter, and/or a page batch memory budget parameter. In various examples, the method further includes performing the each of the plurality of page conversion processes to generate a corresponding set of segments of a plurality of sets of segments for long term storage from the corresponding page batch selected for the each of the plurality of page conversion processes.

corresponding page batch selected for the each of the plurality of page conversion processes.

In various examples, the method further includes storing a set of segments containing a plurality of rows of at least one relational database table via a disk memory resources of a plurality of nodes of a database system. In various examples, the at least one of the set of segments is generated based on performing a segment grouping process upon the single segment. In various examples, the method further includes: generating a tree topology for a segment directory group that includes the set of segments, where a plurality of leaf tree nodes of the tree topology correspond to the set of segments; storing a set of files for the segment directory group in the disk memory resources, where each file of the set of files corresponds to a corresponding tree node of a set of internal tree nodes of the tree topology, and/or where the each file indicates a corresponding set of memory locations in the disk memory resources each storing data corresponding to a corresponding child tree node of a set of child tree nodes of the corresponding tree node in the tree topology; and storing root tree node data for a root tree node of the of the tree topology as state data maintained via a consensus protocol mediated via the plurality of nodes, where the root tree node data includes a set of memory locations for a subset of the set of files corresponding to child tree nodes of the root tree node in the tree topology.

In various examples, the segment directory group includes a plurality of segment directories. In various examples, each directory of the plurality of segment directories contains directory metadata indicating, for each child tree node of a set of child tree nodes of the tree topology: a storage identifier for the child tree node and an owner field for the each child tree node. In various examples, the method further includes accessing the set of segments and the set of files of the tree topology based on: when a root directory owner field for the segment directory group has one of: and unowned value or the value of the owner field, applying a first owned storage identifier indicated by the storage identifier and a value of the owner field; and/or when a root directory owner field for the segment directory group has one another value different from the value of the owner field, applying a second owned storage identifier indicated by the storage identifier and the another value of the root directory owner field.

In various embodiments, any one of more of the various examples listed above are implemented in conjunction with performing some or all steps of FIG. 27B. In various embodiments, any set of the various examples listed above can be implemented in tandem, for example, in conjunction with performing some or all steps of FIG. 27B, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 27B described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 27B, for example, in conjunction with further implementing any one or more of the various examples described above.

In various embodiments, the operational instructions, when executed by the at least one processor, cause the database system to: identify a plurality of pages to undergo a segment generation operation and/or execute the segment generation operation to generate a single segment from the plurality of pages based on: generating, via a director module, a plurality of parallelized threads for generating the single segment from the plurality of pages; generating, via a producer module implemented based on utilizing a first parallelized thread of the plurality of parallelized threads, a plurality of work units assigned to a plurality of delegate modules for processing; and/or processing, via each of the plurality of delegate modules while utilizing a corresponding parallelized thread of a subset of parallelized threads of the plurality of parallelized threads, a corresponding subset of work units of the plurality of work units assigned to the each of the plurality of delegate modules. In various examples, the single segment is generated from the plurality of pages based on processing of plurality of work units via the plurality of delegate modules.

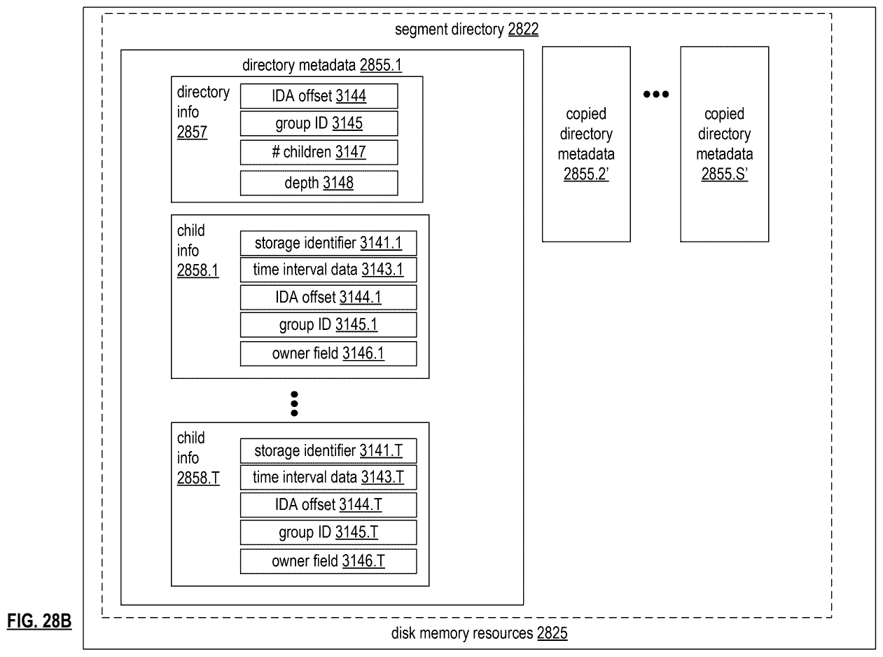

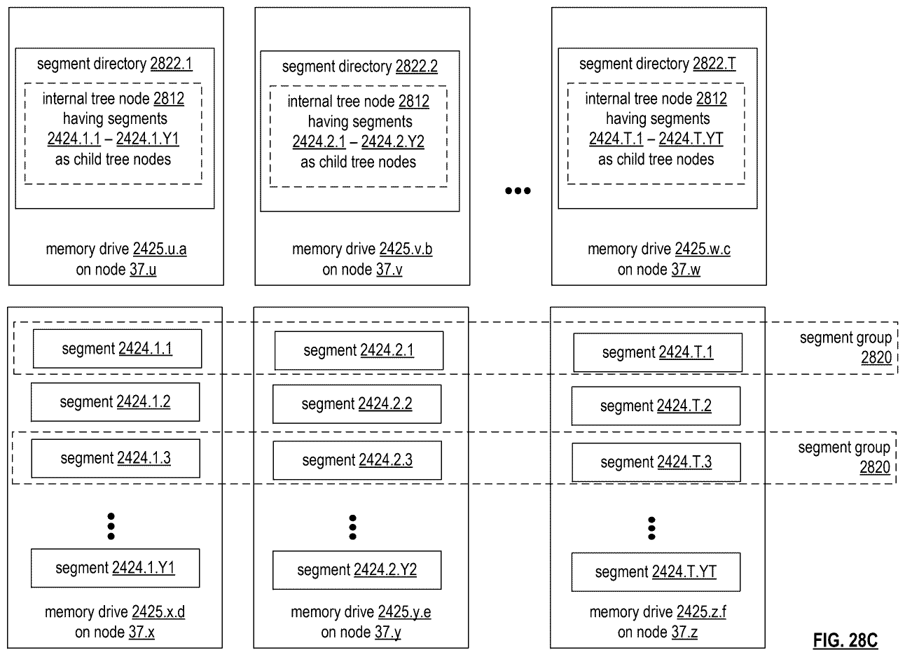

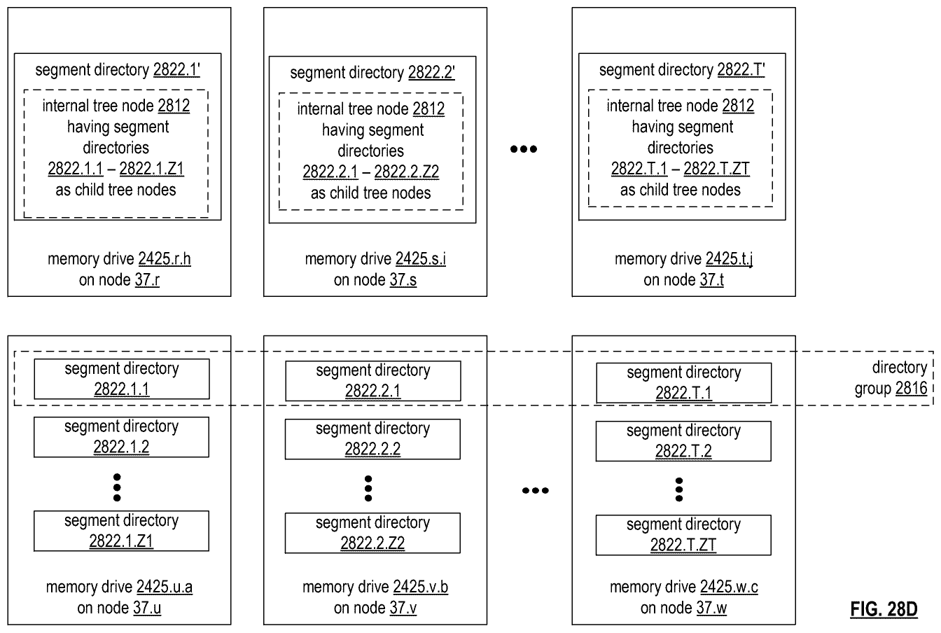

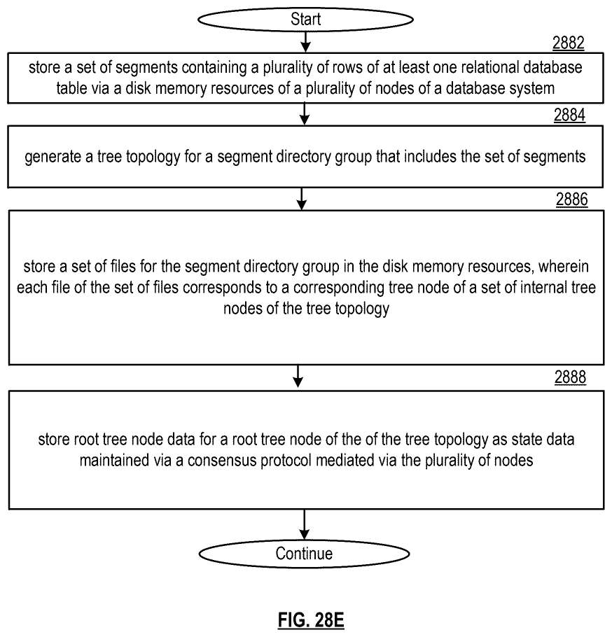

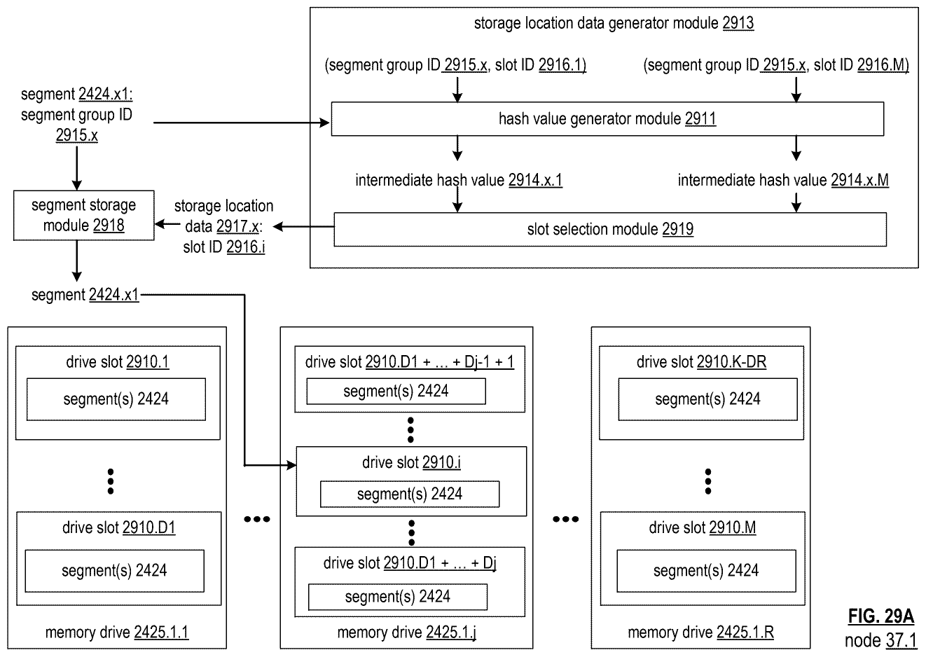

FIGS. 28A-31F present embodiments of database system 10 that stores segments in accordance with a corresponding segment directory group. Some or all features and/or functionality of FIGS. 28A-31F can be utilized to implement one or more nodes 37 of one or more computing devices 18 implementing database system 10. Some or all features and/or functionality of FIG. 28A can be utilized to implement any embodiment of database system 10 described herein.

In some embodiments, as more and more data is loaded (e.g. into a storage cluster 2535) of a database system 10, corresponding state data (e.g. of the storage cluster's Raft consensus state) can bloat in size, as it needs to track more and more objects. This can cause certain operations to become slow (e.g. due to linear or quadratic traversals), and/or can generally reduce stability (e.g. due to storage cluster nodes sending larger and an increased number of network messages, taking more time to process larger numbers of Raft mutations, etc.).

FIGS. 28A-28C illustrate embodiment that present improvements to the technology of database systems by presenting a solution to this scalability problem via implementing a segment directory group 2815.

As illustrated in FIG. 28A, a segment directory group 2815 can be implemented via a tree topology 2881 that includes a plurality of tree nodes 2810 (e.g. as a balanced maximum h height tree, where h is a configurable maximum height, for example, via user input). The state data 3105 for the storage cluster consensus state optionally only stores data for only a root tree node 2811 of this tree. Each internal tree node 2812 (e.g. non-leaf node of the tree) can be represented by a set of one or more files stored on disk in disk memory resources 2825 of database system 10 (e.g. in corresponding disk drives 2425 of nodes 37 of the corresponding storage cluster 2535), each containing metadata and a list of the file locations 2805 of child leaf nodes 2810, such as further segment directories (e.g. represented as further files 2806 for respective tree nodes 2810) and/or leaf segment groups. The leaf tree nodes 2813 of the tree can represent the physical segments 2424 that live on disk in disk memory resources 2825 of database system 10 (e.g. in corresponding disk drives 2425 of nodes 37 of the corresponding storage cluster 2535). In some embodiments, from the consensus state's point of view, a segment directory group 2815 is tracked and/or behaves in a same or similar way that a segment group is tracked/behaves.

Such embodiments of implementing a segment directory group can improve the technology of database system based on solving the scalability problem, for example, because orders of magnitudes of metadata can be moved out of the consensus state and onto disk storage. Alternatively or in addition, the recursive nature of segment directories can allow for minimizing of rewriting already-written data to mitigate storage media lifetime impact, as well as preserving IO bandwidth at directory creation time for more important tasks like querying and loading.

FIG. 28B illustrates an embodiment of a segment directory 2822 included in a segment directory group 2815.

In some embodiments, a segment directory 2822 can represent the path of directories local to one node in a segment directory group. For example, conceptually, this represents the set of segments living on a specific drive and a specific node that belong to the segment directory group. A segment directory group 2815 can include a corresponding set of segment directories, for example, as children or descendants of the root tree node 2811. For example, a given internal tree node 2812 optionally indicates one or more segment directories 2822, which can in turn indicate child tree nodes 2810 of this internal tree node 2812 corresponding to further segment directories 2822 or segments 2424.

In some embodiments, the on-disk representation of a segment directory 2822 contains directory metadata 2855 for a corresponding IDA offset as well as copy-replicated directory metadata 2855′ for other IDA offsets (e.g. S minus 1 other offsets) in the directory group. The value of S can be the same or different as the value of T.

For example, the IDA offset of a segment directory can identify the logical “segment directory” entity and has no relation to the IDA offsets of subsumed children. In addition, the IDA offsets of subsumed children can be different and are unrelated to each other. Note that this means a rebuild of one subsumed child may use a different set of nodes as a rebuild of another subsumed child, even though they belong to the same segment directory.

The directory metadata for segment directory 2822 can store and/or otherwise indicate: directory information 2857 for the segment directory 2822 itself; and/or a set of child information 2858.1-2858.T for a corresponding set of T children.

The directory information 2857 can include and/or otherwise indicate:); at least one group ID 3145 and/or at least one IDA offset 3144 (e.g. the logical segment identifiers for example, for a corresponding tree node 2810 corresponding to the segment directory 2822, which can optionally be used for determining rebuild plans); a value (e.g. T) indicating a number of children 3147; and/or a depth 3148 (e.g. depth in corresponding tree topology 2881).

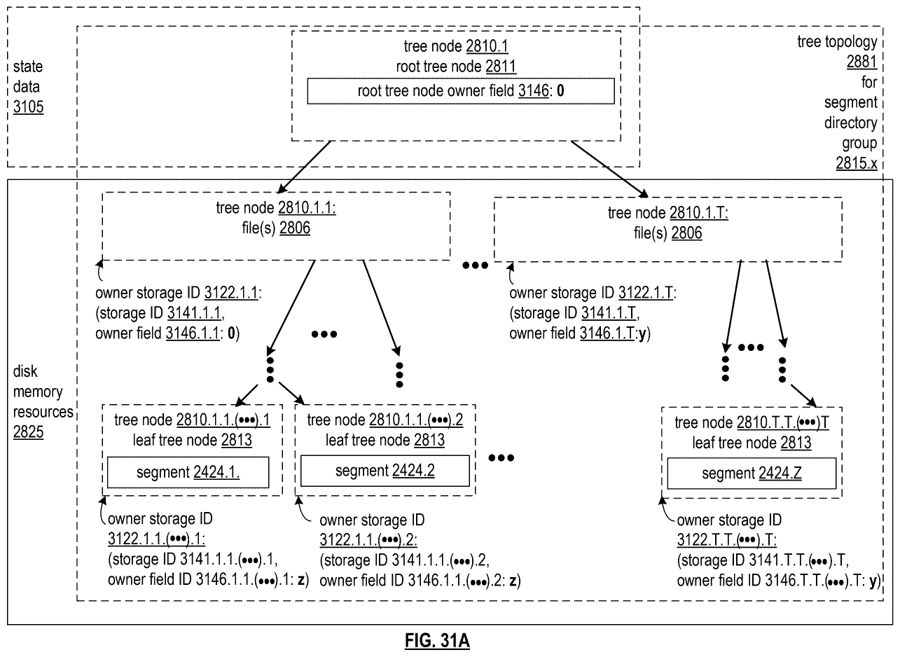

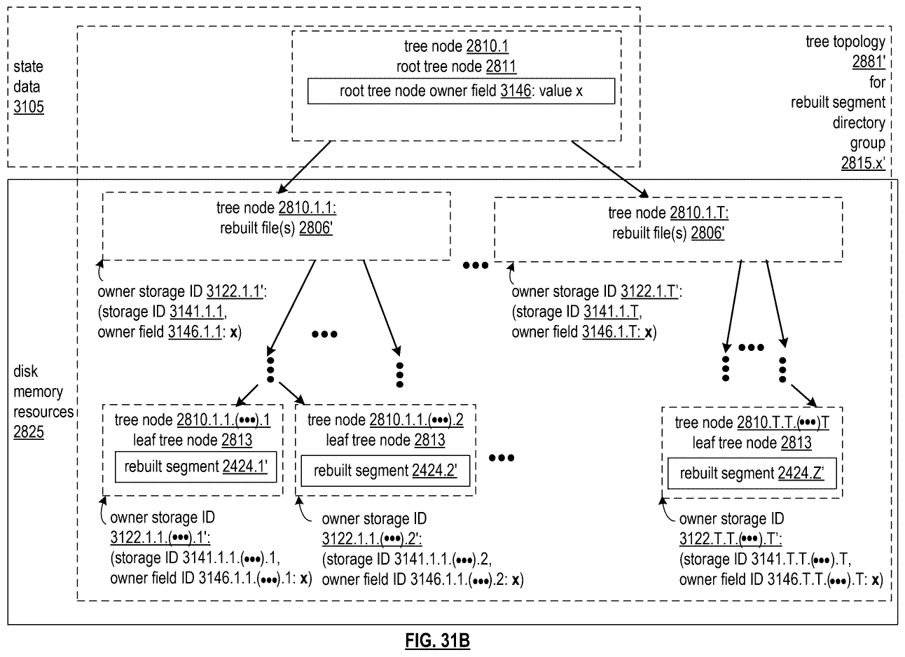

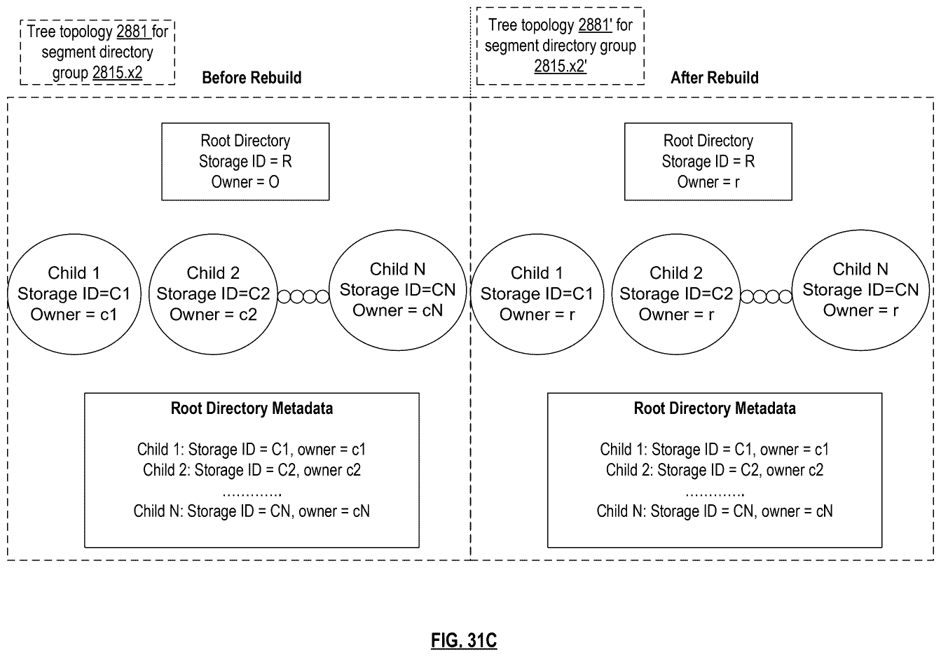

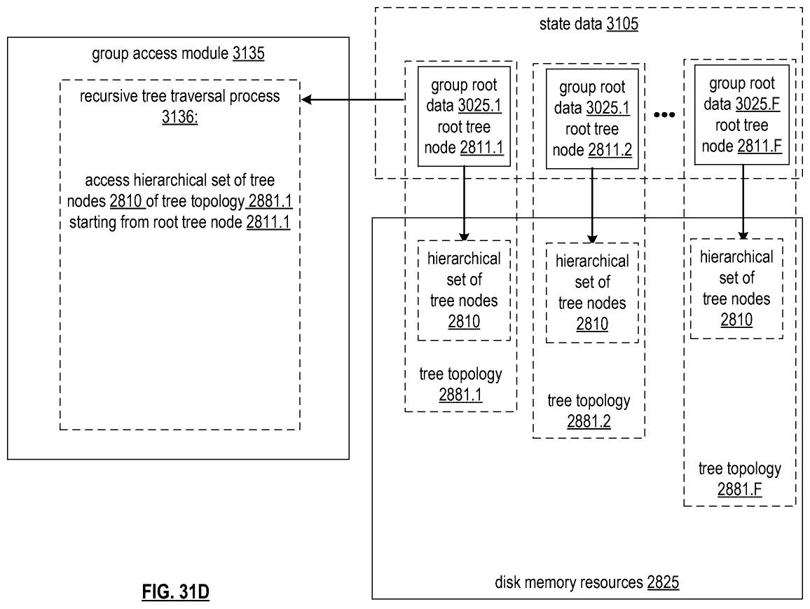

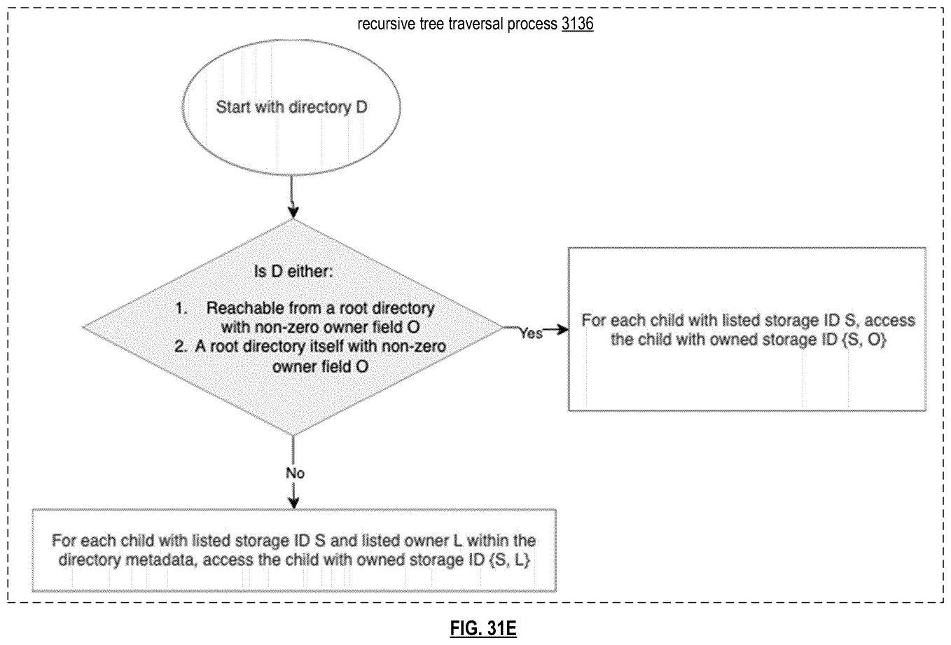

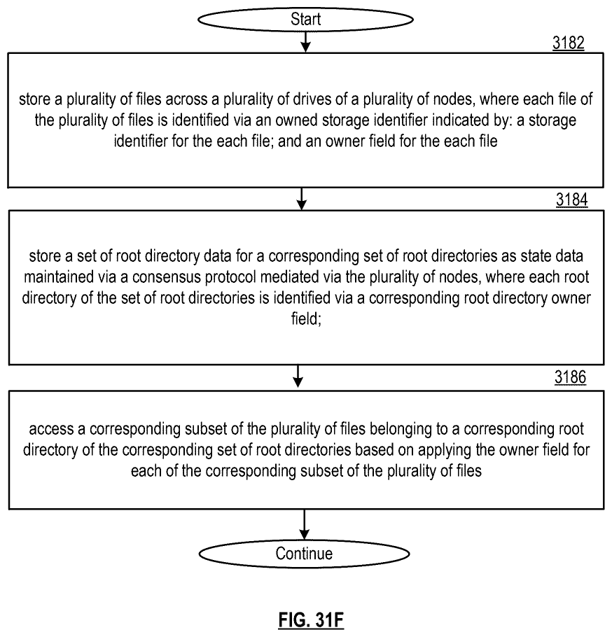

Each child information 2858 can indicate, for a corresponding child, a storage identifier 3141 (e.g. the file name, for example, in which a corresponding child tree node 2810 corresponding to the segment directory 2822 is stored); time interval data 3143 (e.g. time column values for subsumed children, used for more efficient filtering at query time); at least one group ID 3145 and/or at least one IDA offset 3144 (e.g. the logical segment identifiers for example, for a corresponding child tree node 2810 of the segment directory 2822, which can optionally be used for determining rebuild plans); and/or an owner field 3146 (e.g. identifying the owner of the storage identifier 3141 of the child, if owned, used to differentiate between multiple versions of this child, for example, as discussed in conjunction with FIGS. 31A-31E).

In some embodiments, a segment directory 2822 is represented on disk as a combination of serialized C++ structs and protobuf. The on-disk representation can contain the directory metadata for a single IDA offset as well as copy replicated directory metadata for other IDA offsets in the directory group (e.g. according to a static hash function in state::getReplicasIdaOffsets( )), and/or then a table of contents part footer.

An IDA offset 3144 (e.g. “idaOffset”) of directory metadata 2822 (e.g. “directoryMetadata”) can identifies the logical “segment” in the segment directory group. The idaOffset of the children can be different and/or can be totally unrelated to each other. Time interval data 3143 (e.g. “timeRanges”) of each child can be stored to allow for better query performance to easily determine the set of segments that should be involved in a query without unraveling/traversing the entire directory structure.

In some embodiments, a given directory 2822 can be stored on disk via an on disk structure that includes a header, uint64 length-prefixed segmentDirectoryInfo, and/or Consecutive uint64 length-prefixed segmentDirectoryChildInfo. For example, given directory 2822 can be stored on disk via an on disk structure implementing some or all of the following structuring:

```
struct _{——}attribute_{——}((packed)) directoryMetadataHeader_t {
  static constexpr uint64_t MAGIC = 0x686966696E6C6579;
  directoryMetadataHeader_t( ) {
    std::memset(&_{——}unused, 0, sizeof(_{——}unused));
  }
  uint64_t magic = MAGIC;
  uint32_t version = 0;
  uint8_t_{——}unused[12]; // optionally unused, set to zero − padding + reserved bits
  };
message segmentDirectoryChildInfo {
  bytes storage_id = 1;
  uint64 max_time = 2;
  uint64 min_time = 3;
  uint64 segment_group_id = 4;
  uint32 ida_offset = 5;
  bytes owner_storage_id = 6;
}
message segmentDirectoryInfo {
  uint64 directory_group_id = 1;
  uint32 ida_offset = 2;
  uint64 num_children = 3;
  uint32 depth = 4;
}
```

In some embodiments, in the consensus state in state data 3105, a corresponding root tree node 2811 is represented as a corresponding group object (e.g. “rebuildableSegmentGroup_t” object). A uint8_t depth field can be included in the group object to represent the height of the segment directory group (e.g. its corresponding tree topology 2881). A group object can therefore can either be a) a regular segment group with depth=0, or b) a segment group directory with depth >=1. The group object can include an enum, for example, implemented via some or all of the following structuring:

```
enum removalType_e {
  NOT_REMOVED,
  TRUNCATED,
  SUBSUMED
}
```

For example, this field can be set upon marking a group object as having a finite end OSN. If the finite end OSN is due to a truncation, (e.g. the on-disk data is being removed completely from the system and storage should be cleaned up), then TRUNCATED can be used. If the finite end OSN is due to subsuming the underlying storage into a director (e.g. the on-disk data should not be removed completely and instead just the consensus state should be cleaned up), then SUBSUMED can be used. Upon reaping an OSN and cleaning up a segment group, this enum value can be checked. If it is SUBSUMED, then the stored segments can be removed immediately (e.g. without going through the local node's deletion process by setting the deletable flag). If it's TRUNCATED, then the stored segment can be marked as deletable and can be delegated to the local node to reap an OSN and/or clean up the underlying storage before removing the stored segment.

FIG. 28C illustrates an example embodiment of segments 2424 and segment directories 2822 stored in conjunction with a corresponding segment directory group 2815. A set of segment directories 2822.1-2822.T (e.g. optionally part of a same directory group) each indicate a set of segments 2424 stored on a given drive of a give node. Each segment directory 2822 can be stored as one or more corresponding files 2806 on the respective memory drive 2425.

In this example, segment directory 2822.1 is stored on drive 2425.u.a on node 37.u and indicates the set of segments 2424.1.1-2424.1.Y1 stored on memory drive 2425.x.d (e.g. in and/or mapped to its respective metadata 2855); segment directory 2822.2 is stored on drive 2425.v.b on node 37.v and indicate the set of segments 2424.2.1-2424.2.Y2 (e.g. Y2 is same or different number of segments from Y1) stored on memory drive 2425.y.e (e.g. in and/or mapped to its respective metadata 2855); and/or segment directory 2822.1 is stored on drive 2425.w.c on node 37.w and indicate the set of segments 2424.T.1-2424.T.YT (e.g. YT is same or different number of segments from Y1 and/or Y2) stored on memory drive 2425.z.f (e.g. in and/or mapped to its respective metadata 2855). The value of T of FIG. 28C can be the same or different as the value of T of FIG. 28A. The value of T of FIG. 28C can be the same or different as the value of S of FIG. 28B.

In this example, multiple segment groups 2820 optionally have their respective segments stored across a same set of memory drives 2425 (e.g. that include drive 2425.x.d on node 37.x, drive 2425.y.e on node 37.y, and/or drive 2425.z.f on node 37.z). However, not all segments 2424 on a given memory drive necessarily belong to segment groups stored across this given set of drives—others may belong to segment groups belonging to different drives (e.g. segment 2424.1.2 is part of a segment group that includes memory drive 2425.x.d, as well as a first set of other memory drives that don't include drives 2425.y.e or 2425.z.f, optionally on different nodes that don't include node 37.y or 37.z; segment 2424.2.2 is part of a different segment group that includes memory drive 2425.y.e, as well as a second set of other memory drives that don't include drives 2425.x.d or 2425.z.f, optionally on different nodes that don't include node 37.x or 37.z; etc.).

Each node 37 of FIG. 28C can have additional memory drives 2425 that optionally store their own segments 2424 and/or segment directories 2822. Each memory drive 2425 of FIG. 28C can optionally store additional information not indicated in the respective segment directory (e.g. in other locations of the drive, such as in other drive slots of the drive).

FIG. 28D illustrates an example embodiment segment directories 2822 stored in conjunction with a corresponding segment directory group 2815. Another set of segment directories 2822.1′-2822.T′ (e.g. optionally part of a same directory group) each indicate a set of segments directories 2822 stored on a given drive of a give node. Each segment directory 2822 can be stored as one or more files 2806 on the respective memory drive 2425. The number of segments in the other set of segments 2822.1′-2822.T′ of FIG. 28D can be the same or different from the number of segments in the set of segments 2822.1-2822.T of FIG. 28C.

In this example, segment directory 2822.1′ is stored on drive 2425.r.h on node 37.h and indicates the set of segment directories 2822.1.1-2822.1.Z1 stored on memory drive 2425.u.d (e.g. in and/or mapped to its respective metadata 2855); segment directory 2822.2′ is stored on drive 2425.s.i on node 37.v and indicate the set of segment directories 2822.2.1-2822.2.Z2 e.g. Z2 is same or different number of segment directories from Z1) stored on memory drive 2425.v.e (e.g. in and/or mapped to its respective metadata 2855); and/or segment directory 2822.T is stored on drive 2425.t.j on node 37.w and indicate the set of segment directories 2822.T.1-822.T.ZT (e.g. ZT is same or different number of segments from Z1 and/or Z2) stored on memory drive 2425.z.f (e.g. in and/or mapped to its respective metadata 2855).

In some embodiments, drive 2425.u.a on node 37.u, drive 2425.v.b on node 37.v, and/or drive 2425.w.c on node 37.w of FIG. 28D can correspond to drive 2425.u.a on node 37.u, drive 2425.v.b on node 37.v, and/or drive 2425.w.c on node 37.w of FIG. 28C. In particular, the segment directory 2822.1 of FIG. 28C is optionally one of the segment directories 2822.1.1-2822.1.Z1 stored in drive 2425.u.a on node 37.u of FIG. 28D, indicated as a child of segment directory 2822.1′ on memory drive 2425.r.h; segment directory 2822.2 of FIG. 28C is optionally one of the segment directories 2822.2.1-2822.2.Z2 stored in drive 2425.v.b on node 37.v of FIG. 28D, indicated as a child of segment directory 2822.2′ on memory drive 2425.s.i; and/or segment directory 2822.T of FIG. 28C is optionally one of the segment directories 2822.T.1-2822.T.ZT stored in drive 2425.v.b on node 37.v of FIG. 28D, indicated as a child of segment directory 2822.T′ on memory drive 2425.t.j.

In this example, one or more directory groups 2816 optionally have their respective segment directories stored across a same set of memory drives 2425 (e.g. that include drive 2425.u.a on node 37.u, drive 2425.v.b on node 37.v, and/or drive 2425.w.c on node 37.w). However, not all segment directories 2822 on a given memory drive necessarily belong to directory groups stored across this given set of drives—others may belong to directory groups belonging to different drives (e.g. segment directory 2822.1.2 is part of a segment group that includes memory drive 2425.u.a, as well as a first set of other memory drives that don't include drives 2425.v.b or 2425.w.c, optionally on different nodes that don't include node 37.v or 37.w; etc.).

Each node 37 of FIG. 28D can have additional memory drives 2425 that optionally store their own segments 2424 and/or segment directories 2822. Each memory drive 2425 of FIG. 28D can optionally store additional information not indicated in the respective segment directory (e.g. in other locations of the drive, such as in other drive slots of the drive).

In some embodiments, a directory group 2816 can be implemented in a same or similar fashion a segment directory group 2815, where directory group 2816 is optionally at a non-root level of tree topology 2881 (e.g. a segment directory group 2815 corresponds specifically to the root tree node of tree topology 2881, which may include multiple other segment directory groups 2816 at non-root levels of tree topology 2881). As used herein, a “segment directory group” can correspond to a segment directory group 2815 or a directory group 2816.

In some embodiments, a segment group 2820 can be implemented in a same or similar fashion as a segment directory group. For example, a given segment directory group 2815 is optionally a root tree node for a segment group 2820 of segments 2424, with no inner levels of directory groups 2816. As another example, a given directory group 2816 can be implemented in a same or similar fashion as a segment group 2820 (e.g. the only difference being that the segment group 2820 indicates a set of segments while the directory group 2816 indicates a set of directories due to being at a higher hierarchical level of tree topology 2881). As used herein a “segment directory group” or “directory group” can optionally correspond to, or be implemented in a same or similar fashion as, a segment group 2820. As used herein a “segment group” can optionally correspond to, or be implemented in a same or similar fashion as, a segment directory group 2815 and/or a directory group 2816.

FIG. 28E illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 28E, for example, based on participating in execution of a storage operation or other operation being executed by the database system 10. Some or all of the method of FIG. 28E can be performed by nodes participating in a storage cluster to store a plurality of segments. In some embodiments, a node 37 can implement some or all of FIG. 28E based on implementing a corresponding plurality of processing core resources 48.1-48.W. Some or all of the steps of FIG. 28E can optionally be performed by any other one or more processing modules of the database system 10.

Some or all steps of FIG. 28E can be performed in parallel and/or concurrently via a plurality of parallelized processing resources (e.g. implemented via a plurality of nodes 37 and/or a plurality of processing core resources 48). For example, multiple instances of any given step of FIG. 28E can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of FIG. 28E can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step.

Some or all of the steps of FIG. 28E can be performed to implement some or all of the functionality of the database system 10 as described in conjunction with FIGS. 28A-28D, for example, by implementing some or all of the functionality of memory drives 2425 of nodes 37 to store a segment directory group 2815. Some or all steps of FIG. 28E can be performed by database system 10 in accordance with other embodiments of the database system 10 and/or nodes 37 discussed herein. Some or all of the steps of FIG. 28E can be performed in conjunction with performing some or all steps of any other method described herein.

Step 2882 includes storing a set of segments containing a plurality of rows of at least one relational database table via a disk memory resources of a plurality of nodes of a database system. Step 2884 includes generating a tree topology for a segment directory group that includes the set of segments. In various examples, a plurality of leaf tree nodes of the tree topology correspond to the set of segments. Step 2886 includes storing a set of files for the segment directory group in the disk memory resources, wherein each file of the set of files corresponds to a corresponding tree node of a set of internal tree nodes of the tree topology. In various examples, the each file indicates a corresponding set of memory locations in the disk memory resources each storing data corresponding to a corresponding child tree node of a set of child tree nodes of the corresponding tree node in the tree topology. Step 2888 includes storing root tree node data for a root tree node of the of the tree topology as state data maintained via a consensus protocol mediated via the plurality of nodes. In various examples, the root tree node data includes a set of memory locations for a subset of the set of files corresponding to child tree nodes of the root tree node in the tree topology.

In various examples, for each segment of the set of segments, a corresponding file for a parent tree node of the set of internal tree nodes stores a corresponding memory location for the each segment as one of the set of memory locations stored in the corresponding file.

In various examples, the data, corresponding to the corresponding child tree node of the set of child tree node of the corresponding tree node in the tree topology and stored in a corresponding memory location of the set of memory locations indicated in the each file, corresponds to one of: a segment of the set of segments when the set of child tree nodes of the each tree node corresponds to a subset of segments of the set of segments; or another file of the set of files when the set of child tree nodes of the each tree node correspond to a subset of files of the set of files.

In various examples, the tree topology is generated as a balanced tree topology in accordance with a predetermined maximum height.

In various examples, the method further includes setting the predetermined maximum height as a user-configured value generated via user input.

In various examples, the segment directory group includes a plurality of segment directories. In various examples, each segment directory of the segment directory group contains a corresponding subset of segments of the set of segments stored on a corresponding node of the plurality of nodes.

In various examples, at least one file of the set of files indicates a corresponding segment directory of the plurality of segment directories for one corresponding node of the plurality of nodes indicating a path of directories local to the one corresponding node.

In various examples, a plurality of segment groups of the set of segments each contain a group of multiple segments included in the set of segments. In various examples, each segment group of the plurality of segment groups is generated in accordance with performing an information dispersal algorithm (IDA) in conjunction with applying a redundancy storage scheme enabling recovery of an unavailable segment in the each segment group via a subset of other segments in the each segment group. In various examples, each segment in the each segment group has a corresponding one of a plurality of IDA offsets. In various examples, the each segment directory in the segment directory group has a corresponding one of the plurality of IDA offsets.

In various examples, the each segment directory contains: directory metadata for the corresponding one of the plurality of IDA offsets; and/or copy-replicated directory metadata for other ones of the plurality of IDA offsets in the segment directory group. In various examples, the directory metadata is stored in a corresponding file of the set of files for a corresponding parent tree node of a tree node corresponding to the segment directory.

In various examples, the directory metadata stores (e.g. for each child tree node of a set of child tree nodes), at least one of: a storage identifier indicating a file name of a corresponding file of the set of files stored for the child tree node; a group identifier for a corresponding group in which the corresponding file belongs; and/or one of the plurality of IDA offsets corresponding to the child tree node.

In various examples, at least one relational database table for which segments store corresponding rows includes a time column. the directory metadata further stores (e.g. for each child tree node of a set of child tree nodes): a minimum time column value of time column values of the time column stored across the corresponding subset of segments included in the each segment directory; and/or a maximum time column value of the time column values of the time column stored across the corresponding subset of segments included in the each segment directory.

In various examples, the directory metadata further stores an owner field for the storage identifier of the each child tree node.

In various examples, the method further includes accessing the set of segments and the set of files of the tree topology based on: when a root directory owner field for the segment directory group has one of: an unowned value or the value of the owner field, applying a first owned storage identifier indicated by the storage identifier and a value of the owner field; and/or when a root directory owner field for the segment directory group has one another value different from the value of the owner field, applying a second owned storage identifier indicated by the storage identifier and the another value of the root directory owner field.

In various examples, the disk memory resources of the plurality of nodes include a plurality of sets of drives of the plurality of nodes. In various examples, each node of the set of nodes includes a corresponding set of drives of the plurality of sets of drives. In various examples, the corresponding set of memory locations indicates locations upon drives of the plurality of sets of drives. In various examples, the drives are each partitioned into a plurality of drive slots, and wherein the corresponding set of memory locations corresponds to drive slots in the drives of the plurality of sets of drives.

In various examples, the method further includes generating the set of segments based on performing a plurality of page conversion processes. In various examples, performing one of the plurality of page conversion processes includes: executing a segment generation operation to generate a single segment and/or executing a segment grouping process and a segment transfer process upon the single segment to generate at least some of the set of segments from the single segment. In various examples, executing the segment generation operation to generate the single segment is based on: generating, via a director module, a plurality of parallelized threads for generating the single segment; generating, via a producer module implemented based on utilizing a first parallelized thread of the plurality of parallelized threads, a plurality of work units assigned to a plurality of delegate modules for processing; and/or processing, via each of the plurality of delegate modules while utilizing a corresponding parallelized thread of a subset of parallelized threads of the plurality of parallelized threads, a corresponding subset of work units of the plurality of work units assigned to the each of the plurality of delegate modules. In various examples.

In various examples, the method further includes generating the set of segments based on performing a plurality of page conversion processes. In various examples, performing the plurality of page conversion processes is based on generating a plurality of scheduling data for performing the plurality of page conversions processes. In various examples, generating corresponding scheduling data of the plurality of scheduling data for each page conversion process of the plurality of page conversion processes is based on automatically selecting at least one of a plurality of page buckets to have corresponding pages included in a corresponding page batch as a function of a set of page conversion parameters that includes: a segment generation timeout parameter, a minimum batch size parameter, and a page batch memory budget parameter. In various examples, the each of the plurality of page conversion processes is performed to generate a corresponding set of segments of a plurality of sets of segments for long term storage from the corresponding page batch selected for the each of the plurality of page conversion processes.

In various embodiments, any one of more of the various examples listed above are implemented in conjunction with performing some or all steps of FIG. 28E. In various embodiments, any set of the various examples listed above can be implemented in tandem, for example, in conjunction with performing some or all steps of FIG. 28E, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 28E described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 28E, for example, in conjunction with further implementing any one or more of the various examples described above.

In various embodiments, the operational instructions, when executed by the at least one processor, cause the database system to: store a set of segments containing a plurality of rows of at least one relational database table via a disk memory resources of a plurality of nodes of a database system; generate a tree topology for a segment directory group that includes the set of segments, where a plurality of leaf tree nodes of the tree topology correspond to the set of segments; store a set of files for the segment directory group in the disk memory resources, where each file of the set of files corresponds to a corresponding tree node of a set of internal tree nodes of the tree topology, wherein the each file indicates a corresponding set of memory locations in the disk memory resources each storing data corresponding to a corresponding child tree node of a set of child tree nodes of the corresponding tree node in the tree topology; and/or store root tree node data for a root tree node of the of the tree topology as state data maintained via a consensus protocol mediated via the plurality of nodes, where the root tree node data indicates a set of memory locations for a subset of the set of files corresponding to child tree nodes of the root tree node in the tree topology.

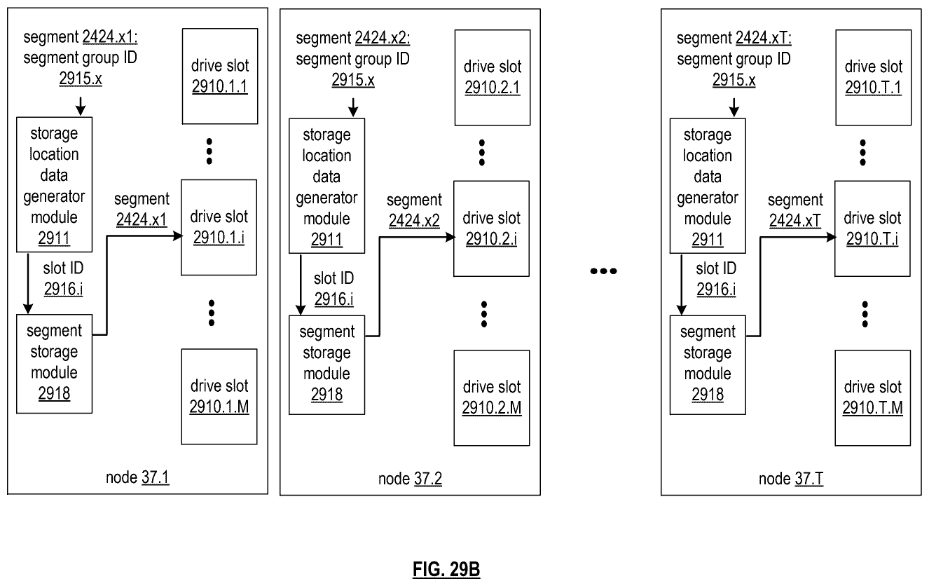

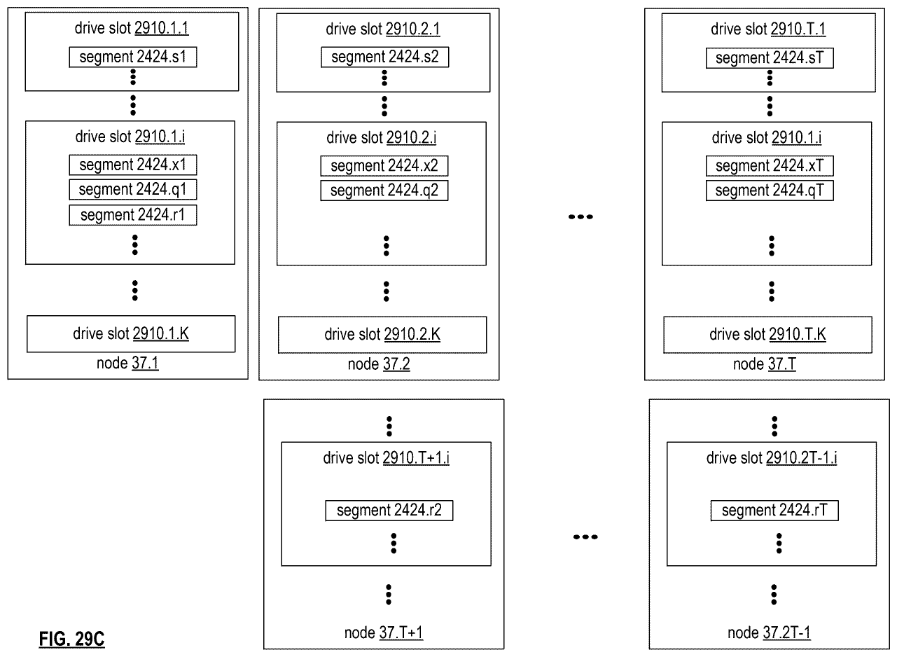

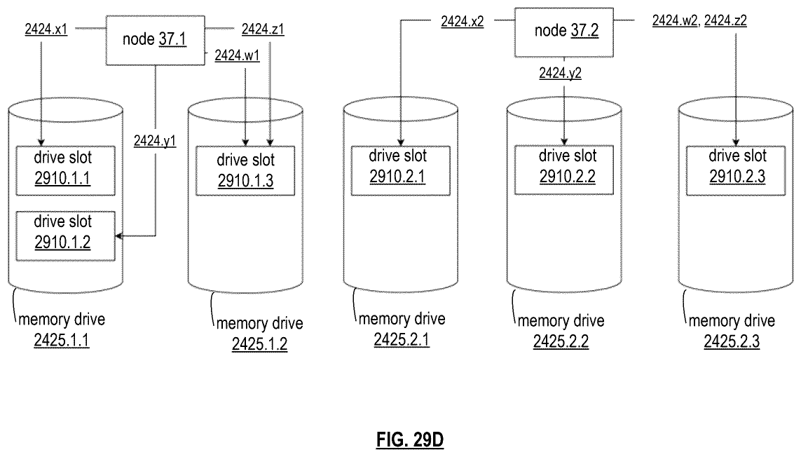

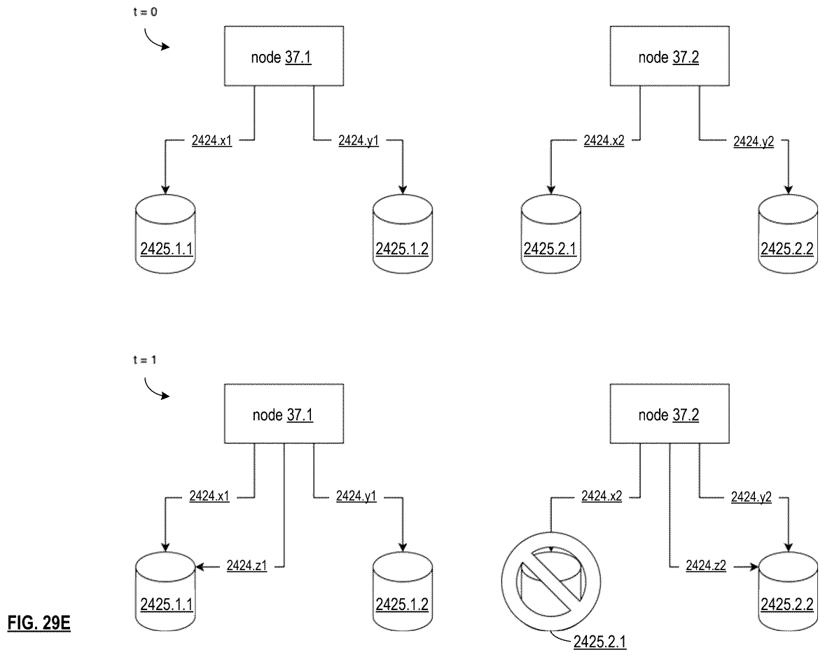

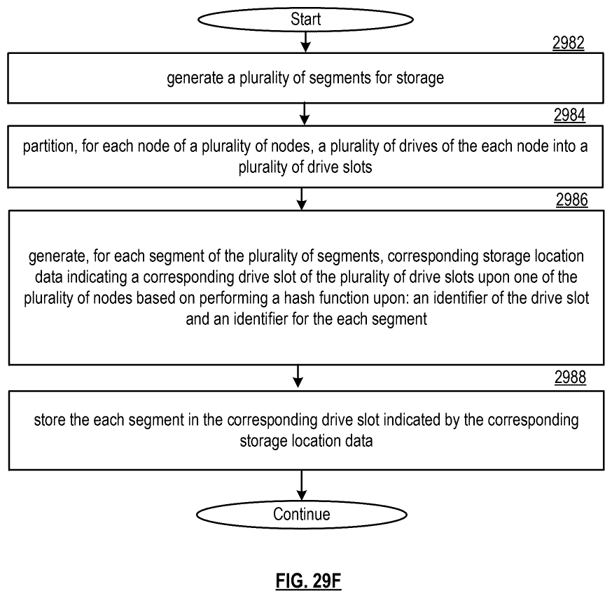

FIGS. 29A-29E illustrate embodiments of database system 10 where segments are assigned to drive slots 2910 of nodes 37 for storage in accordance with applying a deterministic function (e.g. hashing function implemented via a rendezvous hashing scheme), where this same function is applied across nodes to render different segments in a same segment group being assigned to same drive slots of different corresponding nodes.

In some embodiments, segments of a segment group are placed randomly across drives across nodes (and/or are placed based on factors such as drive utilization at a given time which is optionally renders non-deterministic placement over time as such factors change) which can result in suboptimal failure tolerance. For example, at scale on a cluster that can tolerate K drive outages, if one single drive fails on K nodes, it is likely that some data loss occurs. In other words, given some random set of K drives across K nodes on a cluster with far more than 1 segment groups (e.g. thousands, tens of thousands, millions, of segment groups), it's likely that at least one segment group has segments stored on each of the K drives. This can result in an availability tolerance where the cluster can tolerate K node outages, where a node outage is defined as one or more drive failures on a given node.

FIGS. 29A-29E present embodiments that improve the technology of database systems based on presenting solutions to such problems. In particular, a drive hashing scheme can be imposed that segment groups are allocated across drives/nodes in a cluster in a deterministic manner. Drives on a node can be partitioned into a plurality of drive slots 2910.1-2910.M (e.g. all nodes have a same number M of drive slots 2910), and segment groups can be sharded into specific drive slots such that all segments in a group will be almost guaranteed to reside on the same set of drives across each node that stores the segment group.

This can solve the fate-sharing problem, for example, because a data loss failure can only occur if all K drive failures belong to the same drive slot. Even though all segment groups stored on each of the K drives will have data loss, the number of combinations of K drives that result in non-zero data loss can be drastically reduced. In particular, fault tolerance is rendered on the unit of drives (e.g. more specifically, slots), instead of by node.

This strategy can further render more efficient combining of segment groups (e.g. given a set of nodes, all segments in a group will be more likely—almost guaranteed—to reside on the same set of drives as another set of segments in a different group). This can allow for more efficient merging of segment groups (e.g. into same segment directory groups 2815) as discussed in further detail herein.

In some embodiments, a total drive slot count M per node is defined (e.g. at storage cluster creation time), and/or this total count M is stored in metadata. In some embodiments, a drive slot cannot be partitioned across multiple drives. A corresponding segment store (e.g. implemented via record processing and storage system 2505 and/or database storage 2450), upon startup and drive discovery, can assign each drive (e.g. each memory drive 2425) a set of drive slots 2910, for example, to be apportioned as approximately equally as possible. Segments can be placed on a physical drive using rendezvous hashing based on a hash of the drive slot (e.g. a corresponding drive slot identifier 2916) and the segment group ID 2915 for the corresponding segment group to which the segment belongs. This can ensure that, for a given segment group, each node storing a segment will attempt to store the segment on the same drive slot. The set of particular nodes on which a segment group is initially stored on can be determined based off node utilization, determined at allocation time based on the storage cluster derived variables, where the particular drive/drive slots selected upon this particular set of nodes is then deterministic based on the rendezvous hashing scheme being applied. In some embodiments, drive slot placements can be calculated any time a new segment is placed on a node—loading, rebuilding, transferring, etc.

FIG. 29A illustrates an embodiment of a given node 37.1 implementing a storage location data generator module 2911 to generate storage location data 2917.x for segment 2424.x1 having segment group ID 2915.x. A hash value generator module 2914 can generate a plurality of intermediate hash values 2914.x.1-2914.x.M for the plurality of drive slots 2910.1-2910.M, where a slot selection module selects a drive slot based on having a most favorably ordered (e.g. highest valued in some embodiments, lowest valued in other embodiments, etc.) intermediate hash value 2914. In this example, drive slot 2910.i having slot ID 2916.i has a most favorably ordered hash value 2914.x.i (e.g. 2914.x.i is a highest value of all values 2914.x.1-2914.x.M). This selected shot ID 2916.i can be considered/mapped to the hash value that segment 2424.x1 hashes to (e.g. in accordance with selecting this hash value from the intermediate hash values, for example, in conjunction with applying a rendezvous hashing algorithm).

Segment storage module 2918 can then store segment 2424.x1 in the specified drive slot 2910.i. For example, node 37.1 has a plurality of memory drives 2425.1.1-2425.1.R partitioned into the M drive slots 2910.1-2910.M (e.g. different drives have same or different number of drive slots D), where the identified slot 2910.i for segment 2424.x1 is included on memory drive 2425.1.j.

In some embodiments, a given intermediate hash value 2914 is generated as a function of: segment group identifier 2915.x for the given segment 2424.x1 and a slot identifier 2916 for the respective slot 2910 (e.g. hash value 2914.x.1 is generated as a function of group identifier 2915.x and slot identifier 2916.1; hash value 2914.x.2 is generated as a function of group identifier 2915.x and slot identifier 2916.2, hash value 2914.x.i is generated as a function of group identifier 2915.x and slot identifier 2916.i, etc.). As a particular example, the segment group ID 2914.x is concatenated with the respective drive slot ID 2916 (e.g. which is optionally an integer, such as a uint8_t data type), and the corresponding hash function (e.g. modulo function or other hash function) is performed upon this concatenated value to generate the respective intermediate hash value 2914.

The most favorably ordered intermediate hash value 2914 can be identified based on sorting the intermediate hash values 2914.x.1-2914.x.M and selecting drive slot 2910.i having the highest (or optionally lowest) intermediate hash value 2914.i in the sorting.

In some embodiments, this calculation to render selection of slot ID 2916.i for a given segment 2424.x1 via storage location data generator module 2913 has complexity of O(n) where n is the number of drive slots (e.g. n=M).

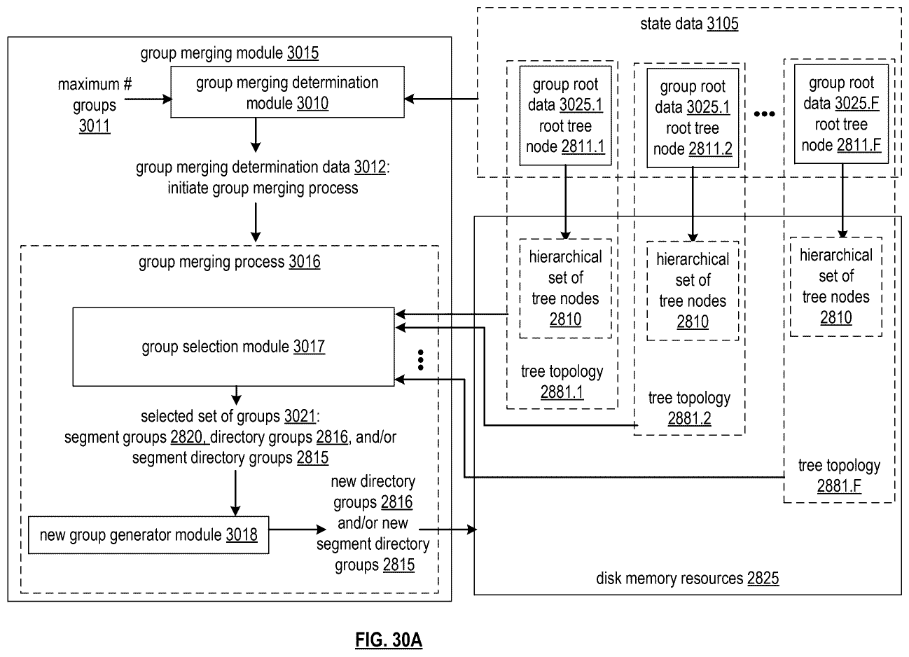

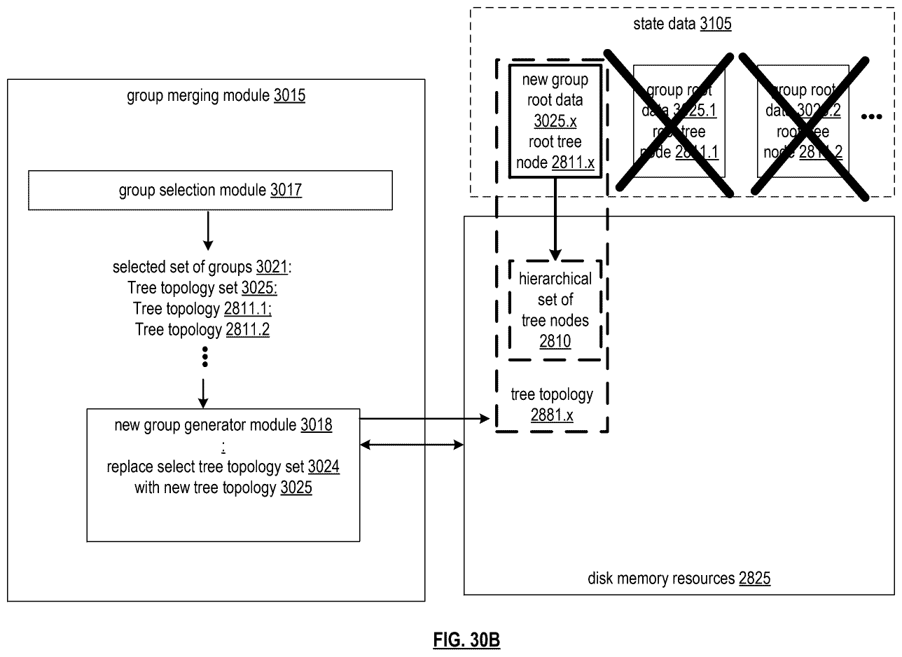

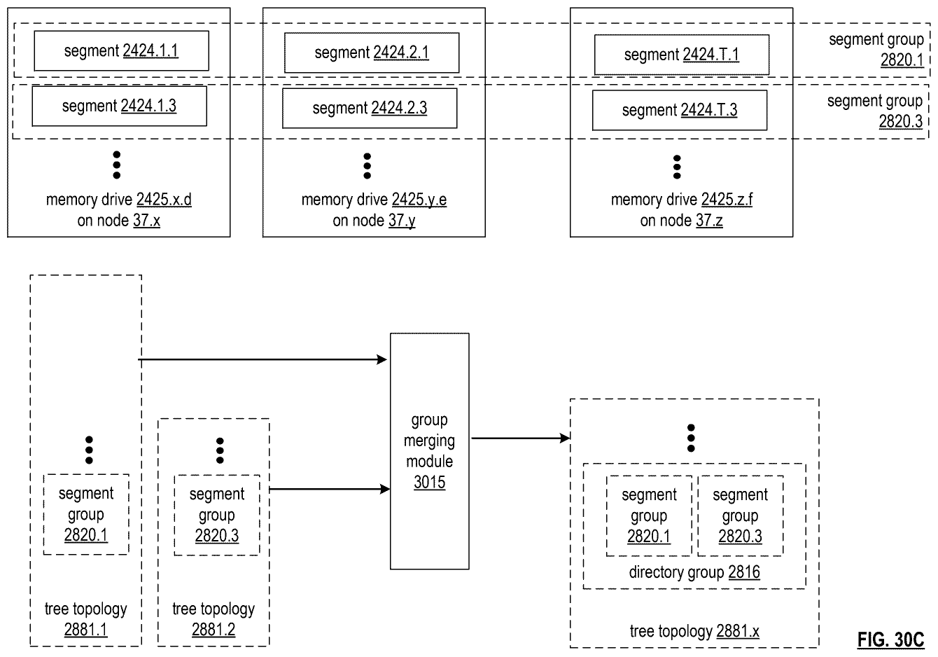

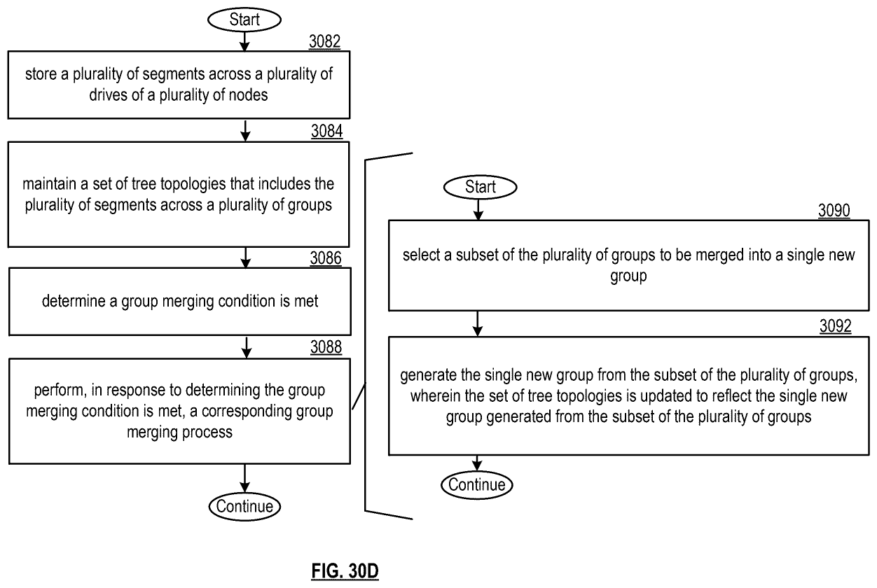

In some embodiments, the drive slot count M is specified on a per-storage cluster basis (e.g. upon creating a storage cluster) and is saved in metadata. In some embodiments, the default value for M used in some or all storage clusters is 48 drive slots per node. The value of M can be selected based on performing at least one simulation and/or computation to determine an ideal and/or reasonable number M, for example, to render a greatest amount of merges/highest “merge-ability” to merge segment groups as discussed in conjunction with FIGS. 30A-30C. In some embodiments, such merge-ability is highest when drive slots are equally distributed across each drive on a node and/or the drive slots are otherwise configured to be distributed across a given node's drives 2425 as equally as possible. In some embodiments, 48 is selected as the value of M based on 48 drive slots performing generally better than 24 drive slots for non-divisible drive counts, and/or based on being evenly divisible by 6, 8, 12, and 16, which can render higher flexibility in terms of future drive topologies.

While not illustrated, segment directories 2822 (e.g. corresponding metadata 2855 and/or corresponding files 2806) can be similarly assigned to a given drive slot 2910 for storage as a function of their segment directory group identifier for a corresponding directory group 2816 (e.g. intermediate hash values 2914 are generated based concatenating this segment directory group identifier with the respective slot identifiers 2916).

In some embodiments, instead of using rendezvous hashing to determine slot identifier for a given segment as a function of its segment group identifier, a consistent hashing algorithm can be applied, for example, at the cost of slightly more complexity to reduce the number of groups that would need to be reallocated upon adding/removing drives. The decision of whether to apply rendezvous hashing vs. consistent hashing can be automatically determined and/or configured via user input. The decision of whether to apply rendezvous hashing vs. consistent hashing can optionally change over time.

FIG. 29B illustrates an embodiment of a plurality of nodes 37.1-37.T (e.g. a subset of nodes of a given storage cluster, or optionally all nodes of a given storage cluster). Each node can have the same number of drive slots M. In the case where a given segment group 2820.x having segments 2424.x1-2424.xT is stored via a given set of nodes 37.1-37.T (e.g. T nodes selected from the storage cluster based on storage utilization, or otherwise selected from the storage cluster). Because the storage location data generator module 2911 selects drive slot 2910 for storage of a given segment based on its segment group identifier 2915, the same drive slot (e.g. in an ordering/mapping of drive slots) having a same slot ID 2916.i is selected across all of the nodes 37 for storage of the respective segment 2424 of the given segment group 2820.x having segment group ID 2915.x.

FIG. 29C illustrates example placement of a plurality of segments 2424 of a plurality of segment groups 2820 in respective drive slots 2910 of nodes 37 of a given storage cluster. The given segment group 2820.x has its segments 2424.x1-2424.xT placed in drive slot 2910.i of each of the nodes 37.1-37.T, for example, as illustrated in FIG. 29B. Similarly, another segment group 2820.q also has its segments 2424.q1-2424.qT placed in drive slot 2910.i of each of the nodes 37.1-37.T, for example, based on all hashing to the corresponding slot ID 2916.i as the result of the rendezvous hashing being performed upon a corresponding segment group identifier 2915.q for segment group 2820.q. Meanwhile another segment group 2820.s has its segments 2424.sl-2424.sT all placed in another drive slot 2910.1 of each of these nodes 37.1-37.T, for example, based on all hashing to the corresponding slot ID 2916.1 as the result of the rendezvous hashing being performed upon a corresponding segment group identifier 2915.s for segment group 2820.s.

This particular set of nodes 37.1-37.T is not necessarily selected for other segment groups, for example, based on utilization across all nodes in the cluster at various times that segment groups are assigned to nodes (e.g. T nodes to store the T respective segments) for storage. For example, another segment group 2820.r has its segments 2424.r1-2424.rT all placed in a drive slot 2910.i of each of another set of T nodes that includes node 37.1 and nodes 37.T+1-37.2T−1, for example, based on all hashing to the corresponding slot ID 2916.1 as the result of the rendezvous hashing being performed upon a corresponding segment group identifier 2915.r for segment group 2820.r.

FIG. 29D illustrates an example of placing segments 2424 across drive slots upon memory drives 2425 of different nodes 37. In this example, two nodes 37.1 and 37.2 each store respective segments 2424 of a set of segment groups 2820.w, 2820.x, 2820.y, and/or 2820.z (e.g. segment group 2820.w includes a set of segments that includes segments 2424.w1 and 2424.w2; segment group 2820.x includes a set of segments that includes segments 2424.x1 and 2424.x2; segment group 2820.y includes a set of segments that includes segments 2424.y1 and 2424.y2; and/or segment group 2820.z includes a set of segments that includes segments 2424.z1 and 2424.z2).

In some embodiments, a given drive slot d may map to different physical drives across different nodes, for example, due to drive imbalances. In this example, a first memory drive 2425.1.1 of node 37.1 stores at least two drive slots 2910.1.1 (e.g. having slot ID 2916.1) and 2910.1.2 (e.g. having slot ID 2916.2), while a second memory drive 2425.1.2 of node 37.1 stores at least drive slot 2910.1.3 (e.g. having slot ID 2916.3). Meanwhile, the first memory drive 2425.2.1 of node 37.2 similarly stores drive slot 2910.2.1 (e.g. having slot ID 2916.1), but drive slot 2910.2.2 (e.g. having slot ID 2916.2) is included on its second memory drive 2910.2.2 and drive slot 2910.2.3 (e.g. having slot ID 2916.3) is included on a third memory drive 2910.2.3. For example.

Thus while all given segments of a given segment group are assigned to drive slots having the same slot ID, for example, based on applying the rendezvous hashing scheme (e.g. segments of segment group 2820.w are assigned to slots having slot ID 2916.3; segments of segment group 2820.x are assigned to slots having slot ID 2916.1; segments of segment group 2820.y are assigned to slots having slot ID 2916.2; and/or segments of segment group 2820.z are assigned to slots having slot ID 2916.3), not all segment groups are necessarily guaranteed to have segments on the same drives across nodes

In some embodiments, merging of segment groups (e.g. into a segment directory) is requires the respective segments be stored on same drives across all of the set of nodes. In this example, even though segment groups 2820.x and 2820.y have respective nodes 2424.x1 and 2424.y1 are stored on the same drive on node 37.1, segment groups 2820.X and 2820.Y cannot be combined into a segment directory due to being stored on different drives on node 37.2 (e.g. due to respective slots being assigned differently across drives of different nodes due to drive imbalances).

Meanwhile, in this example, segment groups segment groups 2820.w and 2820.z map to a same drive slot and can thus be guaranteed to be stored on a same logical drive across multiple nodes (e.g. unless abnormal placement occurs) and are thus eligible to be combined into a segment directory. Indeed, segments 2424.w1 and 2424.z1 are stored on a same drive of node 37.1 and segments 2424.w2 and 2424.z2 are stored on a same drive of node 37.2.

In some embodiments, the deterministic drive slot placements is implemented as a best-effort approach: while it is strongly preferred that segments be allocated on the hashed drive slot, it is not required. This can provide flexibility in various failure cases—the biggest two being out of space errors, or generic drive errors.

At allocation time, the local node can determine what drive slot a segment should be hashed to. If allocating a file of the specified size fails for any reason, the node and/or corresponding segment store can attempt to allocate the segment on the least utilized, available drive. Such storing of the segment on a drive slot and/or corresponding drive different from its drive slot mapped via the hashing scheme can correspond to an “abnormal drive placement”. The existence of an abnormal drive placement can be forwarded to the storage cluster and/or tracked on consensus state (e.g. in corresponding state data). In some embodiments, abnormally placed segments are not eligible to be merged into segment directories.

FIG. 29E illustrates an embodiment where an abnormal placement occurs due to an inability to store the segment the drive to which it is hashed via the hashing scheme. For simplicity, assume one slot 2910 per drive 2425 in this example. The arrows can indicate to which drive a corresponding segment is mapped/is optionally already stored in this example (e.g. segments 2424.x1, 2424.x2, 2424.y1, and 2424.y2 are written to respective drives before/at time t=0, and are still stored in/still map to these drives at time t=1.

In this example, segment groups 2820.x and 2820.z hash to drive 2425.1 while segment group 2820.y hashes to drive 2425.2. Segment groups 2820.x and 2820.y have segments 2424 written to nodes 37.1 and 37.2 after time t=0 and prior to time t=1 when drive 2425.2.1 on node 37.2 becomes unavailable (e.g. due to an outage, being full, or some other reason).

However, when segment group 2820 z is written at/after time t=1, drive 2425.1 on node 37.2 is not available. Node 37.2 can allocate segment 2424.z2 on drive 2425.2 in this case and/or can indirectly sent information to the storage cluster that segment 2424.z2 (and/or segment group 2820.z as a whole) has abnormal drive placement. If drive 2425.1 comes back online in the future, even though segment groups 2820.x and 2820.z should be able to be merged based purely on the hashes of the segment group IDs, they are not eligible to be merged because of the abnormal drive placement.

In some embodiments, if a drive has failed and requires replacement, segment groups are optionally temporarily loaded into the system in abnormal drive placements for the duration of the drive failure+replacement process. However, because the number of logical drives has not changed on the node and therefore the drive slot topology remains unchanged, segments that previously existed in drive slots on the failed drive will be rebuilt on the new drive, and future segments that should hash to the failed drive will still hash to the new drive. Thus, only segment groups loaded during the outage period are affected and ineligible for combination. In the example of FIG. 29D, if the unavailability of drive 2425.2.1 was due to an outage, segment group 2820.z is affected due to being written during the outage, while segment group 2820.x is not due to being written before the outage.

Adding and removing drives can result in drive slot topology changes. Segments that mapped previously to a drive slot may now map to a new drive slot, and possibly even a new drive. During the traversal of the directory trees at startup, a local node should maintain a list of segments that are allocated on in the wrong drive slot (simply by hashing the segment group IDs of each file). When the storage cluster receives the list of storage IDs a node contains locally, additionally mark stored segments as abnormally placed, if specified. This abnormally placed storage can be normalized later via a normalization task, which attempts to rebuild the abnormally placed storage onto the desired storage.

FIG. 29F illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 29F, for example, based on participating in execution of a storage operation or other operation being executed by the database system 10. Some or all of the method of FIG. 29F can be performed by nodes participating in a storage cluster to store a plurality of segments. In some embodiments, a node 37 can implement some or all of FIG. 29F based on implementing a corresponding plurality of processing core resources 48.1-48.W. Some or all of the steps of FIG. 29F can optionally be performed by any other one or more processing modules of the database system 10.

Some or all steps of FIG. 29F can be performed in parallel and/or concurrently via a plurality of parallelized processing resources (e.g. implemented via a plurality of nodes 37 and/or a plurality of processing core resources 48). For example, multiple instances of any given step of FIG. 29F can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of FIG. 29F can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step.

Some or all of the steps of FIG. 29F can be performed to implement some or all of the functionality of the database system 10 as described in conjunction with FIGS. 29A-29E, for example, by implementing some or all of the functionality of memory slots 2910 and/or memory drives 2425 of nodes 37, and/or via implementing some or all functionality of storage location data generator module 2913 and/or segment storage module 2918. Some or all steps of FIG. 29F can be performed by database system 10 in accordance with other embodiments of the database system 10 and/or nodes 37 discussed herein. Some or all of the steps of FIG. 29F can be performed in conjunction with performing some or all steps of any other method described herein.

Step 2982 includes generating a plurality of segments for storage. Step 2984 includes partitioning, for each node of a plurality of nodes, a plurality of drives of the each node into a plurality of drive slots. Step 2986 includes generating, for each segment of the plurality of segments, corresponding storage location data indicating a corresponding drive slot of the plurality of drive slots upon one of the plurality of nodes based on performing a hash function upon: an identifier of the drive slot and an identifier for the each segment. Step 2988 includes storing the each segment in the corresponding drive slot indicated by the corresponding storage location data.

In various examples, generating the corresponding storage location data for the each segment includes: generating a plurality of hash values for a plurality of drive slot options, wherein each hash value of the plurality of hash values is generated as a function of the identifier for the each segment and a corresponding identifier of a corresponding drive slot of the plurality of drive slot options; and/or selecting one of the plurality of drive slot options having a highest valued hash value of the plurality of hash values as the corresponding drive slot.

In various examples, the corresponding drive slot of the corresponding storage location data is computed via performance of a rendezvous hashing scheme.

In various examples, the each hash value of the plurality of hash values is generated as a function of a concatenated value generated by concatenating the identifier for the each segment and the identifier for the drive slot.

In various examples, the plurality of segments includes a plurality of segment groups. In various examples, each segment group of the plurality of segment groups includes a corresponding set of segments generated in accordance with a redundancy storage scheme. In various examples, each of the corresponding set of segments of the each segment group is recoverable via other ones of the corresponding set of segments based on the redundancy storage scheme.

In various examples, the each segment group has a corresponding segment group identifier of a plurality of segment group identifiers for the plurality of segment groups, and wherein the identifier for the each segment is the segment group identifier for a corresponding segment group that includes the each segment.

In various examples, the each of the corresponding set of segments of the each segment group is stored on a corresponding one of a set of nodes in a same corresponding drive slot of the corresponding one of a set of nodes determined via performing the hash function on the group identifier for the each segment group.

In various examples, a first segment group of the plurality of segment groups is stored upon a first set of drive slots across a first set of nodes of the plurality of nodes based on first hash values generated via performance of the hash function for a first set of segments of the first segment group in generating first corresponding storage location data for each of the first set of segments. In various examples, a second segment group of the plurality of segment groups is also stored upon the first set of drive slots across the first set of nodes of the plurality of nodes based on second hash values generated via performance of the hash function for a first set of segments of the first segment group in generating first corresponding storage location data for each of the first set of segments.

In various examples, the method further includes merging the first set of segments and the second set of segments into a same segment directory group based on the first set of drive slots storing both the first set of segments and the second set of segments.

In various examples, the each node includes a same number of drive slots as all other nodes of the plurality of nodes. In various examples, the each node includes exactly forty-eight drive slots.

In various examples, each drive of the plurality of drives of the each node includes multiple corresponding ones of the plurality of drive slots.

In various examples, the method further includes: determining, for a first segment of the plurality of segments, that a first drive slot of a first node indicated by a first corresponding storage location data generated for the first segment is unavailable for storing the first segment; generating first abnormal placement data for the first segment indicating a different drive slot of the first node based on determining that a first drive slot is unavailable for storing the first segment; and/or storing the first segment in the different drive slot indicated by the abnormal placement data.

In various examples, the method further includes maintaining state data via the plurality of nodes in accordance with a consensus protocol. In various examples, the state data indicates a set of abnormal placement data for a subset of segments of the plurality of segments having unavailable corresponding drive slots indicated in their corresponding storage location data. In various examples, the method further includes adding the first abnormal placement data for the first segment to the set of abnormal placement data in the state data based on generating the first abnormal placement data for the first segment.

In various examples, the method further includes: storing a first plurality of segments via a first plurality of drives of a first node in accordance with a first plurality of corresponding storage location data generated for the first plurality of segments; changing the first plurality of drives of the first node to an updated first plurality of drives based on at least one of: adding at least one drive to the first plurality of drives or removing at least one drive from the first plurality of drives; partitioning the updated first plurality of drives into an updated plurality of drive slots for the first node; determining that the corresponding storage location data for at least one of the first plurality of segments indicates a corresponding drive slot that no longer stores the one of the first plurality of segments based on changing the first plurality of drives to the updated first plurality of drives partitioned via the updated plurality of drive slots; generating corresponding abnormal placement data for the at least one of the first plurality of segments based on the corresponding storage location data for the at least one of the first plurality of segments indicates the corresponding drive slot that no longer stores the one of the first plurality of segments; and/or adding the corresponding abnormal placement data for the at least one of the first plurality of segments to the set of abnormal placement data in the state data.

In various examples, the method further includes determining a failure of a first drive of a first node. In various examples, the first drive includes a first plurality of drive slots corresponding to a proper subset of the plurality of drive slots of the first node, and wherein the first drive stores a first set of segments. In various examples, after the first drive is replaced on the first node with a replacement first drive, all of the first set of segments are rebuilt upon the first plurality of drive slots of the replacement first drive.

In various examples, the method further includes generating the plurality of segments based on performing a plurality of page conversion processes. In various examples, performing one of the plurality of page conversion processes includes executing a segment generation operation to generate a single segment based on: generating, via a director module, a plurality of parallelized threads for generating the single segment; generating, via a producer module implemented based on utilizing a first parallelized thread of the plurality of parallelized threads, a plurality of work units assigned to a plurality of delegate modules for processing; and/or processing, via each of the plurality of delegate modules while utilizing a corresponding parallelized thread of a subset of parallelized threads of the plurality of parallelized threads, a corresponding subset of work units of the plurality of work units assigned to the each of the plurality of delegate modules. In various examples, performing one of the plurality of page conversion processes further includes executing a segment grouping process and a segment transfer process upon the single segment to generate at least some of the plurality of segments from the single segment.

In various examples, the method further includes generating the plurality of segments based on performing a plurality of page conversion processes based on: generating a plurality of scheduling data for performing the plurality of page conversions processes. In various examples, generating corresponding scheduling data of the plurality of scheduling data for each page conversion process of the plurality of page conversion processes is based on automatically selecting at least one of a plurality of page buckets to have corresponding pages included in a corresponding page batch as a function of a set of page conversion parameters that includes: a segment generation timeout parameter, a minimum batch size parameter, and a page batch memory budget parameter. In various examples, generating the plurality of segments is further based on performing the each of the plurality of page conversion processes to generate a corresponding set of segments of a plurality of sets of segments for long term storage from the corresponding page batch selected for the each of the plurality of page conversion processes.

In various examples, a tree topology for a root directory indicates a plurality of files that includes a corresponding subset of the plurality of segments. In various examples, the method further includes accessing the set of files and the corresponding subset of the plurality of segments of the tree topology based on: when a root directory owner field for the root directory has one of: an unowned value or the value of the owner field indicated in directory metadata included in ones of the plurality of files corresponding to parent tree nodes in the tree topology, applying a first owned storage identifier indicated by the storage identifier and a value of an owner field; and/or when a root directory owner field for the root directory has one another value different from the value of the owner field, applying a second owned storage identifier indicated by the storage identifier and the another value of the root directory owner field.

In various embodiments, any one of more of the various examples listed above are implemented in conjunction with performing some or all steps of FIG. 29F. In various embodiments, any set of the various examples listed above can be implemented in tandem, for example, in conjunction with performing some or all steps of FIG. 29F, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 29F described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 29F, for example, in conjunction with further implementing any one or more of the various examples described above.

In various embodiments, the operational instructions, when executed by the at least one processor, cause the database system to: generate a plurality of segments for storage; partition, for each node of a plurality of nodes, a plurality of drives of the each node into a plurality of drive slots; generate, for each segment of the plurality of segments, corresponding storage location data indicating a corresponding drive slot of the plurality of drive slots upon one of the plurality of nodes based on performing a hash function upon: an identifier of the drive slot and an identifier for the each segment; and store the each segment in the corresponding drive slot indicated by the corresponding storage location data.

FIGS. 30A-30C illustrate embodiments of database system 10 where a group merging module 3015 is implemented (e.g. via a node 37 and/or other processing resources of database system 10) to “combine” multiple groups of one or more tree topologies 2881 (e.g. multiple segment groups 2820, multiple directory groups 2816, and/or multiple segment directory groups 2815) for inclusion in a same tree topology 2881. For example, multiple segment groups 2820 are “combined” to be included as members of a same segment directory group, where these multiple segment groups 2820 were optionally children/descendants of multiple prior segment directory groups, each including a set of segment groups, and/or where these multiple prior segment groups are merged into a single, new segment directory group.

FIG. 30A illustrates an embodiment of a group merging module 3015 that determines to initiate a group merging process and then performs a group merging process in response based on implementing a group merging determination module 3010, a group selection module 3017, and/or a group generator module 3018.

In some embodiments, a corresponding algorithm for determining whether to initiate a group merging process and/or performing the group merging process runs as a distributed background task on a set polling interval. For example, the background task runs on its own thread, on a general purpose core.

In some embodiments, a group merging determination module 3010 can generate group merging determination data 3012 that the group merging process be performed (e.g. at a given time based on corresponding group merging conditions being met). For example, group merging determination module 3010 can generate group merging determination data 3012 indicating the group merging process be performed in response to determining a predetermined maximum number of groups 3011 is met and/or exceeded by a number of groups (e.g. indicated by a value of a corresponding variable, such as “maximumSegmentGroupCount”) maintained in a set of tree topologies 2881.1-2881.F. For example, the maximum number of groups 3011 corresponds to a maximum number of root tree nodes 3025 (e.g. corresponding to a maximum number of different segment directory groups 2815, for example, having separate/unconnected tree topologies 2811) that can be maintained in state data 3105.

In various examples, the maximum number of groups 3011 is a configurable variable, for example, representing the maximum number of segment groups (and/or segment directory groups) the consensus state can handle. The respective value can be configurable (e.g. via user input and/or automatically). In some embodiments, this maximum number of groups 3011 is treated as a hardcoded “magic number”, where the maximum number of groups 2011 is optionally selected based off storage cluster scalability and snapshot size restraints, for example, rather than being selected as a function of workload dynamics or system sizing.

In some embodiments, one or more nodes 37 implement the group merging module 3015, for example, independently. For example, a given node 37 can choose to kick off the merging task (e.g. via implementing group merging determination module 3010), for example, using random timing and change handlers (e.g. similar to how raft elections work in the consensus state). In some embodiments, only one merging task is allowed to be running on a given storage cluster at any time. In some embodiments, when a node sees that the count of active segment groups in the cluster state exceeds the threshold indicated by maximum number of groups 2011, it can kick off a random timeout in response (e.g. based on using raft election timeout values utilized in participating in the consensus protocol) and then initiate a merging task, for example, via a metadata storage protocol.

In some embodiments, determining the number of segment groups can be based on only counting active segment groups (e.g. visible and infinite end OSN placement) when determining whether or not to kick off a merging task. In some embodiments, some or all nodes of the storage cluster kick off a random timeout at almost the same time (e.g. due to how Raft change handlers work). However, only the first node (e.g. with the smallest randomized timeout) becomes the initiating node for the merging task. If a node tries to run a merging task and there is already one running, it can just abort and not initiate a merging task.

Once group merging determination data 3012 is generated indicating the group merging process 3016 be initiated, group merging process 3016 can be performed (e.g. via a corresponding group merging task) to combine as many groups as possible (e.g. via implementing a corresponding algorithm implemented via group selection module 3017 and/or new group generator module 3018).

Group selection module 3017 can be implemented to identify a selected set of groups 3021 for margining, which can include one or more segment groups 2820, one or more directory groups 2816, and/or one or more segment directory groups 2815.

Implementing group selection module 3017 can include determining a set of segment directory groups or segment groups that can be combined (e.g. but not both) The requirements for identifying candidates to be included in the selected set of groups 3021 can include some or all of the following requirements: (1) candidates must have all children stored on the same drive slots on the same set of nodes; (2) candidates must have the same depth in their corresponding tree topology 2881 (e.g. segment groups cannot be combined with segment directory groups, and segment directory groups cannot be combined with other directory groups of different depth, for example, to preserves the balanced nature of the tree topologies 2881); (3) candidates must be entirely served by placed non-deletable and INTACT DISK segments at the time of combination; (4) All segments (e.g. included as children and/or descendants of candidates) must be normally placed in the correct drive slot (e.g. no segments with abnormal placement); (5) Candidates must be segment groups of segments 2424, not pages 2515; (6) candidates must not be marked deletable and must be a part of the same scope (e.g. if a scope is specified and active); and/or (7) Candidates must be a part of the same table (e.g. all segments store rows of a same table 2712 of database storage 2450).

In some embodiments, group selection module 3017 generates selected set of groups 3021 based on partitioning the set of all candidates into smaller sets of merge-able candidates (e.g. to identify multiple corresponding selected sets of groups 3021), where the new group generator module 3018 is optionally applied to each selected set of groups 3021 of the multiple selected sets of groups 3021. In some embodiments, one single directory group is generated from each of these smaller sets at the end of the group merging process 3016 (e.g. groups of smaller sets are merged into a smaller number of intermediate sets, which are merged, and so on, until only one final group remains).

In some embodiments, the new group generator module 3018 creates a new segment directory group 2815 (and/or new directory group 2816), given a set of segment groups 2820, directory groups 2816, and/or segment directory groups 2815. For example, the new segment directory group 2815 is generated from a corresponding selected set of groups 3021 based on performing some or all of the following steps: (1) acquire an exclusive table write lock (e.g. this prevents addendum parts or transfers from executing against segment groups while the merging algorithm runs); (2) collect storage IDs 3141 to combine into a segment directory for each IDA offset in the segment directory group (e.g. via consulting the Raft state, such as state data 3105); (3) build the directory metadata 2855 locally for each segment directory 2822; (4) Create the full directory metadata parts by combining directory metadata 2855+copy replicated directory metadata 2855′; (5) Build table of contents (TOC) parts and/or calculate padding bytes for each segment directory 2822; (6) build addendum part directory files for each IDA offset (e.g. e.g. via consulting the Raft state, such as state data 3105), for example, where only active existing addendum parts are combined and/or where addendum parts with finite end OSN placed segment parts are not included; (7) write the full directory metadata parts (e.g. via allocate and/or put function calls to each node storing an IDA offset for the segment directory group); (8) save the storage IDs at which the segment directories were written on each remote node; (9) write the addendum part directory (e.g. via allocate and/or put function calls to each node storing an IDA offset for the segment directory group); (10) replicate the addendum part directory to the correct set of nodes for each IDA offset in the segment directory group; (11) send a commit request (e.g. once the storage cluster re-checks all the candidate segment groups/segment directory groups to make sure that they are still valid to be combined) to commit the new segment directory group with depth 1 (e.g. indicating normal vs. abnormal placement), for example, atomically replacing the old TKT segment groups/old segment directory groups with the new segment directory group (e.g. by marking the old groups SUBSUMED); and/or (12) release the exclusive table write lock. In some embodiments, if at any point up to the commit request the combination algorithm receives any sort of error (transport, API, drive, etc.), the transaction can be aborted. For example, nothing needs to be manually cleaned up in this case—any file allocations will be timed out/cleaned up (e.g. according to an orphan/allocation timeout cleanup process).

FIG. 30B illustrates an example of how state data 3105 and/or data stored via disk memory resources 2825 of FIG. 30A changes as a result of performing the group merging process 3016. As a particular example, the selected set of groups 3021 indicates a set of groups including groups (e.g. corresponding segment directory groups 2815 and/or segment groups 2820) included in and/or encompassing at least tree topology 2881.1 and 2881.2 (e.g. the set of groups 3021 indicates combining of the segment directory groups or segment groups indicated by at least group root data 3025.1 and 3025.2). A new group root data 3025.x for a new segment group directory 2815 having a corresponding root tree node 2811 is generated to include a hierarchical set of tree nodes 2810 of a new tree topology 2881.x (e.g. having a same height as or increased heigh from the prior tree topologies 2881.1 and/or 2881.2).

FIG. 30C illustrates an example of segment groups 2820 being merged into a same directory group 2816. For example, two segment groups 2820.1 and 2820.3 stored across a same set of memory drives of a same set of nodes are identified for merging and are merged into a same directory group accordingly (e.g. the resulting directory group 2816 that includes these segment groups corresponds to the set of segment directories 2822.1-2822.T of FIG. 28C). In this example, the two segment groups 2820.1 and 2820.3 were originally stored in different tree topologies 2881.1 and 2881.2 (e.g. having different root tree nodes 2811 indicated in state data 3105). In other examples, the two segment groups 2820.1 and 2820.3 were originally stored in a same tree topology 2881 under different directory groups 2816, where this tree topology 2881 is reconstructed to include the two segment groups 2820.1 and 2820.3 under the same directory group 2816.

FIG. 30D illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 30D, for example, based on participating in execution of a storage operation or other operation being executed by the database system 10. Some or all of the method of FIG. 30D can be performed by nodes participating in a storage cluster to store a plurality of segments. In some embodiments, a node 37 can implement some or all of FIG. 29F based on implementing a corresponding plurality of processing core resources 48.1-48.W. Some or all of the steps of FIG. 30D can optionally be performed by any other one or more processing modules of the database system 10.

Some or all steps of FIG. 30D can be performed in parallel and/or concurrently via a plurality of parallelized processing resources (e.g. implemented via a plurality of nodes 37 and/or a plurality of processing core resources 48). For example, multiple instances of any given step of FIG. 30D can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of FIG. 30D can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step.

Some or all of the steps of FIG. 30D can be performed to implement some or all of the functionality of the database system 10 as described in conjunction with FIGS. 30A-30C, for example, by implementing some or all of the functionality of group merging module 3015 and/or group merging process 3016. Some or all steps of FIG. 30D can be performed by database system 10 in accordance with other embodiments of the database system 10 and/or nodes 37 discussed herein. Some or all of the steps of FIG. 30D can be performed in conjunction with performing some or all steps of any other method described herein.

Step 3082 includes storing a plurality of segments across a plurality of drives of a plurality of nodes. Step 3084 includes maintaining a set of tree topologies that includes the plurality of segments across a plurality of groups. Step 3086 includes determining a group merging condition is met. Step 3088 includes performing, in response to determining the group merging condition is met, a corresponding group merging process.

Performing step 3088 can include performing step 3090 and/or step 3092. Step 3090 includes selecting a subset of the plurality of groups to be merged into a single new group. Step 3092 includes generating the single new group from the subset of the plurality of groups, wherein the set of tree topologies is updated to reflect the single new group generated from the subset of the plurality of groups.

In various examples, the set of tree topologies each include a plurality of hierarchical levels. In various examples, plurality of groups includes: a plurality of segment groups at a leaf level of the plurality of hierarchical levels that each include a corresponding set of segments; and/or a plurality of segment directory groups each at one of a set of non-leaf levels of the plurality of hierarchical levels that each include a correspond set of segment directories that each indicate one of: segments of a corresponding set of segment groups or segment directories of a corresponding set of segment directory groups.

In various examples, the single new group corresponds to a new segment directory group of the set of segment directory groups.

In various examples, the subset of the plurality of groups to be merged into the single new group includes is identified as one of: multiple ones of the plurality of segment groups, or multiple ones of the plurality of segment directory groups all at a same one of the set of non-leaf levels of the plurality of hierarchical levels.

In various examples, the subset of the plurality of groups to be merged into the single new group includes is identified multiple ones of the plurality of segment directory groups all at the same one of the set of non-leaf levels of the plurality of hierarchical levels of the tree topology, wherein the multiple ones of the plurality of segment directory groups collectively include a subset of the plurality of segment groups.

In various examples, the subset of the plurality of groups to be merged includes groups from multiple ones of the set of tree topologies to be merged at a same one of the plurality of hierarchical levels.

In various examples, the single new group is a new segment directory group that includes a corresponding set of new segment directories, wherein each new segment directory of the corresponding set of new segment directories is generated based on generating directory metadata for the each new segment directory that includes storage identifiers for each of a set of segment directory members of the each new segment directory.

In various examples, each group in the subset of the plurality of groups to be merged includes a plurality of group members each at one of a plurality of information dispersal algorithm (IDA) offsets, wherein the each new segment directory corresponds to one of plurality of IDA offsets, and wherein each segment directory indicates a set of segment directory members that includes, for the each group, one of the plurality of group members having the one of the plurality of IDA offsets, wherein different ones of the plurality of group members of the each group are included in different ones of the corresponding set of new segment directories.

In various examples, the each new segment directory is generated further based on: creating full directory metadata parts based on combining the directory metadata and copy replicated segment metadata for other ones of the corresponding set of new segment directories in the directory metadata; creating an addendum part directory based on combining existing addendum parts for the set of segment directory members of the each new segment directory; writing the full directory metadata parts to each of a set of nodes storing group members of the subset of the plurality of groups to be merged; and/or writing the addendum part directory to the each of the set of nodes.

In various examples, the directory metadata further stores an owner field for the each of the set of segment directory members of the each new segment directory. In various examples, the method further includes accessing each of the set of segment directory members of the each new segment directory of the new segment directory group via traversal of a corresponding new tree topology based on: when a root directory owner field for the new segment directory group has one of: an unowned value or the value of the owner field indicated by the directory metadata, applying a first owned storage identifier indicated by the storage identifier and a value of the owner field; and/or when a root directory owner field for the new segment directory group has one another value different from the value of the owner field, applying a second owned storage identifier indicated by the storage identifier and the another value of the root directory owner field.

In various examples, selecting the subset of the plurality of groups to be merged into the single new group is based on identifying groups of the plurality of groups all having a set of group members stored on a same set of drive slots of a same set of nodes.

In various examples, the set of group members for each group of the subset of the plurality of groups are stored on a same set of drive slots across the same set of nodes based on being placed by each node of the same set of nodes in accordance with a rendezvous hashing scheme applied to a corresponding group identifier of the each group.

In various examples, one of the plurality of groups is not selected in the subset of the plurality of groups based on having a group member of a corresponding set of group members stored in an abnormal drive placement based on being mapped to a corresponding drive slot via the rendezvous hashing scheme that is unavailable for storage of group member.

In various examples, the method further includes maintaining state data via the plurality of nodes in accordance with a consensus protocol. In various examples, the state data indicates a set of abnormal placement data for a subset of group members of a plurality of group members of the plurality of groups. In various examples, selecting the subset of the plurality of groups to be merged into the single new group is based on accessing the state data to exclude any groups of the plurality of groups having group members included in the subset of group members from inclusion in the subset of the plurality of groups to be merged into the single new group.

In various examples, the plurality of segments each store relational database rows for one of a set of relational database tables. In various examples, selecting the subset of the plurality of groups to be merged into the single new group is based on identifying groups of the plurality of groups all having segments as descendants in the tree topology storing relational database rows for a same relational database table of the set of relational database tables.

In various examples, selecting the subset of the plurality of groups to be merged into the single new group is based on identifying segment groups having segments determined to be: non-deletable segments; intact disk segments; and non-page segments.

In various examples, performing the corresponding group merging process is further based on partitioning subset of the plurality of groups selected to be merged into a plurality of sub-groups. In various examples, generating the single new group from the subset of the plurality of groups includes generating a plurality of new sub-groups. In various examples, each new sub-group of the plurality of new sub-groups is generated via performing a merging algorithm upon one of: a corresponding sub-group of the plurality of sub-groups, or a plurality of other new sub-groups. In various examples, the single new group is generated via performing the merging algorithm upon at least some of the plurality of new sub-groups.

In various examples, generating the single new group from the subset of the plurality of groups includes: acquiring an exclusive table write lock for a relational database table corresponding to the subset of the plurality of groups, and/or performing a merging algorithm while the exclusive table write lock is acquired. In various examples, no addendum parts are created for any segments included in the subset of the plurality of groups while merging algorithm is performed based on the exclusive table write lock being acquired. In various examples, no segment transfers are performed for the any segments included in the subset of the plurality of groups while the merging algorithm is performed based on the exclusive table write lock being acquired.

In various examples, determining the group merging condition is met is based on determining whether a number of groups corresponding to the set of tree topologies exceeds a predetermined maximum number of groups.

In various examples, a set of root tree nodes for the set of tree topologies is maintained in state data mediated via the plurality of nodes via a consensus protocol, and wherein generating the single new group includes generating a single new root tree node from multiple ones of the set of root tree nodes to reduce a number of root tree nodes in the set of root tree nodes. In various examples, a set of root tree nodes for the set of tree topologies is maintained in state data mediated via the plurality of nodes via a consensus protocol. In various examples, determining the group merging condition is met is based on determining whether a root tree nodes maintained in the state data exceeds a predetermined maximum number of root tree nodes (e.g. the predetermined maximum number of root tree nodes corresponds to the predetermined maximum number of groups).

In various examples, one node of the plurality of nodes determines the group margining condition is met. In various examples, the one node initiates performance of the group merging process as a corresponding task based on the one node determining the group merging condition is met.

In various examples, multiple ones of the plurality of nodes independently determine that the group merging condition is met. In various examples, each of the multiple ones of the plurality of nodes establishes a corresponding random timeout value. In various examples, the one node corresponds to a first node establishing a corresponding first random timeout value based on having a smallest random timeout. In various examples, other ones of the multiple ones of the plurality of nodes do not initiate performance of the group merging process based on determining the group merging process is already running as the corresponding task initiated by the one node.

In various examples, the method further includes generating the plurality of segments based on performing a plurality of page conversion processes. In various examples, performing one of the plurality of page conversion processes includes executing a segment generation operation to generate a single segment based on: generating, via a director module, a plurality of parallelized threads for generating the single segment; generating, via a producer module implemented based on utilizing a first parallelized thread of the plurality of parallelized threads, a plurality of work units assigned to a plurality of delegate modules for processing; and/or processing, via each of the plurality of delegate modules while utilizing a corresponding parallelized thread of a subset of parallelized threads of the plurality of parallelized threads, a corresponding subset of work units of the plurality of work units assigned to the each of the plurality of delegate modules. In various examples, performing one of the plurality of page conversion processes further includes executing a segment grouping process and a segment transfer process upon the single segment to generate at least some of the plurality of segments from the single segment.

In various examples, the method further includes generating the plurality of segments based on performing a plurality of page conversion processes. In various examples, performing the plurality of page conversion processes includes generating a plurality of scheduling data for performing the plurality of page conversions processes. In various examples, generating corresponding scheduling data of the plurality of scheduling data for each page conversion process of the plurality of page conversion processes is based on automatically selecting at least one of a plurality of page buckets to have corresponding pages included in a corresponding page batch as a function of a set of page conversion parameters that includes: a segment generation timeout parameter, a minimum batch size parameter, and a page batch memory budget parameter. In various examples, generating the corresponding scheduling data of the plurality of scheduling data for each page conversion process of the plurality of page conversion processes is further based on performing the each of the plurality of page conversion processes to generate a corresponding set of segments of a plurality of sets of segments for long term storage from the corresponding page batch selected for the each of the plurality of page conversion processes.

In various embodiments, any one of more of the various examples listed above are implemented in conjunction with performing some or all steps of FIG. 30D. In various embodiments, any set of the various examples listed above can be implemented in tandem, for example, in conjunction with performing some or all steps of FIG. 30D, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 30D described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 30D, for example, in conjunction with further implementing any one or more of the various examples described above.

In various embodiments, the operational instructions, when executed by the at least one processor, cause the database system to: store a plurality of segments across a plurality of drives of a plurality of nodes; maintain a tree topology for a segment directory group that includes the plurality of segments across a plurality of groups; determine a group merging condition is met; perform, in response to determining the group merging condition is met, a corresponding group merging process based on: selecting a subset of the plurality of groups to be merged into a single new group; and/or generating the single new group from the subset of the plurality of groups, wherein the tree topology is updated to reflect the single new group generated from the subset of the plurality of groups.

FIGS. 31A-31E illustrate embodiments of database system 10 where owner storage identifiers are implemented to identify (e.g. indicate memory locations of) tree nodes 2810 belonging to a given tree topology 2881 of a given segment directory group 2815.

In some embodiments, when segment directory groups are built (e.g. via one or more group merge processes as discussed in conjunction with FIGS. 30A-30C), information is collected on normalized (e.g. allocated on the expected drive slot) segments 2424 that are combined into directories 2822, with the contents of directories written on-disk into directory metadata 2855. Directory metadata 2855 can describe the immediate children of a directory—with it, a root directory (e.g. root tree node 2811 indicating a corresponding segment directory group 2815) can be traversed to discover all of the relevant children that are impacted by a given event (i.e. directory/segment activation/deallocation/rebuilds/etc.).

In some embodiments, directory metadata is replicated and made redundant (e.g. with the same methods as segments and/or data on the system, for example, in accordance with a respective redundancy storage scheme), for example, specifically by storing copies of it on other nodes within the directory group (e.g. as copy-replicated directory metadata as discussed in conjunction with FIG. 28B). The directory metadata can store the storage IDs 3141 of the immediate children of the directory alongside other pieces of information. These storage identifiers 3141 can be utilized to determine corresponding memory locations 2805 of the respective children, enabling access to the children in performing a respective traversal.

In some embodiments, this scheme can present a conundrum when rebuilding segments 2424 and/or files 2806 implementing segment directories 2822. Rebuilding segments/files can include physically constructing data that was lost by the use of exact byte copies from other nodes on the system or by using parity data from across the cluster, for example, via some or all features and/or functionality of rebuilding/recovering segments and/or other data described herein.

When a damaged or missing segment is rebuilt, a new stored segment 2424 can be created with a new storage ID 3141 (e.g. identifying its new location on disk). When rebuilding the children of a directory, a corresponding storage ID should be used for the newly rebuilt child.

In a first one or more embodiments, the corresponding storage ID used for the newly rebuilt child corresponds to a new storage ID for the newly rebuilt child, different from its prior storage ID. However, if the child is allocated using a new storage ID, it will no longer match the storage ID that is present within its parent directory metadata. Thus, in such embodiments, the directory metadata which is stored/rebuilt on-disk across the cluster would no longer remain accurate. Segments (and by extension directories) are intended to be immutable—the design of storage cluster would need to be adapted to correct the metadata in a manner that is guaranteeably consistent with respect to OSNs and other events within the system in such embodiments.

In a second one or more embodiments, the corresponding storage ID used for the newly rebuilt child corresponds to the prior storage ID for this child that is stored within the directory metadata 2855. However, in such embodiments, potential use of the “wrong” child prior to the rebuild can occur. For example, consider a case where a damaged segment is still present on-disk on a given node. If the child is rebuilt on that node, the storage ID of the rebuilt child will match that of the damaged segment that is still present. This could cause a collision in various components which track segments by their storage ID such as the segment store and segment service.

FIGS. 31A-31E present a third one or more embodiments that provides solutions to pitfalls in the first one or more embodiments and second one or more embodiments described above. Such embodiment involves reusing storage IDs as described in the second one or more embodiments, but utilizing an owner field to differentiate between different versions of a given segment/file having a same storage ID (e.g. prior to and after one or more rebuilds).

This can be achieved based on implementing owned storage identifiers 3122, which can be implemented as rules and/or structures that enable reuse storage IDs 3141 for rebuilt children of directories in a safe and consistent manner. In particular, all files on disk (e.g. segments 2424, page segments 2515, files 2806 indicating directory metadata 2855, etc.) can be identified by a more than a single storage ID 3141 (e.g. corresponding UUID) alone based on augmenting this storage ID 3141 augmented with an additional owner field. The owner field can points to and/or otherwise in the root directory for which a child was rebuilt.

For example, an owned storage identifier can be implementing based on some or all of the following structuring, for example, where the value of “storageID” corresponds to the value of storage ID 3141 and where the value of “ownerStorageID” correspond to the value of owner field 3146:

```
struct OwnedStorageId_t {
  uuid::uuid_t storageId;
  uuid::uuid_t ownerStorageId;
};
```

In some embodiments, to save space and fit within a small (e.g. 128 byte region of memory, for example, that is reserved for extended attributes which can be inline within corresponding descriptors), a 32 bit hash of the owner UUID is stored rather than the full 128 byte UUID itself. In such embodiments, the owned storage identifier can be implementing based on some or all of the following structuring, where “owner” is the hash value generated from “ownerStorageID”:

```
struct ownedStorageId_t {
  uuid::uuid_t storageId;
  uint32_t owner;
};
```

In some embodiments, root directories are not tracked by any directory metadata structures on-disk. Therefore, when rebuilding root directories, they can be safely assigned a new storage ID within storage cluster.

In some embodiments, the directory metadata structuring implementing directory metadata 2855 can be implemented to include the owner of any subsumed children at the time of a merge operation. In such embodiments, the directory metadata 2855 can be implemented based on some or all of the following structuring:

struct directoryMetadataEntry_t {
uuid::uuid_t storageId;
uint32_t owner;
... (other misc. fields)
};
struct directoryMetadata_t {
repeated<directoryMetadataEntry_t> entries;
};

In some embodiments, the rules for setting the owner field when rebuilding a root directory and its children can include: (1) hashing the storage ID 3141 of the root directory, and then (2) passing the respective hashed value into any subsequent rebuild actions. This passed in owner value for owner field 3146 can then be used when allocating files for rebuilt children (e.g. the respective owner storage identifier 3122 dictated by the original storage ID and the passed down hashed value for owner field 3146 can indicate/point to/map to a respective memory location on disk and/or be otherwise utilized to enable access to the corresponding rebuilt file for this corresponding rebuilt child).

The rebuilt root directory itself can also have an assigned owner value (e.g. the same hashed value generated via hashing its storage ID 3141), which can simplify the logic for determining the correct owner values to use when iterating over directories.

When allocating files outside of the context of a rebuild, the owner field 3146 can be is always set a predetermined unowned value (e.g. 0 (zero)) by default), where files with an owner field having the predetermined unowned value are referred to as “unowned”.

FIG. 31A illustrates such an embodiment of a tree topology 2881 for a given segment directory group 2815.x generated prior to any rebuild (e.g. generated via one or more merge processes). As illustrated in this example, root tree node 2811 has a root tree owner field having a value of 0 (e.g. the unowned value due to not being generated via a rebuild). Owner storage identifiers 3122 for some children/descendants can also have the value of 0 for the owner field indicating they are similarly unowned (e.g. because the respective children have not undergone rebuilds prior to being merged into the respective segment directory group 2815.x), while owner storage identifiers for other children/descendants can have other values for owner field.

For example, some directories 2822 and segments 2424 in this example have values of y for owner field 3146, where this non-zero value y corresponds to a first owner, for example, corresponding to a first corresponding segment directory group 2815.y that was rebuilt (e.g. this first corresponding segment directory group 2815.y has storage identifier 3141 hashing to the value of y) and where these files/segments have the value y for their owner field 3146 based on having belonged to this first corresponding segment directory group 2815.y previously when the rebuild occurred (e.g. prior to being merged into the current segment directory group 2815.x).

As another example, other directories 2822 and/or segments 2424 in this example have values of z for owner field 3146, where this non-zero value z corresponds to a second owner, for example, corresponding to a second corresponding segment directory group 2815.z that was rebuilt (e.g. this second corresponding segment directory group 2815.z has storage identifier 3141 hashing to the value of z) and where these files/segments have the value z for their owner field 3146 based on having belonged to this second corresponding segment directory group 2815.z previously when the rebuild occurred (e.g. prior to being merged into the current segment directory group 2815.x).

In this example, segments 2424 having owner field 3146 with value z are descendants of a directory 2822 having an owner field 3146 with value 0, for example, because these segments 2424 were first merged into a prior segment directory group having this directory set with owner field having value 0 due to being generated via a merge rather than a rebuild.

While not illustrated, some segments 2424 included in the given segment directory group 2815.x can have owner fields 3146 with value 0 due to not having undergone rebuilding (e.g. their original owner value of 0 was never reset due to never being involved in a rebuild).

In some embodiments, the owner field of a rebuilt root directory and/or non-subsumed segment can be stored within the consensus state (e.g. as state data 3105), which can enable additional flexibility in configuring how owner values are computed, and/or can allow rebuilt vs. original segments and root directories to be distinguished readily within the consensus state.

FIG. 31B illustrates an embodiment of an updated tree topology 2881′ for the given segment directory group 2815.x after being rebuilt as rebuilt segment directory group 2815.x′. Due to undergoing the rebuild, root tree node owner field 3146 is set with value x (e.g. generated as the hash value of its respective storage identifier 3141), and all rebuild files 2806′ and/or rebuild segments 2424′ are rebuild with new owner storage identifiers 3122′ having their original storage ID 3141 and the new value x for owner field 3146.

In some embodiments, in setting an owner identifier (e.g. “ownerID”) for owner field 3146, some or all of the following rules are applied: (1). The original form of a file is unowned, (e.g. NULL owner). For example, when the loader allocates a segment, or when a directory is first created by the storage cluster, the new files are allocated with owner NULL (e.g. indicated by the predetermined unowned value); (2) On allocation from rebuild, a root segment will set itself as its owner (e.g. storageId==ownerId and/or its ownerID is hashed/derived from its storageID); (3) On allocation from rebuild, a child segment will set its owner as the root segment that it currently belongs to; (4) when a segment is subsumed by a new directory, the segment's owner is unchanged (e.g. note that the immediate child of a new directory optionally must have an owner equal to its storage ID or null; however, any descendants of an immediate child may be owned by any of the storage IDs upon the path to the root); (5) when creating a directory, write the ownerId to disk along with the child; (6) when traversing a directory, if a node X has non-null owner A, every node that is a descendant of X must also have owner A.

In some embodiments, in some or all of the following rules are applied for handling addendum parts and/or a corresponding addendum directory: (1) the parent storage ID for any addendum file with reference the relevant storage ID on the same level (e.g. a leaf addendum part's parent storage ID will be the leaf segment that the addendum part belongs to, and/or a root addendum directory's parent storage ID will be the root directory the addendum directory belongs to); (2) on allocation, an addendum part or directory will have owner NULL (e.g. the predetermined unowned value); (3) when a segment/directory is subsumed, its leaf addendum parts are subsumed, but the directory files themselves are not; (4) a subsuming addendum directory file has NULL owner at merge-creation time. (e.g. its children, such as the leaf addendum parts, may have arbitrary owners); (5) on allocation from rebuild, the root addendum directory file and all leaf addendum parts will set the ownerId to be the storage ID of the root addendum directory file; and/or (6) the owners of the subsumed leaf addendum parts should be written to the addendum directory metadata part, to be stored on disk.

FIG. 31C illustrates another example illustrating how owner values are computed and stored for another example segment directory group 2815.x2 (e.g. a corresponding root directory with a depth of 1) rebuilt as rebuilt segment directory group 2815.x2.

As illustrated in FIG. 31C, despite the owner fields changing for the children after the rebuild, the owner field values in the metadata of any rebuilt child directories are not modified (e.g. because directory metadata is immutable once created, for example, where a corresponding rebuild performed on a corresponding file 2806 reproduces the same data byte-for-byte and thus leave the underlying directory metadata 2855 unaltered).

In some embodiments, this discrepancy of owner identifier in the persisting directory metadata does not cause issues when iterating over children of rebuilt segments based on rules applied when performing a corresponding traversal, for example, based on applying a corresponding recursive tree traversal process 3136.

FIG. 31D illustrates an embodiment of a group access module 3135 (e.g. implemented via one or more nodes 37 and/or other processing resources of database system 10) that performs a recursive tree traversal process 3136 to access some or all of the hierarchical set of tree nodes 2810 of the tree topology 2881 of a corresponding segment directory group 2815 starting from its root tree node 2811 (e.g. in this example, the hierarchical set of tree nodes 2810 of the tree topology 2881.1 are accessed via 2815 starting from its root tree node 2811.1 indicated in state data 3105).

FIG. 31E illustrates an example of how this recursive tree traversal process 3136 is performed to determine which value of owner field be applied. This can include determining whether or not to utilize the owner field indicated in the directory metadata 2855, which may be outdated due to being immutable in a rebuilt, based on the value of the root tree node owner identifier of the root tree node 2811.

In particular, when the given directory (e.g. root directory or some child directory that has been recursively reached) corresponds to, or is reachable from (e.g. a descendant of) a root directory with a non-zero owner field 3146 (e.g. having value “O” that is non-zero or otherwise different from the predetermined unowned value), each child indicated (e.g. in corresponding directory metadata 2855 for the given directory) is accessed utilizing this passed down non-zero owner field value “0” as the owner field 3146 (e.g. regardless of what value is listed as the owner field value for these children in the directory metadata 2855, as the non-zero value for the root directory denotes at least one rebuild has occurred rendering owner fields in the directory metadata 2855 outdated). The owned storage identifier 3122 for accessing a given child is thus implemented as/based on the pair {S,O}, where “S” is the given child's storage ID 3141 (e.g. {S,O} indicates/is mapped to the memory location 2805 where the corresponding rebuilt file/segment is stored)

Meanwhile, when the given directory (e.g. root directory or some child directory that has been recursively reached) corresponds to, or is reachable from (e.g. a descendant of) a root directory with an owner field 3146 having the predetermined unowned value (e.g. having zero as the value for its owner field 3146), each child indicated (e.g. in corresponding directory metadata 2855 for the given directory) is accessed utilizing the value is listed as the owner field value for the child in the directory metadata 2855, as the zero value for the root directory denotes no rebuild has occurred, rendering owner fields in the directory metadata 2855 up-to-date with regards to accessing the correct data. The owned storage identifier 3122 for accessing a given child is thus implemented as/based on the pair {S,L}, where “S” is the given child's storage ID 3141 and where “L” is the value of owner field 3146 indicated in the directory metadata 2855 (e.g. {S,L} indicates/is mapped to the memory location 2805 where the corresponding file/segment is stored)

Iteration through the children of a directory can be performed recursively enable both determine whether a given directory is a root directory or not and/or whether to pass in an owner value from a root directory into subsequent actions. This can enable adhere to corresponding rules when iterating over children: (1) if the current node is owner the predetermined unowned value (e.g. 0 or NULL), read the directory metadata part and reference children based on the ownedStorageId written to disk; (2) if the current node has a non-null owner, any children of this node must have a matching owner (e.g. if there is no matching child-owner pair, then the child for the node is missing).

Helper actions for loading and parsing directory metadata (e.g. in a corresponding codebase) can be configured to automatically follow these rules on behalf of the caller.

In some embodiments, addendum parts and addendum directories also readily comply with the rules for owned storage IDs. When allocating an addendum part for a parent segment with storage ID “S” and owner “O” on-disk, the same owner “O” is used when allocating the addendum part. Addendum directory metadata can also store the owner value of any addendum parts at the time of metadata creation. The rules for iterating over addendum directory metadata and resolving entries to addendum parts on-disk can follow the same rules as for segment directories

FIG. 31F illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 31F, for example, based on participating in execution of a storage operation or other operation being executed by the database system 10. Some or all of the method of FIG. 31F can be performed by nodes participating in a storage cluster to store a plurality of segments. In some embodiments, a node 37 can implement some or all of FIG. 29F based on implementing a corresponding plurality of processing core resources 48.1-48.W. Some or all of the steps of FIG. 31F can optionally be performed by any other one or more processing modules of the database system 10.

Some or all steps of FIG. 31F can be performed in parallel and/or concurrently via a plurality of parallelized processing resources (e.g. implemented via a plurality of nodes 37 and/or a plurality of processing core resources 48). For example, multiple instances of any given step of FIG. 31F can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of FIG. 31F can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step.

Some or all of the steps of FIG. 31F can be performed to implement some or all of the functionality of the database system 10 as described in conjunction with FIGS. 31A-31E, for example, by implementing some or all of the functionality of owned storage identifiers 3122 and/or recursive tree traversal process 3136. Some or all steps of FIG. 31F can be performed by database system 10 in accordance with other embodiments of the database system 10 and/or nodes 37 discussed herein. Some or all of the steps of FIG. 31F can be performed in conjunction with performing some or all steps of any other method described herein.

Step 3182 includes storing a plurality of files across a plurality of drives of a plurality of nodes. In various examples, each file of the plurality of files is identified via an owned storage identifier indicated by: a storage identifier for the each file; and/or an owner field for the each file. Step 3184 includes storing a set of root directory data for a corresponding set of root directories as state data maintained via a consensus protocol mediated via the plurality of nodes. In various examples, each root directory of the set of root directories is identified via a corresponding root directory owner field. Step 3186 includes accessing a corresponding subset of the plurality of files belonging to a corresponding root directory of the corresponding set of root directories based on applying the owner field for each of the corresponding subset of the plurality of files.

In various examples, the each root directory includes the corresponding subset of the plurality of files as corresponding non-root nodes in a corresponding tree topology that includes a root tree node corresponding to the root directory data.

In various examples, accessing the corresponding subset of the plurality of files includes performing a recursive traversal of the corresponding tree topology.

In various examples, accessing the corresponding subset of the plurality of files via performing the recursive traversal includes, for a given tree node of the corresponding tree topology corresponding to a given file of the plurality of files, when the corresponding root directory owner field for the corresponding root directory indicates an unowned value: accessing each of a set of files, indicated as a corresponding one of a set of child tree nodes of the given tree node, via applying a first corresponding owned storage identifier having: the storage identifier for the each of the set of files and the owner field set as an owner field for the each of the set of files indicated in directory metadata for the given file.

In various examples, accessing the corresponding subset of the plurality of files via performing the recursive traversal includes, for a given tree node of the corresponding tree topology corresponding to a given file of the plurality of files, when the corresponding root directory owner field for the corresponding root directory indicates an owner identifier value different from the unowned value, access the each of the set of files, indicated as a corresponding one of a set of child tree nodes of the given tree node, via applying a second corresponding owned storage identifier based on having: the storage identifier for the each of the set of files and the owner field set as the owner identifier value indicated in the corresponding root directory owner field.

In various examples, the corresponding root directory owner field for the corresponding root directory indicates the owner identifier value. In various examples, first directory metadata for a first file reached via the recursive traversal indicates at least one child tree node having a corresponding value for the owner field different from the owner identifier value. In various examples, the recursive traversal does not proceed with access to the at least one child tree node having the corresponding value for the owner field different from the owner identifier value.

In various examples, a first subset of files of the corresponding subset of the plurality of files each correspond to a corresponding internal tree node of the corresponding tree topology and each contain directory metadata indicating, for each child tree node of a set of child tree nodes of the corresponding internal tree node: a corresponding storage identifier for a corresponding file corresponding to the each child tree node; and/or a corresponding owner field for the corresponding file corresponding to the each child tree node.

In various examples, the each file is accessed via the storage identifier for the each file and the owner field for the each file based on being included in the directory metadata of a corresponding parent tree node of a corresponding tree node of the corresponding tree topology.

In various examples, a second subset of files of the corresponding subset of the plurality of files each correspond to a corresponding segment of a plurality of segments stored across the plurality of drives of the plurality of nodes.

In various examples, the directory metadata stored as immutable data. In various examples, a first value of an owner field applied to access at least one of the corresponding subset of the plurality of files is different from a second value of the corresponding owner field for the at least one file indicated in the directory metadata based on the at least one of the corresponding subset of the plurality of files being rebuilt after the directory metadata was written to a corresponding drive of the plurality of drives.

In various examples, each of an unowned subset of the plurality of files has a corresponding unowned value assigned to the owner field. In various examples, the unowned value assigned to the owner field is zero.

In various examples, a set intersection between the unowned subset of the plurality of files and corresponding subset of the plurality of files belonging to the corresponding root directory is non-null based on the root directory owner field having the unowned value.

In various examples, each of an owned subset of the plurality of files have a corresponding owner identifier value assigned to the owner field.

In various examples, the corresponding owner identifier value of the each of the owned subset of the plurality of files has a non-zero value.

In various examples, a first subset of files of the owned subset of the plurality of files all have a first same corresponding owner identifier value and wherein a second subset of files of the owned subset of the plurality of files all have a second same corresponding owner identifier value.

In various examples, the corresponding subset of the plurality of files includes at least one of the first subset of files and at least one of the second subset of files based on the corresponding root directory owner field indicating an unowned value. In various examples, the corresponding subset of the plurality of files includes files from only the first subset of files based on the corresponding root directory owner field indicating the first same corresponding owner identifier value.

In various examples, a first file of the plurality of files has a first storage identifier having a first value for the owner field. In various examples, based on a rebuild process having been previously performed upon the first file, a second file of the plurality of files also has the first storage identifier and has a second value for the owner field different from the first value. In various examples, the corresponding subset of the plurality of files includes the second file and not the first file based on determining the second file is included in the corresponding root directory.

In various examples, the method further includes performing the rebuild process upon the first file to generate the second file based on rebuilding a plurality of files of a first root directory that includes the first file to generate a rebuilt root directory that includes a rebuilt plurality of files. In various examples, performing the rebuild process includes: setting the owner field for the rebuilt root directory as a corresponding owner identifier value generated based on a new storage identifier for the rebuilt root directory; and/or allocating each rebuilt file of the rebuilt plurality of files in a corresponding drive of the plurality of drives via applying a corresponding owned storage identifier having: the storage identifier for a corresponding file of the plurality of files being rebuilt as the each rebuilt file, and the owner field set as the corresponding owner identifier value.

In various examples, the rebuilt root directory is the corresponding root directory based on the corresponding root directory being generated via rebuilding the first root directory. In various examples, the rebuilt root directory is different from the corresponding root directory based on the corresponding root directory being generated via a merging process, performed after the rebuilt root directory is generated, to include a subsumed set of files from the rebuilt root directory that includes the second file.

In various examples, a proper subset of the plurality of files corresponds to a plurality of segments, further comprising generating the plurality of segments based on performing a plurality of page conversion processes. In various examples, performing one of the plurality of page conversion processes includes executing a segment generation operation to generate a single segment based on: generating, via a director module, a plurality of parallelized threads for generating the single segment; generating, via a producer module implemented based on utilizing a first parallelized thread of the plurality of parallelized threads, a plurality of work units assigned to a plurality of delegate modules for processing; and/or processing, via each of the plurality of delegate modules while utilizing a corresponding parallelized thread of a subset of parallelized threads of the plurality of parallelized threads, a corresponding subset of work units of the plurality of work units assigned to the each of the plurality of delegate modules. In various examples, performing one of the plurality of page conversion processes further includes executing a segment grouping process and a segment transfer process upon the single segment to generate at least some of the plurality of segments from the single segment.

In various examples, a proper subset of the plurality of files corresponds to a plurality of segments. In various examples, the method further includes generating the plurality of segments based on performing a plurality of page conversion processes based on: generating a plurality of scheduling data for performing the plurality of page conversions processes, wherein generating corresponding scheduling data of the plurality of scheduling data for each page conversion process of the plurality of page conversion processes is based on automatically selecting at least one of a plurality of page buckets to have corresponding pages included in a corresponding page batch as a function of a set of page conversion parameters that includes: a segment generation timeout parameter, a minimum batch size parameter, and a page batch memory budget parameter; and/or performing the each of the plurality of page conversion processes to generate a corresponding set of segments of a plurality of sets of segments for long term storage from the corresponding page batch selected for the each of the plurality of page conversion processes.

In various embodiments, any one of more of the various examples listed above are implemented in conjunction with performing some or all steps of FIG. 31F. In various embodiments, any set of the various examples listed above can be implemented in tandem, for example, in conjunction with performing some or all steps of FIG. 31F, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 31F described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 31F, for example, in conjunction with further implementing any one or more of the various examples described above.

In various embodiments, the operational instructions, when executed by the at least one processor, cause the database system to: store a plurality of files across a plurality of drives of a plurality of nodes, wherein each file of the plurality of files is identified via an owned storage identifier indicated by a storage identifier for the each file and/or an owner field for the each file; store a set of root directory data for a corresponding set of root directories as state data maintained via a consensus protocol mediated via the plurality of nodes, wherein each root directory of the set of root directories is identified via a corresponding root directory owner field; and/or access a corresponding subset of the plurality of files belonging to a corresponding root directory of the corresponding set of root directories based on applying the owner field for each of the corresponding subset of the plurality of files.

Some or all features and/or functionality of storing, generating, structuring, and/or rebuilding segments 2424 described herein can implement some or all features and/or functionality of storing, generating, structuring, and/or rebuilding segments 2424 disclosed by: U.S. Utility application Ser. No. 18/632,629, entitled “DATABASE SYSTEM PERFORMANCE OF A STORAGE REBALANCING PROCESS”, filed Apr. 11, 2024, which is hereby incorporated herein by reference in its entirety and made part of the present U.S. Utility patent application for all purposes.

Some or all features and/or functionality of storing, generating, structuring, and/or rebuilding segments 2424 described herein can implement some or all features and/or functionality of storing, generating, structuring, and/or rebuilding segments 2424 disclosed by: U.S. Utility application Ser. No. 18/355,497, entitled “TRANSFER OF A SET OF SEGMENTS BETWEEN STORAGE CLUSTERS OF A DATABASE SYSTEM”, filed Jul. 20, 2023, which is hereby incorporated herein by reference in its entirety and made part of the present U.S. Utility patent application for all purposes.

Some or all features and/or functionality of storing, generating, structuring, and/or rebuilding segments 2424 described herein can implement some or all features and/or functionality of storing, generating, structuring, and/or rebuilding segments 2424 disclosed by: U.S. Utility application Ser. No. 18/310,262, entitled “GENERATING A SEGMENT REBUILD PLAN VIA A NODE OF A DATABASE SYSTEM”, filed May 1, 2023, which is hereby incorporated herein by reference in its entirety and made part of the present U.S. Utility patent application for all purposes. For example, directory metadata 2855 can be implemented in a same or similar fashion as segment metadata 3116, for example, based on similarly storing storage id data 3141 and/or time interval data 3143 (e.g. for a given tree node or for each of set of child tree nodes). As another example, state data 3105 can be implement in a same or similar fashion as system metadata 2710.

Some or all features and/or functionality of storing, generating, structuring, and/or rebuilding segments 2424 described herein can implement some or all features and/or functionality of storing, generating, structuring, and/or rebuilding segments 2424 disclosed by: U.S. Utility application Ser. No. 18/308,954, entitled “QUERY EXECUTION DURING STORAGE FORMATTING UPDATES”, filed Apr. 28, 2023, which is hereby incorporated herein by reference in its entirety and made part of the present U.S. Utility patent application for all purposes. For example, directory metadata 2855 can be implemented in a same or similar fashion as segment metadata 3725. As another example, state data 3105 can be implement in a same or similar fashion as system state data 3502. As another example segment groups 2820 can be implemented to include segments and sibling segments.

Some or all features and/or functionality of implementing addendum parts described herein can implement some or all features and/or functionality of implementing addendum parts and/or handling deletes as disclosed by: U.S. Utility application Ser. No. 18/364,761, entitled “GENERATING ADDENDUM PARTS FOR SUBSEQUENT PROCESSING VIA A DATABASE SYSTEM”, filed Aug. 3, 2023, which is hereby incorporated herein by reference in its entirety and made part of the present U.S. Utility patent application for all purposes; and/or U.S. Utility application Ser. No. 18/457,049, entitled “DISTRIBUTED GENERATION OF ADDENDUM PART DATA FOR A SEGMENT STORED VIA A DATABASE SYSTEM”, filed Aug. 28, 2023, which is hereby incorporated herein by reference in its entirety and made part of the present U.S. Utility patent application for all purposes.

As used herein, an “AND operator” can correspond to any operator implementing logical conjunction. As used herein, an “OR operator” can correspond to any operator implementing logical disjunction.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining—A matches -B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event —without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

1-20. (canceled)

21. A database system comprises:
a plurality of computing device clusters, wherein a computing device cluster of the plurality of computing device clusters includes a plurality of computing devices, wherein a computing device of the plurality of computing devices includes a plurality of computing nodes, wherein a computing node of the plurality of computing nodes includes a plurality of processing core resources, wherein a set of processing core resources of the computing device cluster is operable to:
effectuate data activity of a segment of a plurality of segments of a dataset in accordance with a consensus protocol, wherein the plurality of segments is stored in memory of the database system, wherein a plurality of segment directories associated with the plurality of segments include metadata regarding storage of the plurality of segments in the memory of the database system;
in accordance with successfully effectuated data activity of the segment:
record the successful effectuated data activity of the segment in a consensus file; and
update a segment directory of the plurality of segment directories with metadata regarding data resulting from the successfully effectuated data activity of the segment; and
effectuate data activity of a second segment of the plurality of segments in accordance with the consensus protocol;
in accordance with successfully effectuated data activity of the second segment:
record the successful effectuated data activity of the second segment in a second consensus file; and
update a second segment directory of the plurality of segment directories with metadata regarding data resulting from the successfully effectuated data activity of the second segment.

22. The database system of claim 21, wherein the effectuated data activity comprises one or more of:
store the segment of the plurality of segments of the dataset;
add data to the segment of the plurality of segments of the dataset;
delete data from the segment of the plurality of segments of the dataset;
modify data of the segment of the plurality of segments of the dataset;
compute new data from the segment of the plurality of segments of the dataset; and
access the segment of the plurality of segments of the dataset for a query.

23. The database system of claim 21, wherein the segment of the plurality of segments of the dataset comprises one of:
a data segment; and
a parity segment.

24. (canceled)

25. The database system of claim 21 further comprises:
the set of processing core resources storing copies of the consensus file;
the sets of computing nodes of the set of computing devices of the computing device cluster storing copies of the consensus file;
the set of computing devices of the computing device cluster storing copies of the consensus file; and
the computing device cluster storing a copy of the consensus file.

26. The database system of claim 21, wherein the set of processing core resources are further operable to:
create a plurality of file names for the plurality of segment directories, wherein a first file name of the plurality of file names is for a first segment directory; and
store, based on the plurality of file names, the plurality of segment directories as a plurality of files in the database system.

27. The database system of claim 26, wherein the storing the plurality of files further comprises:
process the plurality of files in accordance with a long term storage (LTS) protocol to produce a plurality of LTS files, wherein the LTS protocol includes one or more of: dictionary compression, data compression, data deduplication, and error encoding; and
store the plurality of LTS files as the plurality of files.

28. (canceled)

29. The database system of claim 21, wherein the segment directory of the plurality of segment directories comprises:
first data regarding storage of a set of the plurality of segments of the dataset in memory of the database system; and
second data regarding the successfully effectuated data activity regarding the set of the plurality of segments of the dataset.

30. A computer-readable memory comprises:
a first memory section that stores operational instructions that, when executed by a set of processing core resources of a computing device cluster of a database system, causes the set of processing core resources to:
effectuate data activity of segments of a dataset in accordance with a consensus protocol, wherein the plurality of segments is stored in memory of the database system, wherein a plurality of segment directories associated with the plurality of segments include metadata regarding storage of the plurality of segments in the memory of the database system;
in accordance with successfully effectuated data activity of the segment:
record the successful effectuated data activity of the segment in a consensus file; and
update a segment directory of the plurality of segment directories with metadata regarding data resulting from the successfully effectuated data activity of the segment; and
effectuate data activity of a second segment of the plurality of segments in accordance with the consensus protocol;
in accordance with successfully effectuated data activity of the second segment:
record the successful effectuated data activity of the second segment in a second consensus file; and
update a second segment directory of the plurality of segment directories with metadata regarding data resulting from the successfully effectuated data activity of the second segment.

31. The computer-readable memory of claim 30, wherein the effectuated data activity comprises one or more of:
store the segment of the plurality of segments of the dataset;
add data to the segment of the plurality of segments of the dataset;
delete data from the segment of the plurality of segments of the dataset;
modify data of the segment of the plurality of segments of the dataset;
compute new data from the segment of the plurality of segments of the dataset; and
access the segment of the plurality of segments of the dataset for a query.

32. The computer-readable memory of claim 30, wherein the segment of the plurality of segments of the dataset comprises one of:
a data segment; and
a parity segment.

33. (canceled)

34. The computer-readable memory of claim 30, wherein the first memory section further stores operational instructions that, when executed by the set of processing core resources, causes the set of processing core resources to:
store copies of the consensus file;
wherein the first memory section further stores operational instructions that, when executed by a set of computing nodes of a set of computing devices of a computing device cluster of the database system, causes the set of computing nodes to:
store copies of the consensus file;
wherein the first memory section further stores operational instructions that, when executed by the set of computing devices, causes the set of computing devices to:
store copies of the consensus file; and
wherein the first memory section further stores operational instructions that, when executed by the computing device cluster, causes the computing device cluster to:
store copies of the consensus file.

35. The computer-readable memory of claim 30, wherein the first memory section further stores operational instructions that, when executed by the set of processing core resources causes the set of processing core resources to:
create a plurality of file names for the plurality of segment directories, wherein a first file name of the plurality of file names is for a first segment directory; and
store, based on the plurality of file names, the plurality of segment directories as a plurality of files in the database system.

36. The computer-readable memory of claim 30, wherein the first memory section further stores operational instructions that, when executed by the set of processing core resources causes the set of processing core resources to further store the plurality of files by: processing the plurality of files in accordance with a long term storage (LTS) protocol to produce a plurality of LTS files, wherein the LTS protocol includes one or more of: dictionary compression, data compression, data deduplication, and error encoding; and
storing the plurality of LTS files as the plurality of files.

37. (canceled)

38. The computer-readable memory of claim 30, wherein the segment directory of the plurality of segment directories comprises:
first data regarding storage of a set of the plurality of segments of the dataset in memory of the database system; and
second data regarding the successfully effectuated data activity regarding the set of the plurality of segments of the dataset.
